(19) United States
(12) Patent Application Publication
(10) Pub. No.: US 2024/0323898 A1
(43) Pub. Date: Sep. 26, 2024

(54) SL POSITIONING ON A SL INTERFACE

(71) Applicant: Samsung Electronics Co., Ltd., Suwon-si (KR)

(72) Inventors: Emad Nader Farag, Flanders, NJ (US); Hongbo Si, Allen, TX (US)

(21) Appl. No.: 18/603,085

(22) Filed: Mar. 12, 2024

Related U.S. Application Data
(60) Provisional application No. 63/454,548, filed on Mar. 24, 2023.
(60) Provisional application No. 63/455,880, filed on Mar. 30, 2023.

(51) Int. Cl. H04W 64/00; H04L 5/00; H04W 24/10; H04W 72/25; H04W 92/18

(52) U.S. Cl. CPC H04W 64/00; H04L 5/0051; H04W 24/10; H04W 72/25; H04W 92/18

(57) ABSTRACT

Apparatuses and methods for SL PRS transmission and measurement for multi-panel UE. A method of operating a user equipment (UE) includes receiving, from a second UE, sidelink positioning reference signals (SL PRSs) and performing a first positioning measurement based on a first SL PRS and a second positioning measurement based on a second SL PRS or a third positioning measurement based on a third SL PRS that is received by a first antenna panel and a fourth positioning measurement based on the third SL PRS that is received by a second antenna panel. The method includes determining a first positioning measurement report based on the first positioning measurement and the second positioning measurement or the third positioning measurement and the fourth positioning measurement. The first positioning measurement report includes an identifier of a SL PRS used and an identifier of an antenna panel used to receive the SL PRS.

### CROSS-REFERENCE TO RELATED AND CLAIM OF PRIORITY

The present application claims priority under 35 U.S.C. § 119(e) to U.S. Provisional Patent Application No. 63/454,548 filed on Mar. 24, 2023, and U.S. Provisional Patent Application No. 63/455,880 filed on Mar. 30, 2023, which are hereby incorporated by reference in their entirety.

### TECHNICAL FIELD

The present disclosure relates generally to wireless communication systems and, more specifically, the present disclosure is related to apparatuses and methods for sidelink (SL) positioning on a SL interface with multi-panel UE.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to SL PRS transmission and measurement for multi-panel UE.

In one embodiment, a user equipment (UE) is provided. The UE includes a transceiver configured to receive, from a second UE, via N antenna panels, M sidelink positioning reference signals (SL PRSs). At least one of N and M is greater than 1. The UE further includes a processor operably coupled to the transceiver. The processor is configured to perform a first positioning measurement based on a first SL PRS from the M SL PRS and a second positioning measurement based on a second SL PRS from the M SL PRS, or a third positioning measurement based on a third SL PRS from the M SL PRS that is received by a first antenna panel from the N antenna panels and a fourth positioning measurement based on the third SL PRS that is received by a second antenna panel from the N antenna panels. The processor is further configured to determine a first positioning measurement report based on (i) the first positioning measurement and the second positioning measurement or (ii) the third positioning measurement and the fourth positioning measurement. The first positioning measurement report includes (i) an identifier of a SL PRS used and (ii) an identifier of an antenna panel used to receive the SL PRS.

In another embodiment, a method of operating a UE is provided. The method includes receiving, from a second UE, via N antenna panels, M SL PRSs and performing a first positioning measurement based on a first SL PRS from the M SL PRS and a second positioning measurement based on a second SL PRS from the M SL PRS or a third positioning measurement based on a third SL PRS from the M SL PRS that is received by a first antenna panel from the N antenna panels and a fourth positioning measurement based on the third SL PRS that is received by a second antenna panel from the N antenna panels. At least one of N or M is greater than 1. The method further includes determining a first positioning measurement report based on (i) the first positioning measurement and the second positioning measurement or (ii) the third positioning measurement and the fourth positioning measurement. The first positioning measurement report includes (i) an identifier of a SL PRS used and (ii) an identifier of an antenna panel used to receive the SL PRS.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of an example orthogonal frequency division multiplexing (OFDM) waveform according to embodiments of the present disclosure;

FIG. 7 illustrates a diagram of an example Fast Fourier Transform (FFT) window(s) according to embodiments of the present disclosure;

FIG. 8 illustrates flow diagrams of example random access procedures according to embodiments of the present disclosure;

FIG. 9 illustrates flow diagrams of example 2-step random access procedures according to embodiments of the present disclosure;

FIG. 10 illustrates a diagram of example downlink positioning reference signal (DL PRS) resources according to embodiments of the present disclosure;

FIG. 11 illustrates a diagram of an example architecture for positioning according to embodiments of the present disclosure;

FIG. 12 illustrates a diagram of an example location management function (LMF) according to embodiments of the present disclosure;

FIG. 13 illustrates a diagram of an example UE communication with two transmission reception points (TRPs) according to embodiments of the present disclosure;

FIG. 14 illustrates a diagram of an example UE communication with two TRPs according to embodiments of the present disclosure;

FIG. 15 illustrates a flow diagram for a UE receiving a time adjustment (TA) value(s) for positioning according to embodiments of the present disclosure;

FIG. 16 illustrates a diagram for relative positioning according to embodiments of the present disclosure;

FIG. 17 illustrates a diagram of an example coverage network for a UE according to embodiments of the present disclosure;

FIGS. 18A, 18B, 18C, 18D, 18E, 18F, 18G, and 18H illustrate diagrams of example sidelink (SL) positioning reference signals (PRSs) according to embodiments of the present disclosure;

FIGS. 19A, 19B, 19C, and 19D illustrate diagrams of example SL PRSs according to embodiments of the present disclosure;

FIGS. 20A, 20B, 20C, 20D, 20E, 20F, 20G, and 20H illustrate diagrams of example SL PRSs according to embodiments of the present disclosure;

FIGS. 21A, 21B, 21C, and 21D illustrate diagrams of example SL PRSs according to embodiments of the present disclosure; and

FIG. 22 illustrates a diagram of an example nested comb structure for SL PRS according to embodiments of the present disclosure.

### DETAILED DESCRIPTION

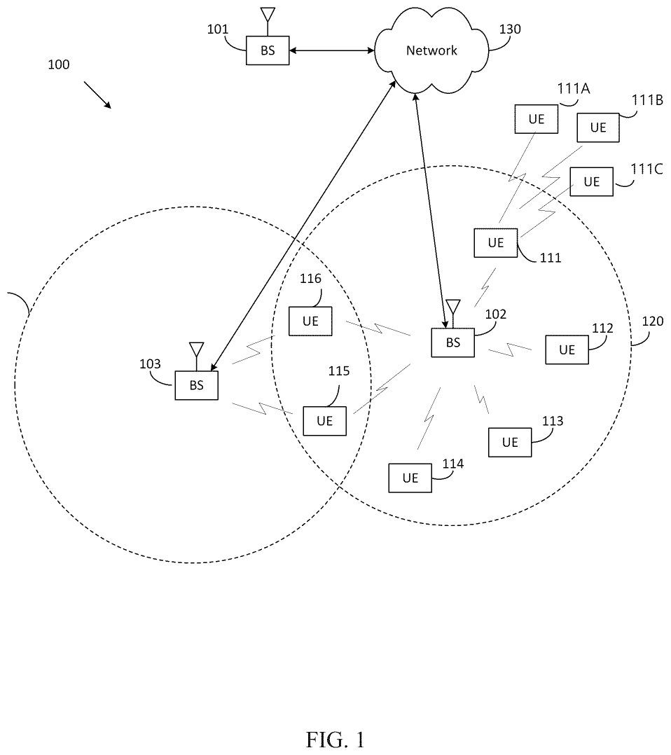

FIGS. 1-22, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v17.4.0, “NR; Physical channels and modulation;” [2] 3GPP TS 38.212 v17.4.0, “NR; Multiplexing and Channel coding;” [3] 3GPP TS 38.213 v17.4.0, “NR; Physical Layer Procedures for Control;” [4] 3GPP TS 38.214 v17.4.0, “NR; Physical Layer Procedures for Data;” [5] 3GPP TS 38.215 v17.2.0, “NR; Physical Layer Measurements;” [6] 3GPP TS 38.321 v17.3.0, “NR; Medium Access Control (MAC) protocol specification;” [7] 3GPP TS 38.331 v17.3.0, “NR; Radio Resource Control (RRC) Protocol Specification;” [8] 3GPP TS 36.213 v17.4.0, “Evolved Universal Terrestrial Radio Access (E-UTRA); Physical layer procedures;” [9] 3GPP TR 38.845 v17.0.0, “Study on scenarios and requirements of in-coverage, partial coverage, and out-of-coverage NR positioning use cases”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication and/or positioning.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for SL PRS transmission and measurement for multi-panel LUE. In certain embodiments, and one or more of the gNBs 101-103 includes circuitry, programing, or a combination thereof, for supporting SL PRS transmission and measurement for multi-panel UE.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

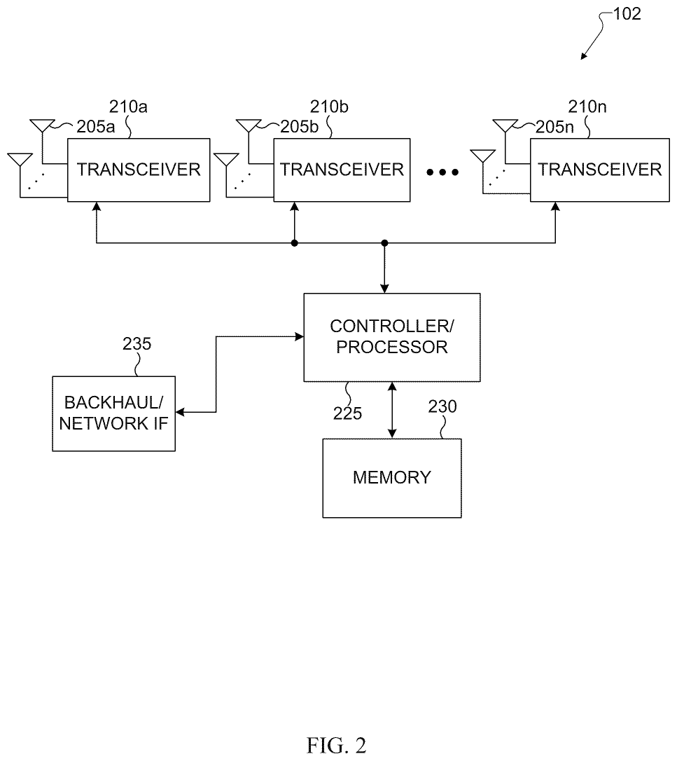

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting SL PRS transmission and measurement for multi-panel UE. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

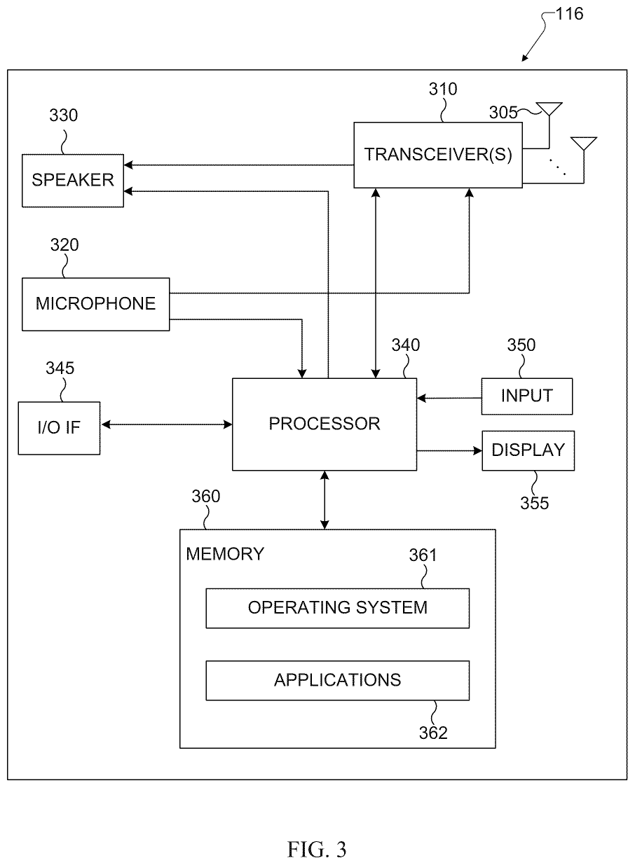

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals and SL channels and/or signals and the transmission of UL channels and/or signals and SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for SL PRS transmission and measurement for multi-panel UE.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

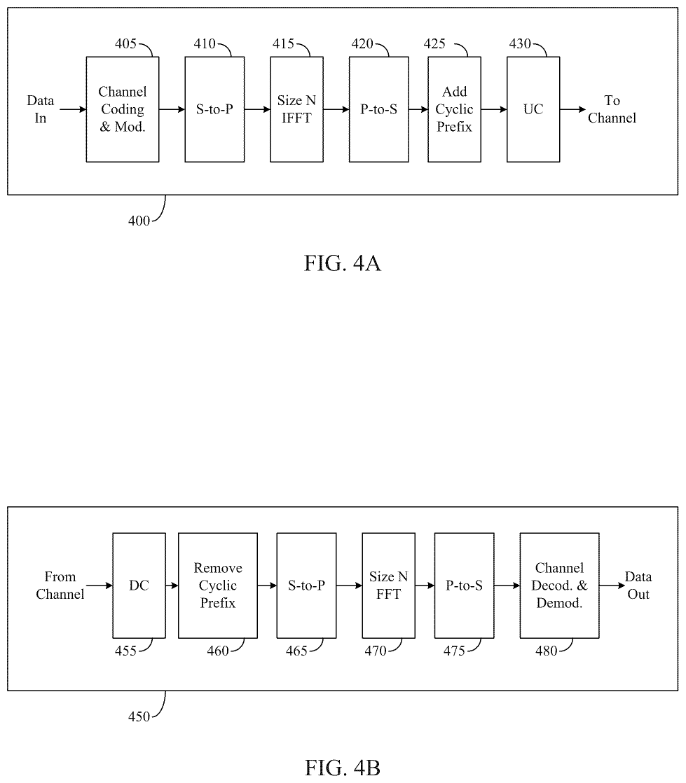

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. It will be understood that the receive path 450 can be implemented in a first UE and that the transmit path 400 can be implemented in a second UE. In some embodiments, the transmit path 400 is configured for SL PRS transmission and measurement for multi-panel UE as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or for transmitting in the sidelink to another UE and may implement a receive path 450 for receiving in the downlink from gNBs 101-103 or for receiving in the sidelink from another UE.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., Synchronization Signal/Physical Broadcast Channel (SS/PBCH) block) (SSB) and/or Channel State Information Reference Signal (CSI-RS)) and a target RS or a spatial relation information that establishes an association to a source RS, such as SSB or CSI-RS or sounding RS (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

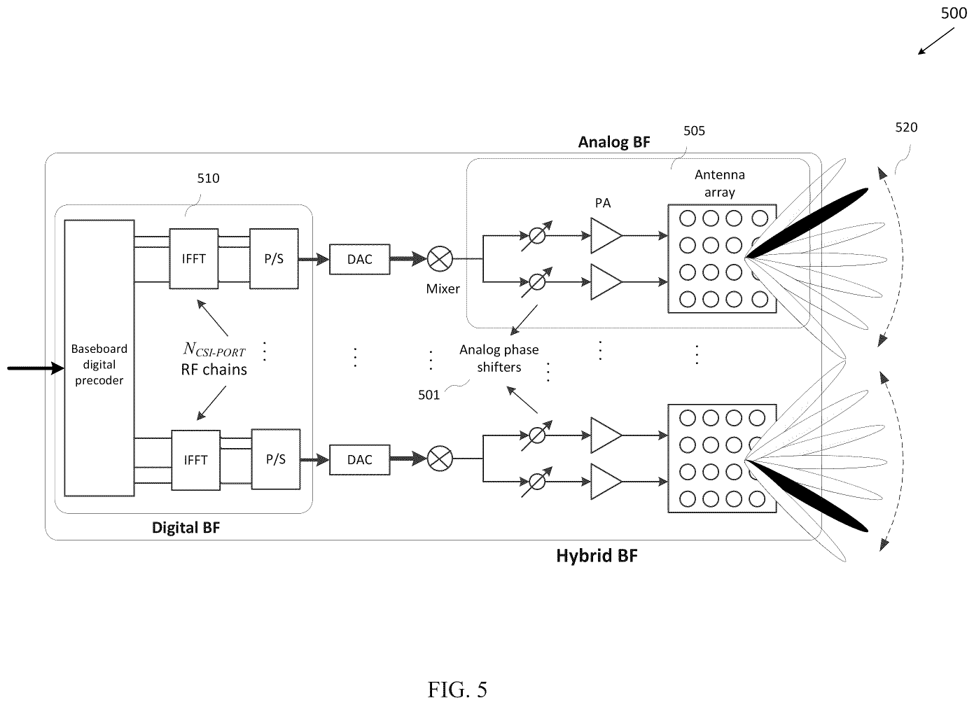

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCS-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 500 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

A description of example embodiments is provided on the following pages.

Any of the variation embodiments can be utilized independently or in combination with at least one other variation embodiment.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications and/or SL positioning. A UE can be configured one or more bandwidth parts (BWPs) of a system BW for transmissions or receptions of signals or channels.

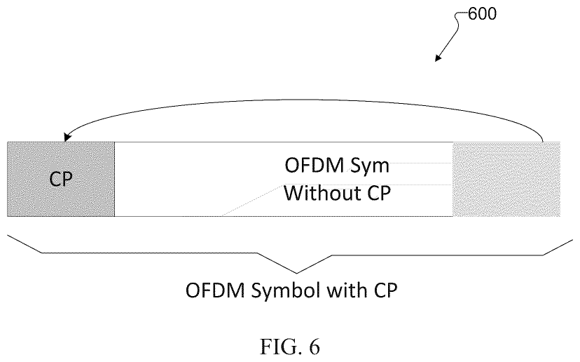

FIG. 6 illustrates a diagram 600 of an example OFDM waveform according to embodiments of the present disclosure. For example, diagram 600 of an example OFDM waveform can be utilized by any of the UEs 111-116 of FIG. 1. This example is for illustration only and other embodiments can be used without departing from the scope of the present disclosure.

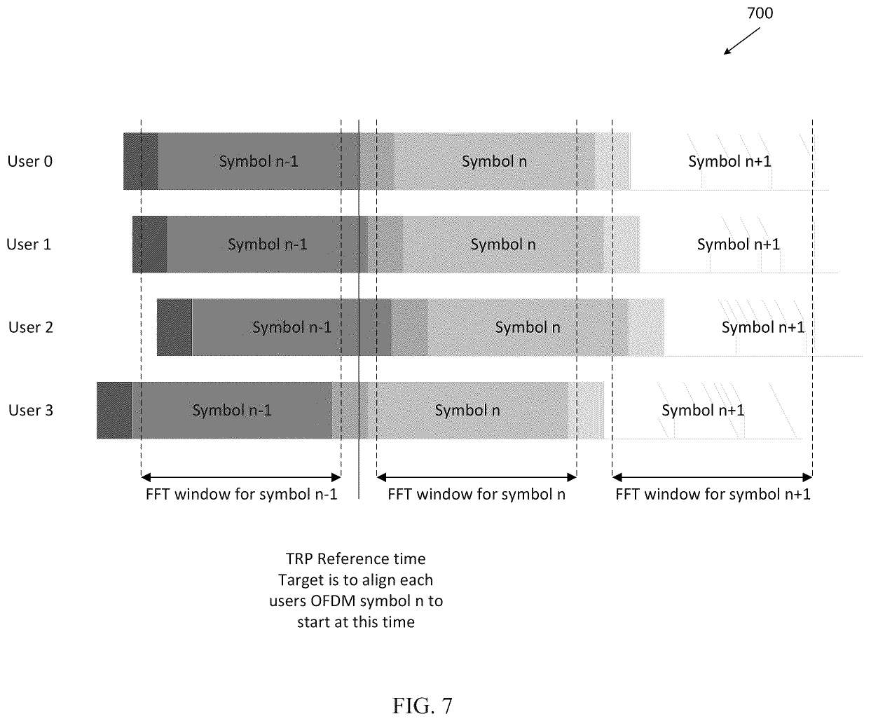

FIG. 7 illustrates a diagram 700 of an example Fast Fourier Transform (FFT) window(s) according to embodiments of the present disclosure. For example, diagram 700 of an example Fast Fourier Transform (FFT) window(s). For example, diagram 700 of an example Fast Fourier Transform (FFT) window(s) can be utilized by the UE 116 of FIG. 3 or by gNB 102 of FIG. 2. This example is for illustration only and other embodiments can be used without departing from the scope of the present disclosure.

NR uses Cyclic Prefix (CP)-OFDM or DTF-s-OFDM waveforms for uplink transmissions [1], i.e., for Physical Uplink Shared Channel (PUSCH), Physical Uplink Control Channel (PUCCH), and sounding reference signal (SRS). With reference to FIG. 6, both waveforms include a (Cyclic Prefix) CP appended to the front of each symbol. The CP is the last few samples of the OFDM symbol appended to the front of the symbol. With reference to FIG. 7, the base station 102 estimates the round-trip-time between the UE 116 and the base station 102. For example, this can be initially estimated using the physical random access channel (PRACH) during random access. The base station 102 signals a time advance (TA) command to advance the UE's uplink transmission time by a duration equivalent e.g., to the round-trip-delay such that an uplink transmission from the UE 116 and n-TimingAdvanceOffset, e.g., PUSCH or PUCCH or SRS arrives aligned to the base station 102 reference timing. All users are synchronized to the same reference time; this retains orthogonality between users. In FIG. 7, user 0 start time for symbol n, for example symbol n can correspond to symbol zero of a radio frame, is exactly aligned to the reference time of the base station 102. For user 1, the start time of symbol n is slightly delayed from the base station 102's reference time. For user 2, the start time of symbol n is delayed even more from the base station 102's reference time this can be for example due to a time alignment error. For user 3, the start time of symbol n is advanced by a large duration from the base station 102's reference time, this can for example due to a time alignment error.

The first stage of a NR baseband receiver is the removal of the CP followed by a Fast Fourier Transform (FFT) operator that converts the OFDM symbol from time domain to frequency domain. An example of the FFT window is illustrated in FIG. 7. In this example, the FFT window of symbol n starts CP/2 after the base station 102's reference time, where CP is the duration of the cyclic prefix and the duration of the FFT window is large enough to include all the samples required for FFT operation. Note that in this example, as the FFT window is starting halfway through the CP rather than at the end of the CP, a time adjustment of CP/2 can be done in frequency domain (after the FFT) to compensate the CP/2 offset. If the user's misalignment is within the CP range, i.e., in the range of [−CP/2, CP/2] for the example illustrated in FIG. 7, the signal of user i is cyclically delayed by τᵢ, as long as τᵢ is within the CP range. For example, user 1 is delayed by τ₁<CP/2, hence within the FFT window of symbol n all the samples belong to symbol n, there is no inter-symbol interference in this case. The delay τᵢ when within the CP range is converted into a phasor after the FFT and can be easily estimated and compensated. If xi is greater than the CP range, inter symbol interference can occur, as illustrate in FIG. 7, for users 2 and 3. For user 2, τ₂ exceeds CP2/, hence in the FFT window of symbol n, there are samples from symbol n−1 leading to inter-symbol interference and thus degrading performance. For user 3, τ₃ is less than−CP2/, hence in the FFT window of symbol n, there are samples from symbol n+1 leading to inter-symbol interference and thus degrading performance.

When a UE is communicating with multiple TRPs, the distances between the UE 116 and each TRP can be different. If the UE 116 were to use a common UL transmission time for transmitting to all TRPs, the UE 116 reception might be aligned to the receive reference time of one TRP, but misaligned (by more than a CP) to receive reference time of the other TRPs leading to inter-symbol interference and loss of orthogonality at the other TRPs. One way to avoid this issue is to allow for multiple UL transmit times from the UE 116 wherein each transmit time corresponds to a TRP.

NR supports four different sequence length for random access preamble sequence:
Sequence length 839 used with sub-carrier spacings 1.25 kHz and 5 kHz with unrestricted or restricted sets.
Sequence length 139 used with sub-carrier spacings 15 kHz, 30 kHz, 60 kHz, and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in PRACH Occasions (ROs). Each RO determines the time and frequency resources in which a preamble is transmitted. The resources allocated to an RO in the frequency domain (e.g., number of PRBs) and the resource allocated to an RO in the time domain (e.g., number of OFDMA symbols or number of slots) depend on the preamble sequence length, sub-carrier spacing of the preamble, sub-carrier spacing of the PUSCH in the UL BWP, and the preamble format. Multiple PRACH Occasions can be FDMed in one time instance. This is provided by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 [REF 1].

SSBs are associated with ROs. The number of SSBs associated with one RO can be provided by higher layer parameters such as ssb-perRACH-OccasionAndCB-PreamblesPerSSB and ssb-perRACH-Occasion. The number of SSBs per RO can be {⅛,¼,½,1,2,4,8,16}. When the number of SSBs per RO is less than 1, multiple ROs are associated with the same SSB. SS/PBCH block indexes provided by ssb-PositionsInBurst in SIB1 or in ServingCellConfigCommon are mapped to valid PRACH occasions in the following order [38.213] [REF 3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

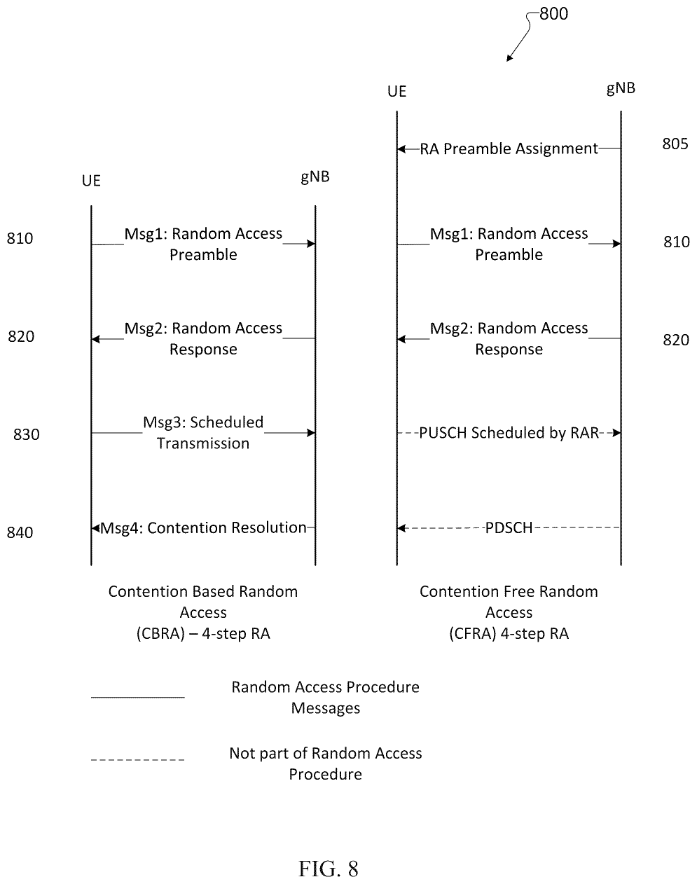

FIG. 8 illustrates flow diagrams 800 of example random access procedures according to embodiments of the present disclosure. For example, flow diagrams 800 of example random access procedures can be followed by any of the UEs 111-116 of FIG. 1, such as the UE 116 of FIG. 3 and a BS, such as BS 102. This example is for illustration only and other embodiments can be used without departing from the scope of the present disclosure.

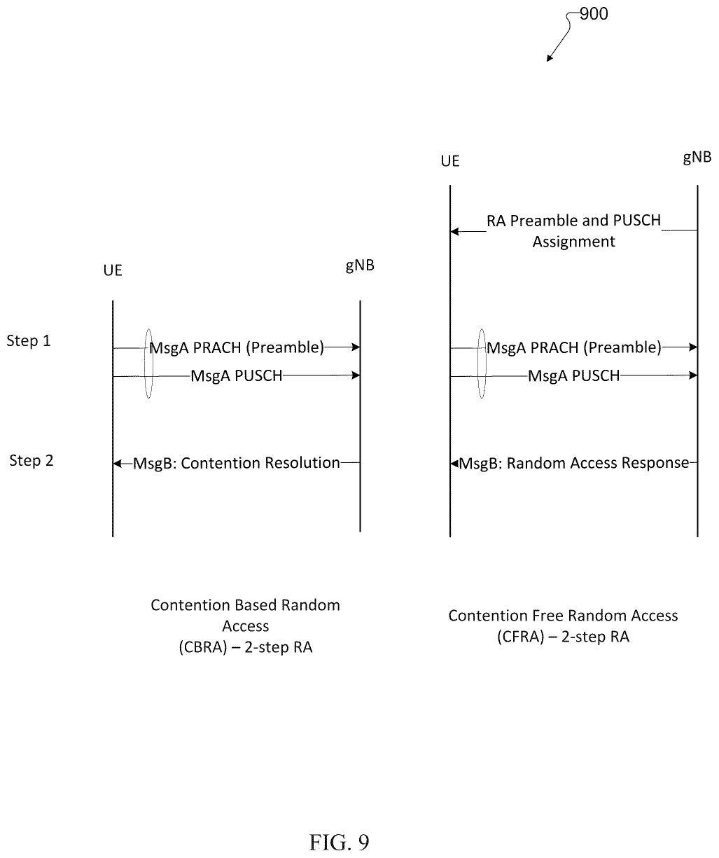

FIG. 9 illustrates flow diagrams 900 of example 2-step random access procedures according to embodiments of the present disclosure. For example, flow diagrams 900 of example 2-step random access procedures can be followed by any of the UEs 111-116 of FIG. 1, such as the UE 115 of FIG. 3 and a BS, such as BS 103. This example is for illustration only and other embodiments can be used without departing from the scope of the present disclosure.

A random access procedure can be initiated by a physical downlink control channel (PDCCH) order, by the MAC entity, or by RRC.

There are two types of random access procedures, type-1 random access procedure and type-2 random access procedure.

Type-1 random access procedure, also known as four-step random access procedure (4-step RACH), is as illustrated in FIG. 8;
In 810, the UE 116 transmits a random access preamble, also known as Msg1, to the gNB 102. The gNB 102 attempts to receive and detect the preamble.
In 820, the gNB 102 upon receiving the preamble transmits a random access response (RAR), also known as Msg2, to the UE 116 including, among other fields, a time adjustment (TA) command and an uplink grant for a subsequent PUSCH transmission.
In 830, the UE 116, after receiving the RAR, transmits a PUSCH transmission scheduled by the grant of the RAR, and time adjusted according to the TA received in the RAR. Msg3 or the PUSCH scheduled by the RAR UL grant can include the RRC setup request message.
In 840, the gNB 102 upon receiving the RRC setup request message, allocates downlink and uplink resources that are transmitted in a physical downlink shared channel (PDSCH) transmission to the UE 116.

After the last step, the UE 116 can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in 805, the gNB 102 indicates to the UE 116 the preamble to use.

Release 16, introduced a new random access procedure; Type-2 random access procedure, also known as 2-step random access procedure (2-step RACH), is as illustrated in FIG. 9, that combines the preamble and PUSCH transmission into a single transmission from the UE 116 to the gNB 102, which is known as MsgA. Similarly, the RAR and the PDSCH transmission (e.g., Msg4) are combined into a single downlink transmission from the gNB 102 to the UE 116, which is known as MsgB.

A random access procedure can be triggered by a PDCCH order. The PDCCH order is triggered by downlink control information (DCI) Format 1_0 with Cyclic Redundancy Check (CRC) scrambled by -radio network temporary identifier (C-RNTI) and the “Frequency domain resource assignment” field is set to all ones. The fields of DCI format 1_0 carrying the PDCCH order are interrupted as follows:

TABLE 1

| Field | Size | | Description |
|---|---|---|---|
| Identifier for DCI | 1 | | The value of this bit field is |
| formats | | | always set to 1, indicating a DL |
| | | | DCI format |
| Frequency domain | [log₂ (N_{RB}^{DL, BWP} (N_{RB}^{DL, BWP} + 1)/2)] | | Set to all ones |
| resource assignment | | | |
| Random Access | 6 | bits | |
| Preamble index | | | |
| UL/SUL indicator | 1 | bit | |
| SS/PBCH index | 6 | bits | If “Random Access Preamble |
| | | | index” is not zero indicates |
| | | | SSB index of RO used, else |
| | | | this field is reserved |
| PRACH Mask index | 4 | bits | If “Random Access Preamble |

| | | index” is not zero indicates RO |
|---|---|---|
| | | used, else this field is reserved |
| Reserved bits | 12 bits or 10 bits | |

If “Random Access Preamble index” is not zero, the PDCCH order triggers a contention free random access preamble, wherein the PRACH Occasion is determined based on the “SS/PBCH index” indicated in the PDCCH order and the “PRACH Mask index” indicated in the PRACH Occasion associated with the SS/PBCH indicated by “SS/PBCH index”. The “Random Access Preamble index” indicates the preamble index to use in the PRACH Occasion.

If a PRACH transmission from a UE is in response to a detection of a PDCCH order by the UE 116 that triggers a contention-free random access procedure, the preamble can be transmitted based on the SSB that the DL RS that the demodulation reference signal (DM-RS) of the PDCCH order is quasi-collocated with.

If the UE 116 attempts to detect the DCI format 1_0 with CRC scrambled by the corresponding RA-RNTI in response to a PRACH transmission initiated by a PDCCH order that triggers a contention-free random access procedure for the SpCell [TS 38.321] [REF6], the UE 116 may assume that the PDCCH that includes the DCI format 1_0 and the PDCCH order have same DM-RS antenna port quasi co-location properties. When receiving a PDSCH scheduled with RA-RNTI in response to a random access procedure triggered by a PDCCH order which triggers contention-free random access procedure for the SpCell [TS 38.321] [REF6], the UE 116 may assume that the DM-RS port of the received PDCCH order and the DM-RS ports of the corresponding PDSCH scheduled with RA-RNTI are quasi co-located with the same SS/PBCH block or CSI-RS with respect to Doppler shift, Doppler spread, average delay, delay spread, spatial RX parameters when applicable.

If the UE 116 attempts to detect the DCI format 1_0 with CRC scrambled by the corresponding RA-RNTI in response to a PRACH transmission initiated by a PDCCH order that triggers a contention-free random access procedure for a secondary cell, the UE 116 may assume the DM-RS antenna port quasi co-location properties of the CORESET associated with the Type1-PDCCH common search space (CSS) set for receiving the PDCCH that includes the DCI format 1_0.

If “Random Access Preamble index” is zero, the PDCCH order triggers a contention based random access procedure. If a PRACH transmission from a UE is in response to a detection of a PDCCH order by the UE 116 that triggers a contention-based random access procedure, the UE 116 can determine a SSB for the preamble transmission and select a preamble in a PRACH occasion corresponding to the SSB. If the UE 116 attempts to detect the DCI format 1_0 with CRC scrambled by the corresponding RA-RNTI in response to a PRACH transmission initiated by a PDCCH order that triggers a contention-based random access procedure, the UE 116 may assume same DM-RS antenna port quasi co-location properties for PDCCH and PDSCH, as for a SS/PBCH block or a CSI-RS resource the UE 116 used for PRACH association.

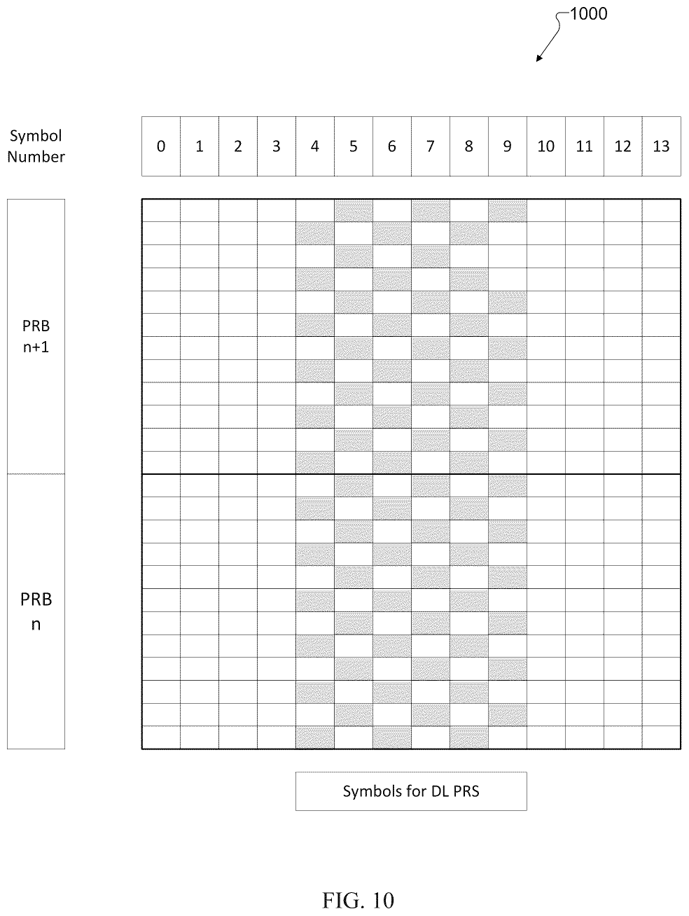

FIG. 10 illustrates a diagram 1000 of example DL PRS resources according to embodiments of the present disclosure. For example, diagram 1000 of example DL PRS resources can be utilized by the UE 111 of FIG. 1. This example is for illustration only and other embodiments can be used without departing from the scope of the present disclosure.

In downlink, the UE 116 receives DL positioning reference signal (PRS), where a positioning frequency layer includes one or more DL PRS resources sets. Each DL PRS resource set includes one or more DL PRS resources.

The reference signal sequence is defined by:

$$r ( m ) = \frac{1}{\sqrt{2}} ( 1 - 2 c ( 2 m ) + j ( 1 - 2 c ( 2 m + 1 ) ) )$$

The pseudo-random sequence c(n) is a length-31 Gold sequence defined as

$$c ( n ) = ( {x}_{1} ( n + {N}_{c} ) + {x}_{2} ( n + {N}_{c} ) ) mod 2$$

$$where ,$$

$${N}_{c} = 1 \; 600$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

The first m-sequence is initialized with x₁(0)=1, and x₂(n)=0, for n=1 . . . 30.

The second m-sequence is initialized with cᵢₙᵢₜ, where cᵢₙᵢₜ

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( ( {n}_{ID , seq}^{PRS} mod 1024 ) ) ) mod {2}^{31}$$

where, N_{symb}^{slot} is the number of symbols per slot, n_{s,f}^{μ} is the slot number, l is the symbol number within a slot and n_{ID,seq}^{PRS} is a higher layer provided parameter (dl-PRS-SequenceID-r16), with n_{ID,seq}^{PRS}∈{0,1, . . . , 4095}.

The DL PRS sequence is mapped to resource elements a_{k,l}^{(p,μ)} within a slot, where k is the sub-carrier frequency, l is the symbol number within the slot, p is the antenna port, which for DL PRS is p=5000 and μ is the sub-carrier spacing configuration, by

a_{k,l}^{(p,μ)}=β_{PRS}r(m)

where,
β_{PRS} is a scaling factor, m=0, 1, . . . .
k=mK_{comb}^{PRS} ((k_{offset}^{PRS}+k′) mod K_{comb}^{PRS}), K_{comb}^{PRS} is the comb size, which is given by higher layer parameter dl-PRS-CombSizeN, with K_{comb}^{PRS}∈{2,4,6,12}, k_{offset}^{PRS} is the sub-carrier offset, which is given by higher layer parameter dl-PRS-ReOffset, with k_{offset}^{PRS}ϵ{0, 1, . . . , K_{comb}^{PRS}−1}, k′ is a sub-carrier offset that is a function of the symbol number within a slot as given by Table 2.

l=lₛₜₐᵣₜ^{PRS}, lₛₜₐᵣₜ^{PRS}+1, . . . , lₛₜₐᵣₜ^{PRS}+L_{PRS}−1, lₛₜₐᵣₜ^{PRS} is the first DL PRS symbol in a slot, which is given by higher layer parameter dl-RS-ResourceSymbolOffset, L_{PRS} is the number of DL PRS symbols in a slot, with L_{PRS}∈{2,4,6,12}.

TABLE 2

| | Symbol number within PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

The allowed combination of {L_{PRS}, K_{comb}^{PRS}} is one of {{2,2}, {4,2}, {6,2}, {12,2}, {4,4}, {12,4}, {6,6}, {12,6}, {12,12}}.

FIG. 10 illustrates an example DL PRS resources within a slot, with K_{comb}^{PRS}=2, k_{offset}^{PRS}=0, L_{PRS}=6, and lₛₜₐᵣₜ^{PRS}=4.

In uplink, a UE can transmit positioning sounding reference signal (SRS). A positioning SRS is configured by higher layer IE SRS-PosResource.

The positioning SRS sequence is a low PAPR sequence of length N_{ZC}=M_{sc,b}^{SRS} given by:

$${r}^{( p )} ( n , {l}^{′} ) = {r}_{u , v}^{( α , δ )} ( n ) = {e}^{j α n} {\overline{r}}_{u , v} ( n ) ,$$

$$0 \leq n < {M}_{ZC}$$

where M_{ZC}=mN_{sc}^{RB}/2^{δ}, δ=log(K_{TC}), with K_{TC} being the transmission comb number is provided in higher layer IE transmissionComb, K_{TC}∈{2,4,8}. l′ is the positioning SRS symbol within a positioningSRS resource of a slot, l′∈{0, 1, . . . , N_{symb}^{SRS}−1} N_{symb}^{SRS} is the number of SRS symbols in a slot. For positioning SRS, there is one antenna port, the cyclic shift α is given

$$α = 2 π \frac{{n}_{SRS}^{cs}}{{n}_{SRS}^{cs , max}} ,$$

with n_{SRS}^{cs} being provided by higher layer in IE transmissionComb, n_{SRS}^{cs,max} depends on K_{TC} as illustrated in Table 3.

TABLE 3

| K_{TC} | n_{SRS}^{cs, max} |
|---|---|
| 2 | 8 |
| 4 | 12 |
| 8 | 6 |

u is the group number u∈{0, 1, . . . ,29}, v is the base sequence number, with v∈{0}, if 6≤N_{ZC}≤60 and v∈{0,1}, if 60>N_{ZC}. The base sequence, r̅_{u,v}(n), is generated as follows:
1. For N_{ZC}∈{6,12,18,24}, r̅_{u,v}(n)=e^{jϕ(n)π/4}, with 0≤n<M_{ZC}−1. ϕ(n) is given by Tables 5.2.2.2-1 to 5.2.2.2-4 of TS 38.211 [REF1].
2. For

$${N}_{ZC} = 30 ,$$

$${\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q}(n mod N_{ZC}),

$${x}_{q} ( n ) = {e}^{- j \frac{π q m ( m + 1 )}{{N}_{ZC}}} \cdot {N}_{ZC}$$

is the largest prime number less than

$${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by: u=(ƒ_{gh}(n_{s,f}^{μ},l′)+n_{ID}^{SRS}), where n_{ID}^{SRS} is provided by higher layer parameter sequenceID, with n_{ID}^{SRS}∈{0, 1, . . . , 65535}. Higher layer parameter groupOrSequenceHopping determines the values of u and v:
ifgroupOrSequenceHopping equals ‘neither’, neither group, nor sequence hopping shall be used and ƒ_{gh} (n_{s,f}^{μ},l′)=0, and v=0.
if groupOrSequenceHopping equals ‘groupHopping’, group hopping but not sequence hopping is used and v=0, and ƒ_{gh}(n_{s,f}^{μ},l′)=(Σₘ₌₀⁷c(8(n_{s,f}^{μ}N_{symb}^{slot}+l₀+l′)+m)·2^{m}) mod 30, N_{symb}^{slot} is the number of symbols in a slots, l₀ is the first positioning SRS symbols in the slot, and c(n) a length-31 Gold sequence defined asc(n)=(x₁(n+N_{c})+x₂(n+N_{c})) mod 2, with N_{c}=1600, x₁(n+31)=(x₁(n+3)+x₁(n)) mod 2, x₁(n+31)=(x₂(n+3)+x₂(n+2)+x₂(n+1)+x₂(n)) mod 2, the first m-sequence is initialized with x₁(0)=1, and x₂(n)=0, for n=1 . . . 30. The second m-sequence is initialized with cᵢₙᵢₜ, where cᵢₙᵢₜ=n_{ID}^{SRS}.
if groupOrSequenceHopping equals ‘sequenceHopping’, sequence hopping but not group hopping is used and ƒ_{gh}(n_{s,f}^{μ},l′)=0 and

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

N_{symb}^{slot} is the number of symbols in a slots, l₀ is the first positioning SRS symbols in the slot, and c(n) a length-31 Gold sequence as previously defined.

The positioning SRS sequence, r^{(p)}(n,l′), is mapped to resource elements k₀^{(p)} within a slot, where k is the sub-carrier frequency, l is the symbol number within the slot and p is the antenna port, where for positioning SRS there is one antenna port, by

$${a}_{k , l}^{( p )} = {β}_{SRS} {r}^{( p )} ( {k}^{′} , {l}^{′} )$$

$$l = {l}^{′} + {l}_{0}$$

where,
β_{SRS} is a scaling factor, k′=0,1, . . . , M_{sc,b}^{SRS}−1, M_{sc,b}^{SRS}=N_{sc}^{RB}/K_{TC}, m_{symb,b}^{SRS} is provided by Table 6.4.14.3-1 of TS 38.211 [REF1], and l′=0,1, . . . , N_{symb}^{SRS}−1.

l=l′+l₀, with l₀ the first positioning SRS symbols in the slot, where l₀∈{0,1, . . . , 13}.

k=K_{TC}k′+k₀^{(p)}, K_{TC} is the transmission comb number as described herein. k₀^{(p)}=k̅₀^{(p)}+Σ_{b=0}^{B}^{_{SRS}}K_{TC}M_{sc,b}^{SRS}n_{b}, k̅₀^{(p)}=t_{shift}N_{sc}^{RB}+(k_{TC}^{(p)}+k_{offset}^{l′}) mod K_{TC}, k_{TC}^{(p)}=k̅^{TC} for positioning SRS. k̅_{TC} is the transmission comb offset included within higher layer IE transmissionComb, with k̅_{TC}∈{0,1, . . . , K_{TC}−1}, k_{offset}^{l′} is a symbol dependent sub-carrier offset given by Table 4. n_{shift} is given by higher layer parameter freqDomainShift and it adjusts the frequency allocation with respect to a reference point. If N_{BWP}^{start}≤n_{shift} the reference point for k₀^{(p)} is sub-carrier 0 in common resource block 0, otherwise the reference point is the lowest subcarrier of the BWP. n_{b} is a frequency positioning index. For positioning SRS, B_{SRS}=0, bₕₒₚ=0, and frequency hopping is disable. n_{b} is given by:

$${n}_{b} = ⌊ \frac{4 {n}_{RRC}}{{m}_{SRS , b}} ⌋ mod {N}_{b}$$

n_{RRC} is given by higher layer parameterfreqDomainPosition, and m_{SRS,b} and N_{b} are determined by Table 6.4.14.3-1 of TS 38.211 [REF1] with b=B_{SRS} and the configured value of C_{SRS}.

TABLE 4

| | k_{offset}⁰, k_{offset}¹, . . . , k_{offset}^{N}^{_{symb}}^{SRS}−1 | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, |
| | | | | | 0, 2, 1, 3 |
| 8 | — | — | 0, 4, 2, 6 | 0, 4, 2, 6, 1, 5, 3, 7 | 0, 4, 2, 6, 1, 5, 3, 7, |
| | | | | | 0, 4, 2, 6 |

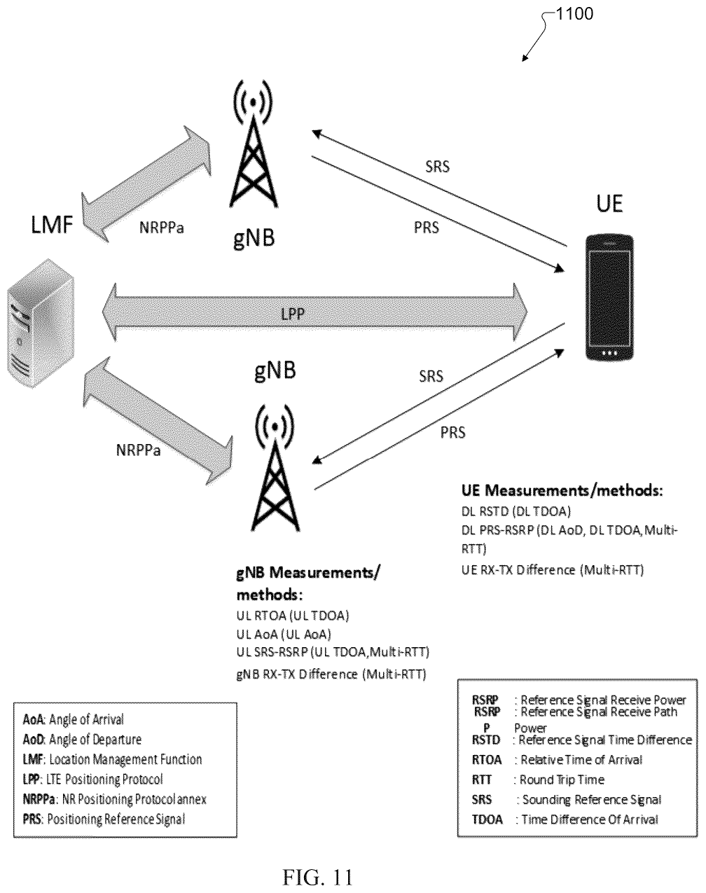

FIG. 11 illustrates a diagram 1100 of an example architecture for positioning according to embodiments of the present disclosure. For example, diagram 1100 of an example architecture for positioning can be utilized by the UE 112 and BS 102 within the network 100 of FIG. 1. This example is for illustration only and other embodiments can be used without departing from the scope of the present disclosure.

NR supports positioning on the Uu interface. In the DL positioning reference signal (PRS) can be transmitted by a gNB to a UE to enable the UE 116 to perform positioning measurements. In the UL a UE can transmit positioning sounding reference signal (SRS) to enable a gNB to perform positioning measurements. UE measurements or metrics for positioning include: DL PRS reference signal receive power (DL PRS RSRP), DL PRS reference signal received path power (DL PRS-RSRPP), DL reference signal time difference (DL RSTD), UE Rx-Tx time difference, DL reference signal carrier phase (DL RSCP), DL reference signal carrier phase difference (DL RSCPD), NR enhanced cell ID (E-CID) DL SSB radio resource management (RRM) measurement, and NR E-CID DL CSI-RS RRM measurement. UE measurements for positioning on the SL interface include; sidelink PRS reference signal received power (SL PRS-RSRP), sidelink PRS reference signal received path power (SL PRS-RSRPP), sidelink relative time of arrival (SL-RTOA), sidelink angle of arrival (SL AoA), sidelink Rx-Tx time difference, and sidelink reference signal time difference (SL RSTD). Next generation radio access network (NG-RAN) measurements for positioning include UL relative time of arrival (UL-RTOA), UL angle of arrival (UL AoA), UL SRS reference signal received power (UL SRS-RSRP), UL SRS reference signal received path power (UL SRS-RSRPP), gNB Rx-Tx time difference and UL reference signal carrier phase (UL RSCP). NR introduced several radio access technology (RAT) dependent positioning methods: time difference of arrival based methods such DL time difference of arrival (DL-TDOA), UL time difference of arrival (UL TDOA) and SL time difference of arrival (SL TDOA), angle based methods such as UL angle of arrival (UL AoA), DL angle of departure (DL AoD) and SL angle of arrival (SL AoA), multi-round trip time (RTT) based methods for Uu interface and SL interface and E-CID based methods.

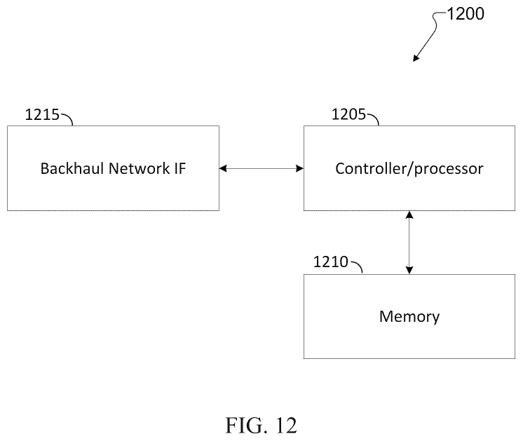

FIG. 12 illustrates a diagram of an example LMF 1200 according to embodiments of the present disclosure. For example, the LMF 1200 can be implemented in a base station 102 or a network 130. This example is for illustration only and other embodiments can be used without departing from the scope of the present disclosure.

Positioning schemes can be UE-based, i.e., the UE 116 determines the location or UE-assisted (e.g., location management function (LMF) based), i.e., UE provides measurements for a network entity (e.g., LMF) to determine the location. LTE positioning protocol (LPP) [TS 37.355], first introduce for LTE and then extended to NR is used for communication between the UE 116 and LMF. NR positioning protocol annex (NRPPa) [TS 38.455] is used for communication between the gNB 102 and the LMF. FIG. 11 illustrates the overall positioning architecture along with positioning measurements and methods.

As shown in FIG. 12, the LMF 1200 includes a controller/processor 1205, a memory 1210, and a backhaul or network interface 1215.

The controller/processor 1205 can include one or more processors or other processing devices that control the overall operation of the LMF 1200. For example, the controller/processor 1205 can support functions related to positioning and location services. Any of a wide variety of other functions can be supported in the LMF by the controller/processor. In some embodiments, the controller/processor 1205 includes at least one microprocessor or microcontroller.

The controller/processor 1205 is also capable of executing programs and other processes resident in the memory 1210, such as a basic OS. In some embodiments, the controller/processor 1205 supports communications between entities, such as gNB and UE and supports protocols such as LPP and NRPPA. The controller/processor 1205 can move data into or out of the memory as required by an executing process.

The controller/processor 1205 is also coupled to the backhaul or network interface 1215. The backhaul or network interface 1215 allows the LMF to communicate with other devices or systems over a backhaul connection or over a network. The interface 1215 can support communications over any suitable wired or wireless connection(s). For example, when the LMF 1200 is implemented as part of a cellular communication system or wired or wireless local area network (such as one supporting 5G, LTE, or LTE-A), the interface 1215 can allow the LMF 1200 to communicate with gNBs or eNBs or other network elements over a wired or wireless backhaul connection. The interface includes any suitable structure supporting communications over a wired or wireless connection, such as an Ethernet or RF transceiver.

The memory 1210 is coupled to the controller/processor. Part of the memory 1210 can include a RAM, and another part of the memory 1210 can include a Flash memory or other ROM. In certain embodiments, a plurality of instructions, such as a process for transmission timing of SRS for positioning is stored in memory 1210. The plurality of instructions is configured to cause the controller/processor 1205 to perform the process and to perform or support transmission timing of SRS for positioning.

The positioning solutions for release 16 target the following commercial requirements for commercial applications:

TABLE 5

| Requirement characteristic | Requirement target |
|---|---|
| Horizontal Positioning | Indoor: 3 m for 80% of the UEs |
| Error | Outdoor: 10 m for 80% of the UEs |
| Vertical Positioning Error | Indoor: 3 m for 80% of the UEs |
| | Outdoor: 3 m for 80% of the UEs |
| End to end latency | Less than 1 second |

To meet these requirements, radio access technology (RAT)-dependent, RAT independent, and a combination of RAT-dependent and RAT independent positioning schemes have been evaluated. For the RAT-dependent positioning schemes, timing based positioning schemes as well as angle-based positioning schemes have been evaluated. For timing based positioning schemes, NR supports DL Time Difference of Arrival (DL-TDOA), using positioning reference signals (PRS) for time of arrival measurements. NR also supports UL Time Difference of Arrival (UL-TDOA), using sounding reference signals (SRS) for time of arrival measurements. NR also support timing-based position on the SL interface using SL PRS.

NR also supports round-trip time (RTT) with one or more neighboring gNBs or transmission/reception points (TRPs). For angle based positioning schemes, NR exploits the beam-based air interface, supporting downlink angle of departure (DL-AoD) as well as uplink angle of arrival (UL-AoA). Furthermore, NR supports enhanced cell-ID (E-CID) based positioning schemes. RAT independent positioning schemes can be based on global navigation satellite systems (GNSS), WLAN (e.g., WiFi), Bluetooth, Terrestrial Beacon System (TBS), as well as sensors within the UE 116 such as accelerometers, gyroscopes, magnetometers, etc. Some of the UE 116 sensors are also known as Inertial Measurement Unit (IMU).

As NR expands into new verticals, embodiments of the present disclosure recognize there is a need to provide improved and enhanced location capabilities to meet various regulatory and commercial positioning requirements. 3GPP SA1 evaluated the service requirements for high accuracy positioning in TS 22.261 [7] and identified seven service levels for positioning with varying levels of accuracy (horizontal accuracy and vertical accuracy), positioning availability, and latency requirement, as well as positioning type (absolute or relative).

One of the positioning service levels is relative positioning (see table 7.3.2.2-1 of TS 22.261 [7]) with a horizontal and vertical accuracy of 0.2 m, availability of 99%, latency of 1 sec, and targeting indoor and outdoor environments with speed up to 30 km/hr and distance between UEs or a UE and a 5G positioning node of 10 m.

Rel-17 further enhanced the accuracy, latency, reliability, and efficiency of positioning schemes for commercial and HoT applications. Targeting to achieve sub-meter accuracy with a target latency less than 100 ms for commercial applications, and accuracy better than 20 cm with a target latency in the order of 10 ms for HoT applications.

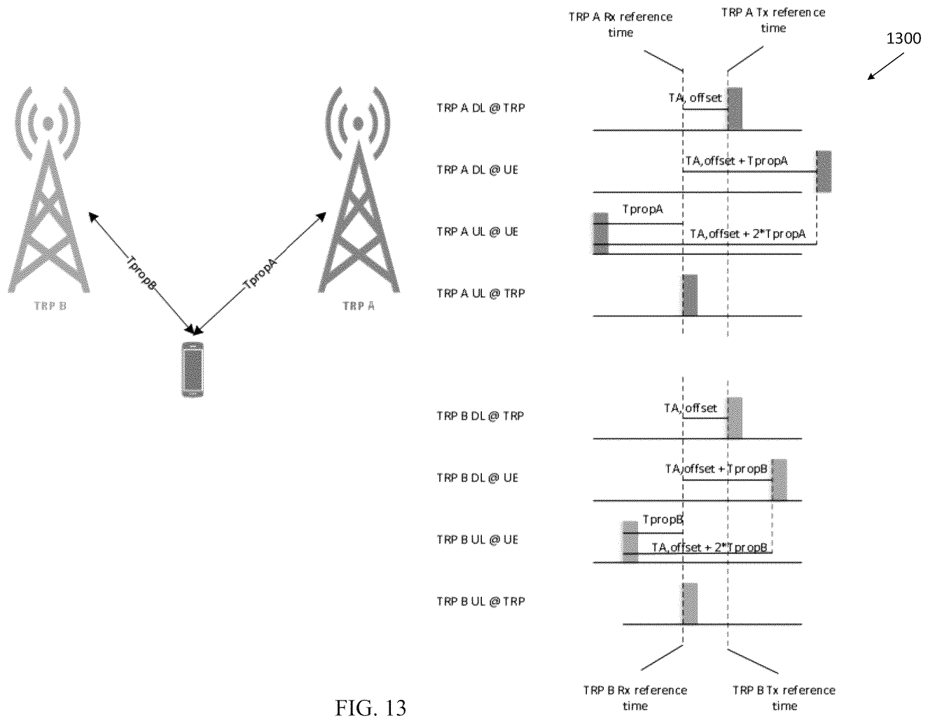

FIG. 13 illustrates a diagram 1300 of an example UE communication with two TRPs according to embodiments of the present disclosure. For example, diagram 1300 of an example UE communication with two TRPs can be utilized by the UE 114 in wireless network 100 of FIG. 1. This example is for illustration only and other embodiments can be used without departing from the scope of the present disclosure.

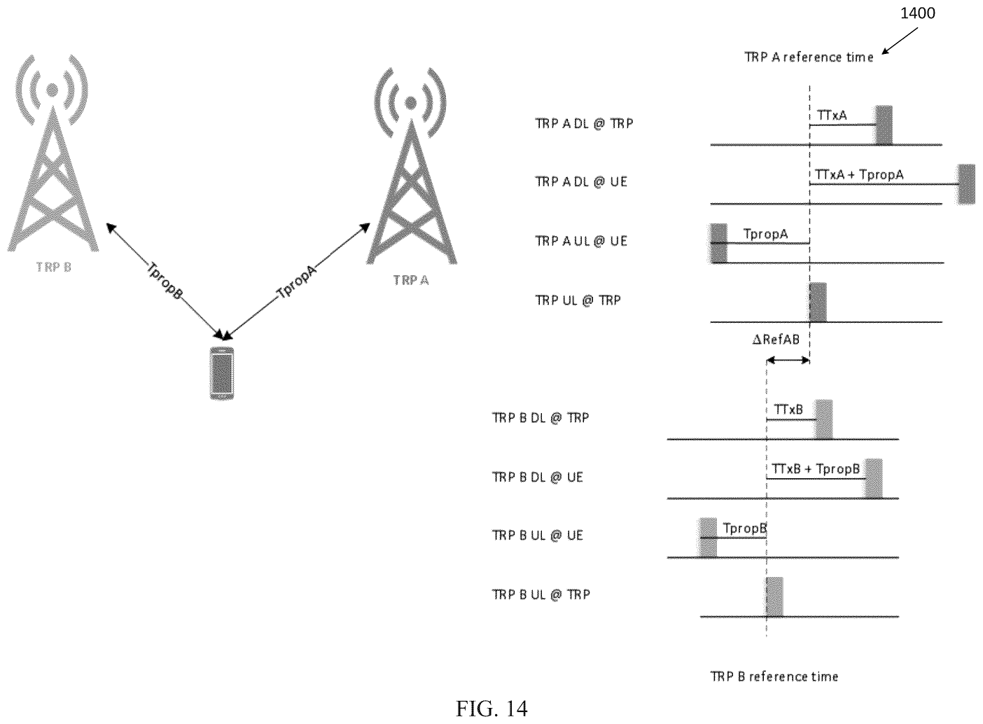

FIG. 14 illustrates a diagram 1400 of an example UE communication with two TRPs according to embodiments of the present disclosure. For example, diagram 1400 of an example UE communication with two TRPs can be utilized by the UE 115 in wireless network 100 of FIG. 1. This example is for illustration only and other embodiments can be used without departing from the scope of the present disclosure.

Rel-18 further enhances RAT-based positioning by targeting new applications through SL positioning on the SL air interface, improving accuracy by using carrier phase measurements and bandwidth aggregation and reducing power and complexity by designing positioning solutions for low-power high-accuracy positioning (LPHAP) and red-cap positioning. For LPHAP, one design objective is to allow a UE in the RRC_INACTIVE state to transmit SRS for positioning to multiple TRPs. The TRPs can be (1) at different distances from the UE 116, and/or (2) are not synchronized in timing. As a result, the UE 116 transmits SRS to each TRP with a different TA value to arrive at the corresponding TRP aligned with its UL receiver time reference. In this disclosure we evaluate how to determine and maintain the TA for each TRP.

3GPP Rel-16 is the firstNR release to introduced RAT-based positioning through work item “NR Positioning Support”. Rel-17 further enhanced accuracy and reduced the latency of NR-based positioning through work item “NR Positioning Enhancements”. In Rel-18, NR positioning is further enhanced. One such enhancement is low-power high-accuracy positioning (LPHAP), wherein a UE can transmit SRS for positioning while in the RRC_INACTIVE state. The SRS is transmitted to multiple TRPs within the SRS positioning validity area. The TRPs might be at different distances from the UE 116 and not synchronized with each other (i.e., the frame or slot boundaries are not aligned at the different TRPs).

With reference to FIG. 13, an example of a UE communicating with two TRPs is shown: TRPA and TRPB. This model can be extended to a UE communicating with more than two TRPs. In this example, TRPA and TRBB are synchronized, i.e., the TRPs have the same Tx reference time and the same Rx reference time. The difference between Tx reference time and the Rx reference time is TA,offset. For example, TA,offset can correspond to the time in units of time (μs, ms or sec) of n-TimingAdvanceOffset (N_{TA,offset}), wherein N_{TA,offset} can be in units of Tc, wherein T_{c}=1/(Δƒₘₐₓ·N_{f}), where Δƒₘₐₓ=480 kHz, N_{f}=4096. In one example N_{TA,offset}=0. In one example N_{TA,offset}=25600. In one example N_{TA,offset}=39936. In one example, N_{TA,offset}=13792.

The propagation delay between the UE 116 and TRPA is Tprop_{A}. The propagation delay between the UE 116 and TRPB is Tprop_{B}. If TRPA transmits a signal at time T₁, the signal arrives at the UE 116 at time Tprop_{A}+T₁, this establishes the Rx time reference at the UE 116. The Tx time reference of the UE 116 is advanced relative to the Rx time reference of the UE 116 by a TA value for corresponding TRP, the TA value (T_{TA}) is the sum of the TA, offset and the round trip propagation delay, i.e.:

$${T}_{TA} = ( {N}_{TA} + {N}_{TA , offset} ) \cdot {T}_{c}$$

where, N_{TA}·T_{c} corresponds to TA, offset, and N_{TA,offset}·T_{c} corresponds to the round-trip propagation delay. For TRPA, N_{TA,offset}·T_{c}=2*Tprop_{A}. Initially, N_{TA} is determined by a random access procedure, i.e., a Type-1 random access procedure where an absolute TA value T_{A} is provided in the RAR as 12-bits, or a Type-2 random access procured where an absolute TA value T_{A} is provided in the MSGB response. T_{A} is 12-bits and related to N_{TA} as follows:

$${N}_{TA} = \frac{{T}_{A} \cdot 16 \cdot 64}{{2}^{μ}}$$

When a UE is signaled T_{A-A} for TRPA, the UE 116 can calculate N_{TA-A} for TRPA using the last equation. The UE 116 then determines the time advance value for TRPA (this is the advance of the transmit time to TRPA relative to the receive time from TRPA) as: T_{TA-A}−(N_{TA-A}+N_{TA,offset-A})·T_{c}.

When the UE 116 transmits an uplink signal at UE's Tx reference time, as mentioned herein, the signal arrives at the at TRPA at TRPA's Rx reference time. As each TRP has a different round-trip delay to the UE 116, each TRP would have its own reference receive and transmit timings at the UE 116. For example, (this is for the case when the TRPs are synchronized):
If the Tx reference time of TRPA is T₁ and the Tx reference time of TRPB is T₁ (TRPA and TRPB are synchronized), the Rx time of TRPA at the UE 116 is T₁+Tprop_{A}, and the Rx time of TRPB at the UE 116 is T₁+Tprop_{B}. Therefore, the Rx time of TRPA at the UE 116 is before the Rx time of TRPB at the UE 116 by Tprop_{B}−Tprop_{A}. Equivalently, the Rx time of TRP A at the UE 116 is after the Rx time of TRPB at the UE 116 by Tprop_{A}−Tprop_{B}.
The Tx time to a TRP at the UE 116 is advanced relative to the Rx time from the TRP at the UE 116 by N_{TA,offset}·T_{c}+2*Tprop, where N_{TA,offset}−T_{c} corresponds to TA,offset and 2*Tprop corresponds to the round-trip propagation delay between the UE 116 and the TRP. Therefore, the Tx time to TRPA at the UE 116 is T₁−N_{TA,offset}·T_{c}−Tprop_{A}, and the Tx time to TRPB at the UE 116 is T₁−N_{TA,offset}·T_{c}−Tprop_{B}. The Tx time of TRP A at the UE 116 is before the Rx time of TRPB at the UE 116 by Tprop_{A}−Tprop_{B}. Equivalently, the Rx time of TRP A at the UE 116 is after the Rx time of TRPB at the UE 116 by Tprop_{B}−Tprop_{A}. This assumes that both TRPs have the same TA, offset (N_{TA,offset}).

With reference to FIG. 14, a second example of a UE communicating with two TRPs is shown: TRPA and TRPB. This model can be extended to a UE communicating with more than two TRPs. In this example, TRPA and TRBB are not synchronized. The reference time of TRPA is after the reference time of TRPB by ΔREF_{AB}. FIG. 14 shows the same Tx reference time and Rx reference time at each TRP (i.e., N_{TA,offset}=0) while the following discussion also applies when N_{TA,offset}≠0.

As each TRP has a different round-trip delay to the UE 116 and the TRPs are not synchronized, each TRP would have its own reference receive and transmit timings at the UE 116. For example, (this is for the case when the TRPs are not synchronized):
If the Tx reference time of TRPA is T₁ and the Tx reference time of TRPB is T₁−ΔREF_{AB} (ΔREF_{AB} is the offset between TRPA and TRPB), the Rx time of TRPA at the UE 116 is T₁+Tprop_{A} and the Rx time of TRPB at the UE 116 is T₁+Tprop_{B}−ΔREF_{AB}. Therefore, the Rx time of TRPA at the UE 116 is before the Rx time of TRPB at the UE 116 by Tprop_{B}−Tprop_{A}−ΔREF_{AB}. Equivalently, the Rx time of TRP A at the UE 116 is after the Rx time of TRPB at the UE 116 by Tprop_{A}−Tprop_{B}+ΔREF_{AB}.
The Tx time to a TRP at the UE 116 is advanced relative to the Rx time from the TRP at the UE 116 by N_{TA,offset}·T_{c}+2*Tprop, where N_{TA,offset}·T_{c} corresponds to TA,offset and 2*Tprop corresponds to the round-trip propagation delay between the UE 116 and the TRP. Therefore, the Tx time to TRPA at the UE 116 is T₁−N_{TA,offset}·T_{c}−Tprop_{A} and the Tx time to TRPB at the UE 116 is T₁−N_{TA,offset}·T_{c}−Tprop_{B}−ΔREF_{AB}. The Tx time of TRP A at the UE 116 is before the Rx time of TRPB at the UE 116 by Tprop_{A}−Tprop_{B}−ΔREF_{AB}. Equivalently, the Rx time of TRP A at the UE 116 is after the Rx time of TRPB at the UE 116 by Tprop_{B}−Tprop_{A}+ΔREF_{AB}. This assumes that both TRPs have the same TA, offset (N_{TA,offset}).

In this disclosure, we evaluate method(s) and procedures to determine one or more TA values when transmitting SRS for positioning to multiple TRPs (or cells) within the SRS positioning validity area when the UE 116 is in RRC_INACTIVE state.

The present disclosure relates to a 5G/NR communication system.

This disclosure introduces signaling and methods for:
Determination of UL transmission time of SRS for positioning to a TRP based on difference in receive timing from multiple TRPs.
Determination of UL transmission time of SRS for positioning to a TRP based on timing determined from a RACH procedure triggered towards that TRP.
Using a combination of difference in receive timing from multiple TRPs and RACH procedures triggered towards the TRPs to determine the transmission timing of SRS for positioning.
Using positioning reference unit (PRU) like UEs to determine difference in reference timing between TRPs.

In this disclosure, RRC signaling can refer to (1) cell-level RRC signaling, e.g., using SIB1 or other SIBs, or (2) UE-dedicated RRC signaling. In this disclosure L1 control signaling can be (1) UE-specific L1 control signaling, or (2) UE-common L1 control signaling to a group or to all UEs in the cell.

In this disclosure a TRP can replaced by a cell or a physical cell identity (PCI).

In one example, the UL positioning reference signal (e.g., Positioning Sounding Reference Signal—Pos-SRS) in this disclosure is a reference signal designed for LPHAP.

In one example, the UL positioning reference signal (e.g., Positioning Sounding Reference Signal—Pos-SRS) in this disclosure is a reference signal introduced in the Rel-16 and Rel-17 3GPP specifications for positioning.

A UE is in the RRC_INACTIVE state and is within a SRS positioning validity area. The UE 116 can send an SRS for positioning to multiple TRPs within the SRS positioning validity area.

In one example, the TRPs are associated with a same physical cell identity (PCI).

In one example, the TRPs are associated with different PCIs.

In one example, each TRP is associated with a different PCI.

In one example, the UE 116 can use the same timing advance value when transmitting SRS for positioning to different TRPs within the SRS positioning validity area.

In one example, the UE 116 can use different timing advance values when transmitting SRS for positioning to different TRPs within the SRS positioning validity area.

In one example, there is a maximum number of PCIs or TRPs within the SRS positioning validity area Nₘₐₓ. In one example, Nₘₐₓ depends on a UE capability. In one example, Nₘₐₓ is reported by the UE 116. In one example, Nₘₐₓ is specified in the specifications. For example, Nₘₐₓ can be 7 or 8 or 15 or 16 or any other value. In one example, Nₘₐₓ can be configured and/or updated by RRC signaling and/or MAC control element (CE) signaling and/or L1 control signaling. In one example, in addition to a Nₘₐₓ specified in the specifications and/or configured, a UE can have a UE-specific maximum number of PCIs or TRPs within the SRS positioning validity area. For example, the UE 116 specific maximum number of PCIs or TRPs can be denoted as N_{max-UE}. In one example, each PCI or TRP has an index i, for example the UE 116 is configured with an index i for each TRP or PCI within the SRS positioning validity, wherein the configuration can be RRC signaling and/or MAC CE signaling and/or L1 control signaling. In one example, the index i is in range 0, 1, . . . , Nₘₐₓ−1. In one example, the index i is in range 0, 1, . . . , N_{max-UE}−1. In one example, if a UE is camping on a PCI of cell, or on a TRP, that PCI or that TRP has index 0. In one example, the TRP or the cell on which the UE 116 is camping can be used to determine a reference time at the UE 116 (e.g., the receive time of a DL transmission from the TRP or cell).

In one example, the UE 116 has one reference downlink timing. For example, the reference downlink time is determined based on SSB reception from a first TRP. The uplink transmission of SRS to each TRP is determined based on (relative to) that reception time.
In one example, the first TRP is the TRP on which the UE 116 is camping.
In one example, the first TRP is the TRP for which the UE 116 is informed or has determined or can determine a TA value.
In one example, the first TRP can be configured or updated by RRC signaling and/or MAC CE signaling and/or L1 control signaling.
In one example, the first TRP is a TRP which has the largest SSB (SS/PBCH Block or Synchronization Signal Block) RSRP/Reference signal received quality (RSRQ)—the largest SSB RSRP/RSRQ can be based one of the following: (1) the RSRP/RSRQ of an SSB of the first TRP or (2) the sum of RSRP/RSRQ from all SSBs of the first TRP or (3) the average RSRP/RSRQ of all SSBs of the first TRP.
In one example, the first TRP is a TRP which has the largest SSB Signal to Interference and Noise Ratio (SINR)—the largest SSB SINR can be based one of the following (1) the SINR of an SSB of the first TRP or (2) the sum of SINR from all SSBs of the first TRP or (3) the average SINR of all SSBs of the first TRP.
In one example, the first TRP is determined based on the UE 116's own implementation.
In one example, the first TRP is determined based on the UE 116's own implementation and such that SSB RSRP/RSRQ is above a threshold. The threshold can be configured by or updated by RRC signaling and/or MAC CE signaling and/or L1 control signaling. The SSB RSRP/RSRQ can be based one of the following: (1) the RSRP/RSRQ of an SSB of the first TRP or (2) the sum of RSRP/RSRQ from all SSBs of the first TRP or (3) the average RSRP/RSRQ of all SSBs of the first TRP.
In one example, the first TRP is determined based on the UE 116's own implementation and such that SSB SINR is above a threshold. The threshold can be configured by or updated by RRC signaling and/or MAC CE signaling and/or L1 control signaling. The SSB SINR can be based one of the following: (1) the SINR of an SSB of the first TRP or (2) the sum of SINR from all SSBs of the first TRP or (3) the average SINR of all SSBs of the first TRP.

The SSB of the first TRP used to determine the timing can be based on:
In one example, the SSB of the first TRP with the largest RSRP/RSRQ.
In one example, the SSB of the first TRP with the largest SINR
In one example, the SSB of the first TRP can be determined based on the UE 116's own implementation.
In one example, the SSB of the first TRP can be determined based on the UE 116's own implementation such that the SSB RSRP/RSRQ is above a threshold. The threshold can be configured by or updated by RRC signaling and/or MAC CE signaling and/or L1 control signaling.
In one example, the SSB of the first TRP can be determined based on the UE 116's own implementation such that the SSB SINR is above a threshold. The threshold can be configured by or updated by RRC signaling and/or MAC CE signaling and/or L1 control signaling.
In one example, the SSB can be configured by or updated by RRC signaling and/or MAC CE signaling and/or L1 control signaling.

Assume that the determined SSB of the first TRP is transmitted at time T₁.

The SSB of the first TRP (e.g., TRPA) arrives at the UE 116 at time T₂=T₁+Tprop_{A}, where Tprop_{A} is the one way propagation delay between the first TRP and the UE 116, wherein T₂ is the reference receive timing at the UE 116.

The UL transmission time to the first TRP at the UE 116 is T₃=T₁−N_{TA,offset}·T_{c}−Tprop_{A}−T₂−N_{TA,offset}·T_{c}−2*Tprop_{A}, wherein N_{TA,offset}·T_{c} is the TA offset (i.e., the difference between the Tx reference time and Rx reference time at the TRP).

The UL transmission time to a second TRP (e.g., TRPB) at the UE 116 is T₁−N_{TA,offset}·T_{c}−Tprop_{B}−ΔREF_{AB}, where
Tprop_{B} is the one-way propagation delay between the second TRP and the UE 116.
ΔREF_{AB} is difference between a reference time at the first TRP (TRPA) and a reference time at the second TRP (TRPB) as shown in FIG. 14
N_{TA,offset} is assumed to be the same for first TRP and the second TRP.

Relative to the receive time of the first TRP (i.e., T₂), the transmission time to the second TRP is T₂−N_{TA,offset}·T_{c}−Tprop_{A}−Tprop_{B}−ΔREF_{AB}.

Relative to the transmit time of the first TRP (i.e., T₃), the transmission time to the second TRP is T₃+Tprop_{A}−Tprop_{B}−ΔREF_{AB}.

In one example, N_{TA,offset} can be different for each TRP; for the first TRP N_{TA,offset-A} and/or for the second TRP N_{TA,offset-B}. In one example, N_{TA,offset} is configured for a TRP or for a cell or for a PCI.

The UL transmission time to the second TRP at the UE 116 is: T₁−N_{TA,offset-B}·T_{c}−Tprop_{B}−ΔREF_{AB}.

Relative to the receive time of the first TRP (i.e., T₂), the transmission time to the second TRP is T₂−N_{TA,offset-B}·T_{c}−Tprop_{A}−Tprop_{B}−ΔREF_{AB}.

Relative to the transmit time of the first TRP (i.e., T₃), the transmission time to the second TRP is T₃−(N_{TA,offset-B}−N_{TA,offset-A})·T_{c}+Tprop_{A}−Tprop_{B}−ΔREF_{AB}.

In a further example, there are additional TRPs and the transmission time of the SRS for positioning to each TRP is based on the timing of the first TRP as mentioned herein.

In one example, the UE 116 has multiple reference downlink timings. For example, each reference downlink time within the multiple reference downlink timings for UL SRS for positioning transmission to a TRP is determined based on an SSB reception from the TRP. The SSB used to determine the timing can be based on:
In one example, the SSB of the TRP with the largest RSRP/RSRQ.
In one example, the SSB of the TRP with the largest SINR
In one example, the SSB of the TRP can be determined based on the UE 116's own implementation.
In one example, the SSB of the TRP can be determined based on the UE 116's own implementation and such the SSB RSRP/RSRQ is above a threshold. The threshold can be configured by or updated by RRC signaling and/or MAC CE signaling and/or L1 control signaling.
In one example, the SSB of the TRP can be determined based on the UE 116's own implementation such that the SSB SINR is above a threshold. The threshold can be configured by or updated by RRC signaling and/or MAC CE signaling and/or L1 control signaling.
In one example, the SSB can be configured by or updated by RRC signaling and/or MAC CE signaling and/or L1 control signaling.

Assume that the determined SSB of the TRP is transmitted at time: T₁.

The SSB of the first TRP (e.g., TRPA) arrives at the UE 116 at time T₂=T₁+Tprop_{A}, where Tprop_{A} is the one way propagation delay between the TRP and the UE 116. Wherein, T₂ is the reference receive timing at the UE 116.

The UL transmission time to the corresponding TRP at the UE 116 is T₃=T₁-N_{TA,offset}·T_{c}−Tprop_{A}−T₂−N_{TA,offset}·T_{c}−2*Tprop_{A}, wherein N_{TA,offset}·T_{c} is the TA,offset (i.e., the difference between the Tx reference time and Rx reference time at the TRP).

In one example, N_{TA,offset} is the same for all TRPs.

In one example, N_{TA,offset} can be configured for each TRP.

In one example, the TRPs (e.g., in the same validity area) are synchronized. The UE 116 determines the receive timing of a first TRP. The first TRP can be the TRP used to determine the downlink reference (e.g., receive) time at the UE 116 as mentioned herein. The transmit time of the determined SSB from the first TRP is T₁. The received time of the SSB at the UE 116 is T₁+Tprop_{A}, wherein Tprop_{A} is the one way propagation delay between the first TRP and the UE 116.

The UE 116 determines an SSB for a second TRP. The second TRP can be the TRP towards which the UE 116 is transmitting an SRS for positioning. The SSB for the second TRP can be determined based one of the following:
In one example, the SSB of the second TRP with the largest RSRP/RSRQ.
In one example, the SSB of the second TRP with the largest SINR
In one example, the SSB of the second TRP can be determined based on the UE 116's own implementation.
In one example, the SSB of the second TRP can be determined based on the UE 116's own implementation such that the SSB RSRP/RSRQ is above a threshold. The threshold can be configured by or updated by RRC signaling and/or MAC CE signaling and/or L1 control signaling.
In one example, the SSB of the second TRP can be determined based on the UE 116's own implementation such that the SSB SINR is above a threshold. The threshold can be configured by or updated by RRC signaling and/or MAC CE signaling and/or L1 control signaling.
In one example, the SSB can be configured by or updated by RRC signaling and/or MAC CE signaling and/or L1 control signaling.

The transmit time of the determined SSB from the second TRP is T₁ (first and second TRPs are synchronized), the received time of the SSB at the UE 116 is T₁+Tprop_{B}, wherein Tprop_{B} is the one way propagation delay between the second TRP and the UE 116.

The UE 116 can determine the difference in receive time between the first TRP and second TRP: Δ_{RX}=(T₁+Tprop_{B})−(T₁+Tprop_{A}). Therefore, Δ_{RX}=Tprop_{B}−Tprop_{A}. If the SSB from the first TRP and the SSB from the second TRP are transmitted at different times (e.g., in different frames, or subframes, or slots or OFDM symbols), the difference in transmission time is taken into account when calculating Δ_{RX}. In a variant example, the UE 116 can use CSI-RS or DL PRS or other DL channels or signals from the first TRP and the second TRP to determine Δ_{RX}.

The UE 116 can determine the transmit time of the positioning SRS to the second TRP relative to its transmit time to the first TRP, T₃ as mentioned herein, as:

$${T}_{3} + {Tprop}_{A} - {Tprop}_{B} = {T}_{3} - {Δ}_{RX}$$

When the UE 116 knows the transmit time to the first TRP, and Δ_{RX} (based on the measurement mentioned herein), the UE 116 can determine the transmit time to second TRP. In one example, the UE 116 is informed or determines the TA value for the first TRP and then can determine T₃.

The last equation can apply when N_{TA,offset} of the first TRP and the second TRP are the same. If the first TRP has N_{TA,offset-A} and the second TRP has N_{TA,offset-B}. The UE 116 can determine the transmit time of the positioning SRS to the second TRP relative to its transmit time to the first TRP, T₃ as mentioned herein, as:

$${T}_{3} - ( {N}_{TA , offset - B} - {N}_{TA , offset - A} ) \cdot {T}_{c} - {Δ}_{RX}$$

The TA value for the first TRP is given by

$${T}_{TA - A} = {N}_{TA , offset - A} \cdot {T}_{c} + 2 * {Tprop}_{A}$$

Therefore, T₃=T₂−T_{TA-A}, where T₂ is the receive time from the first TRP.

Therefore, if N_{TA,offset-A}=N_{TA,offset-B}, the UE 116 can determine the transmit time of the positioning SRS to the second TRP relative to its receive time from the first TRP, T₃ as mentioned herein, as:

$${T}_{2} - {T}_{TA - A} - {Δ}_{RX}$$

if N_{TA,offset-A}≠N_{TA,offset-B}, the UE 116 can determine the transmit time of the positioning SRS to the second TRP relative to its receive time from the first TRP, T₃ as mentioned herein, as:

$${T}_{2} - {T}_{TA - A} - ( {N}_{TA , offset - B} - {N}_{TA , offset - A} ) \cdot {T}_{c} - {Δ}_{RX}$$

In one example, the TRPs are not synchronized. The UE 116 determines the receive timing of a first TRP, the first TRP can be the TRP used to determine the downlink reference time at the UE 116 as mentioned herein. The transmit time of the determined SSB from the first TRP is T₁, the received time of the SSB at the UE 116 is T₁+Tprop_{A}, wherein Tprop_{A} is the one way propagation delay between the first TRP and the UE 116.

The UE 116 determines an SSB for a second TRP. The second TRP can be the TRP towards which the UE 116 is transmitting an SRS for positioning. The SSB for the second TRP can be determined based one of the following:
In one example, the SSB of the second TRP with the largest RSRP/RSRQ.
In one example, the SSB of the second TRP with the largest SINR.
In one example, the SSB of the second TRP can be determined based on the UE 116's own implementation.
In one example, the SSB of the second TRP can be determined based on the UE 116's own implementation such that the SSB RSRP/RSRQ is above a threshold. The threshold can be configured by or updated by RRC signaling and/or MAC CE signaling and/or L1 control signaling.
In one example, the SSB of the second TRP can be determined based on the UE 116's own implementation such that the SSB SINR is above a threshold. The threshold can be configured by or updated by RRC signaling and/or MAC CE signaling and/or L1 control signaling.
In one example, the SSB can be configured by or updated by RRC signaling and/or MAC CE signaling and/or L1 control signaling.

The transmit time of the determined SSB from the second TRP is T₁−ΔREF_{AB} (first and second TRPs are not synchronized. The first TRP's reference time is after the second TRP's reference by ΔREF_{AB}). The received time of the SSB at the UE 116 is T₁+Tprop_{B}−ΔREF_{AB}, wherein Tprop_{B} is the one way propagation delay between the second TRP and the UE 116.

The UE 116 can determine the difference in receive time between the first TRP and second TRP: Δ_{RX}=(T₁+Tprop_{B}−ΔREF_{AB})−(T₁+Tprop_{A}). Therefore, Δ_{RX}=Tprop_{B}−Tprop_{A}−ΔREF_{AB}. This has two components, the first depends on the propagation delay difference and the second depends on the difference between reference times of the two TRPs. If the SSB from the first TRP and the SSB from the second TRP are transmitted at different times (e.g., in different frames, or subframes, or slots or OFDM symbols), the difference in transmission time is taken into account when calculating Δ_{RX}. In a variant example, the UE 116 can use CSI-RS or DL PRS or other DL channels or signals from the first TRP and the second TRP to determined Δ_{RX}.

The UE 116 can determine the transmit time of the positioning SRS to the second TRP relative to its transmit time to the first TRP, T₃ as mentioned herein, as:

$${T}_{3} + {Tprop}_{A} - {Tprop}_{B} - Δ {REF}_{AB} = {T}_{3} - {Δ}_{RX} - 2 * Δ {REF}_{AB}$$

When the UE 116 knows the transmit time to the first TRP and Δ_{RX} (based on the measurement mentioned herein) and the difference in reference times between the first TRP and the second TRP, the UE 116 can determine the transmit time to second TRP. In one example, the UE 116 is informed or determines the TA value for the first TRP and the can determine T₃. In one example, the UE 116 is informed or configured the difference between the reference time of the first TRP and the second TRP, e.g., ΔREF_{AB}.

The last equation can apply when N_{TA,offset} of the first TRP and the second TRP are the same. If the first TRP has N_{TA,offset-A} and the second TRP has N_{TA,offset-B}. The UE 116 can determine the transmit time of the positioning SRS to the second TRP relative to its transmit time to the first TRP, T₃ as mentioned herein, as:

$${T}_{3} - ( {N}_{TA , offset - B} - {N}_{TA , offset - A} ) \cdot {T}_{c} - {Δ}_{RX} - 2 * Δ {REF}_{AB}$$

The TA value for the first TRP is given by

$${T}_{TA - A} = {N}_{TA , offset - A} \cdot {T}_{c} + 2 * {Tprop}_{A}$$

Therefore, T₃=T₂−T_{TA-A}, where T₂ is the receive time from the first TRP.

Therefore, if N_{TA,offset-A}=N_{TA,offset-B}, the UE 116 can determine the transmit time of the positioning SRS to the second TRP relative to its receive time from the first TRP, T₂ as mentioned herein, as:

$${T}_{2} - {T}_{TA - A} - {Δ}_{RX} - 2 * Δ {REF}_{AB}$$

If N_{TA,offset-A}≠N_{TA,offset-B}, the UE 116 can determine the transmit time of the positioning SRS to the second TRP relative to its receive time from the first TRP, T₂ as mentioned herein, as:

$${T}_{2} - {T}_{TA - A} - ( {N}_{TA , offset - B} - {N}_{TA , offset - A} ) \cdot {T}_{c} - {Δ}_{RX} - 2 * Δ {REF}_{AB}$$

In one example, the TRPs are synchronized. The UE 116 determines the receive timing of a first TRP. The transmit time of the determined SSB from the first TRP is T₁, the received time of the SSB at the UE 116 is T₁+Tprop_{A}, wherein Tprop_{A} is the one way propagation delay between the first TRP and the UE 116.

If the UE 116 is informed or determines the TA of the first TRP, i.e., T_{TA-A}, the UE 116 can determine the transmit time to the first TRP of the SRS for positioning relative to the receive time from the first TRP (T₂) as:

T₂−T_{TA-A}

In one example, the UE 116 is informed or determines T_{TA-B} for a second TRP. The UE 116 is not informed T_{TA-A} of the first TRP. The UE 116 determines an SSB of the second TRP as mentioned herein. The transmit time of the determined SSB from the second TRP is T₁ (first and second TRPs are synchronized), the received time of the SSB at the UE 116 is T₁+Tprop_{B}, wherein Tprop_{B} is the one way propagation delay between the second TRP and the UE 116.

The UE 116 can determine the difference in receive time between the first TRP and second TRP: Δ_{RX}=(T₁+Tprop_{B})−(T₁+Tprop_{A}). Therefore, Δ_{RX}=Tprop_{B}−Tprop_{A}. If the SSB from the first TRP and the SSB from the second TRP are transmitted at different times (e.g., in different frames, or subframes or slots or OFDM symbols), the difference in transmission time is taken into account when calculating Δ_{RX}.

$$If$$

$${N}_{TA , offset - A} = {N}_{TA , offset - B} = {N}_{TA , offset} :$$

$${T}_{TA - A} = {N}_{TA , offset} \cdot {T}_{c} + 2 * {Tprop}_{A}$$

$$and$$

$${T}_{TA - B} = {N}_{TA , offset} \cdot {T}_{c} + 2 * {Tprop}_{B}$$

therefore,

$${T}_{TA - A} = {T}_{TA - B} - 2 * ( {Tprop}_{B} - {Tprop}_{A} ) = {T}_{TA - B} - 2 * {Δ}_{RX}$$

Hence, the UE 116 can determine the transmit time to the first TRP of the SRS for positioning relative to the receive time from the first TRP (T₂) as:

$${T}_{2} - {T}_{TA - B} + 2 * {Δ}_{RX}$$

Hence, by knowing T_{TA-B} of the second TRP and difference in receive timing between the first and the second TRP (i.e., Δ_{RX}), the UE 116 can determine the transmit time to the first TRP relative to the receive time of the first TRP.

$$If$$

$${N}_{TA , offset - A} \neq {N}_{TA , offset - B} :$$

$${T}_{TA - A} = {N}_{TA , offset - A} \cdot {T}_{c} + 2 * {Tprop}_{A}$$

$$and$$

$${T}_{TA - B} = {N}_{TA , offset - B} \cdot {T}_{c} + 2 * {Tprop}_{B}$$

therefore,

$${T}_{TA - A} = {T}_{TA - B} - ( {N}_{TA , offset - B} - {N}_{TA , offset - A} ) - 2 * ( {Tprop}_{B} - {Tprop}_{A} ) = {T}_{TA - B} - ( {N}_{TA , offset - B} - {N}_{TA , offset - A} ) - 2 * {Δ}_{RX}$$

Hence, the UE 116 can determine the transmit time to the first TRP of the SRS for positioning relative to the receive time from the first TRP (T₂) as:

$${T}_{2} - {T}_{TA - B} + ( {N}_{TA , offset - B} - {N}_{TA , offset - A} ) + 2 * {Δ}_{RX}$$

Hence, by knowing T_{TA-B} of the second TRP and difference in receive timing between the first and the second TRP (i.e., Δ_{RX}), and N_{TA,offset} for each TRP, the UE 116 can determine the transmit time to the first TRP relative to the receive time of the first TRP.

In one example, the TRPs are not synchronized. The UE 116 determines the receive timing of a first TRP. The transmit time of the determined SSB from the first TRP is T₁, the received time of the SSB at the UE 116 is T₁+Tprop_{A}, wherein Tprop_{A} is the one way propagation delay between the first TRP and the UE 116.

If the UE 116 is informed or determines the TA of the first TRP, i.e., T_{TA-A}, the UE 116 can determine the transmit time to the first TRP of the SRS for positioning relative to the receive time from the first TRP (T₂) as:

T₂−T_{TA-A}

In one example, the UE 116 is informed or determines T_{TA-B} for a second TRP. The UE 116 is not informed T_{TA-A} of the first TRP. The UE 116 determines an SSB of the second TRP as mentioned herein. The transmit time of the determined SSB from the second TRP is T₁-ΔREF_{AB} (first and second TRPs are not synchronized, the first TRP's reference time is after the second TRP's reference by ΔREF_{AB}). The received time of the SSB at the UE 116 is T₁+Tprop_{B}−ΔREF_{AB}, wherein Tprop_{B} is the one way propagation delay between the second TRP and the UE 116.

The UE 116 can determine the difference in receive time between the first TRP and second TRP: Δ_{RX}=(T₁+Tprop_{B}−ΔREF_{AB})−(T₁+Tprop_{A}). Therefore, Δ_{RX}=Tprop_{B}−Tprop_{A}−ΔREF_{AB}. If the SSB from the first TRP and the SSB from the second TRP are transmitted at different times (e.g., in different frames, or subframes or slots or OFDM symbols), the difference in transmission time is taken into account when calculating Δ_{RX}.

$$If {N}_{TA , offset - A} = {N}_{TA , offset - B} = {N}_{TA , offset} : \\ {T}_{TA - A} = {N}_{TA , offset} \cdot {T}_{c} + 2 * {Tprop}_{A} \\ and \\ {T}_{TA - B} = {N}_{TA , offset} \cdot {T}_{c} + 2 * {Tprop}_{B}$$

therefore,

$${T}_{TA - A} = {T}_{TA - B} - 2 * ( {Tprop}_{B} - {Tprop}_{A} ) = {T}_{TA - B} - 2 * {Δ}_{RX} - 2 * Δ {REF}_{AB}$$

Hence, the UE 116 can determine the transmit time to the first TRP of the SRS for positioning relative to the receive time from the first TRP (T₂) as:

$${T}_{2} - {T}_{TA - B} + 2 * {Δ}_{RX} + 2 * Δ {REF}_{AB}$$

Hence, by knowing T_{TA-B} of the second TRP and difference in receive timing between the first and the second TRP (i.e., Δ_{RX}), and the difference between reference time of the first TRP and the second TRP (i.e., ΔREF_{AB}), the UE 116 can determine the transmit time to the first TRP relative to the receive time of the first TRP.

$$If {N}_{TA , offset - A} \neq {N}_{TA , offset - B} : \\ {T}_{TA - A} = {N}_{TA , offset - A} \cdot {T}_{c} + 2 * {Tprop}_{A} \\ and \\ {T}_{TA - B} = {N}_{TA , offset - B} \cdot {T}_{c} + 2 * {Tprop}_{B}$$

therefore,

$$\begin{matrix}{T}_{TA - A} = {T}_{TA - B} - ( {N}_{TA , offset - B} - {N}_{TA , offset - A} ) - 2 * ( {Tprop}_{B} - {Tprop}_{A} ) - \\ 2 * Δ {REF}_{AB} \\ = {T}_{TA - B} - ( {N}_{TA , offset - B} - {N}_{TA , offset - A} ) - 2 * {Δ}_{RX} - 2 * Δ {REF}_{AB}\end{matrix}$$

Hence, the UE 116 can determine the transmit time to the first TRP of the SRS for positioning relative to the receive time from the first TRP (T₂) as:

$${T}_{2} - {T}_{TA - B} + ( {N}_{TA , offset - B} - {N}_{TA , offset - A} ) + 2 * {Δ}_{RX} + 2 * Δ {REF}_{AB}$$

Hence, by knowing T_{TA-B} of the second TRP and difference in receive timing between the first and the second TRP (i.e., Δ_{RX}), and the difference between reference time of the first TRP and the second TRP (i.e., ΔREF_{AB}), and N_{TA,offset} for each TRP, the UE 116 can determine the transmit time to the first TRP relative to the receive time of the first TRP.

In one example, to determine the TA when transmitting SRS for positioning towards a TRP, a random access procedure is triggered to towards that TRP.

In one example, the random access procedure is PDCCH-order triggered random access procedure.

In one example, the random access procedure is a CFRA PDCCH-order triggered random access procedure.

In one example, the CFRA PDCCH-order is triggered by one TRP towards the same TRP.

In one example, the CFRA PDCCH-order is triggered by one TRP towards another TRP. In one example, the PDCCH order includes an index of the PCI of the TRP or an index of the TRP towards which the PDCCH is being triggered. In one example if the maximum number of PCIs or TRPs in a SRS positioning validity area is Nₘₐₓ or N_{max-UE} as mentioned herein, the size of the field in the PDDCH order to convey the index of the PCI or the index of the TRP is ┌log₂ Nₘₐₓ┐ or ┌log₂ N_{max-UE}┐, wherein the index of the PCI or TRP is as configured as mentioned herein.

In one example, the TRP or PCI from which to trigger the PDDCH order is the TRP or PCI the UE 116 is camping on. In one example, the TRP or PCI from which to trigger the PDDCH order is configured or determined by the network 130.

In one example, the random access procedure is a CBRA PDCCH-order triggered random access procedure.

In one example, the CBRA PDCCH-order is triggered by one TRP towards the same TRP.

In one example, the CBRA PDCCH-order is triggered by one TRP towards another TRP. In one example, the PDCCH order includes an index of the PCI of the TRP or an index of the TRP towards which the PDCCH is being triggered. In one example if the maximum number of PCIs or TRPs in a SRS positioning validity area is Nₘₐₓ or N_{max-UE} as mentioned herein, the size of the field in the PDDCH order to convey the index of the PCI or the index of the TRP is ┌log₂ Nₘₐₓ┐ or ┌log₂ N_{max-UE}┐, wherein the index of the PCI or TRP is as configured as mentioned herein. In one example, the TRP or PCI from which to trigger the PDDCH order is the TRP or PCI the UE 116 is camping on. In one example, the TRP or PCI from which to trigger the PDDCH order is configured or determined by the network 130.

In one example, the random access procedure is higher-layer triggered random access procedure.

In one example, the random access procedure is higher-layer triggered contention-based random access procedure.

In one example, the random access procedure is higher-layer triggered contention-free random access procedure.

In one example, the random access procedure is higher-layer triggered random access procedure, triggered by the UE 116.

In one example, the random access procedure is higher-layer triggered random access procedure, triggered by the gNB 102.

In one example, the random access procedure triggered is a type-1 random access procedure (also known as 4-step RACH). The TA value can be included in RAR response.

In one example, the random access procedure triggered is a type-2 random access procedure (also known as 2-step RACH). The TA value can be included in the MsgB.

In one example, after the RACH procedure and the TA value for a PCI or a TRP is determined, the network 130 may update the TA value through a MAC-CE that includes a TA command. For example, the TA update can be determined based on the SRS for positioning sent towards a TRP.

In one example, the MAC CE with TA command can be sent from any PCI or TRP, for example, such as the PCI or TRP towards which the SRS for positioning is transmitted.

In one example, the MAC CE with TA command is sent from the PCI or TRP on which the UE 116 is camping. For example, the PCI or TRP towards which the SRS for positioning is sent can measure the time of arrival of the SRS for positioning and determine if a TA adjustment is needed and send the TA command to the PCI or TRP or which the UE 116 is camping, which sends the TA command to the UE 116.

In one example, the MAC CE with TA command is sent from the PCI or TRP configured by the network 130.

In one example, N_{TA} can be indicated in an absolute timing advance MAC CE command. In which case, the timing advance command can signal an absolute value, T_{A}, which is 12-bits.

$${N}_{TA} = \frac{{T}_{A} \cdot 16 \cdot 64}{{2}^{μ}}$$

wherein, μ is the sub-carrier spacing configuration.

For example, T_{A-A} for UL transmissions (e.g. SRS for positioning) to TRPA can be signalled, N_{TA-A} can be determined based on the last equation, and the time advance at the UE 116 to TRPA is determined as: T_{TA-A}=N_{TA,offset-A}·T_{c}+N_{TA-A}·T_{c}. Similar equations hold for TRPB.

In one example, the change in value of N_{TA} can be indicated in a Timing Advance MAC CE command [TS 38.321] [REF6]. For example, the Timing Advance MAC CE indicates a T_{A} values in the range of 0, 1, . . . , 63 (e.g., a 6-bit value). The updated (new) N_{TA} value relative to the previous (old) N_{TA} value is given by:

$${N}_{TA , new} = {N}_{TA , old} + \frac{( {T}_{A} - 31 ) \cdot 16 \cdot 64}{{2}^{μ}}$$

wherein, μ is the sub-carrier spacing configuration.

For example, T_{A-A} for UL transmissions (e.g. SRS for positioning) to TRPA can be signalled, N_{TA,new-A} can be determined based on the last equation using N_{TA,old-A}, and the time advance at the UE 116 to TRPA is determined as: T_{TA-A}=N_{TA,offset-A}·T_{c}+N_{TA,new-A}·T_{c}. Similar equations hold for TRPB.

In one example, the MAC CE with the timing advance command (absolute timing advance or relative timing advance) includes an index to indicate the PCI or the TRP to which the TA command applies.

In one example, the MAC CE can include multiple TA commands (absolute timing advance or relative timing advance) and corresponding multiple indices to includes the PCIs or the TRPs to which the TA commands respectively apply to.

In various embodiments, the UE 116 sends a SRS for positioning towards a PCI or TRP in the SRS positioning validity area without first triggering a RACH procedure towards that TRP. For example, the UE 116 can use a TA of the PCI or TRP on which the UE 116 has camped, or a TA of any other PCI or TRP, or the UE 116 may initially assume a TA value of 0 (e.g., N_{TA}=0 or T_{A}=0) or the UE 116 may assume any other TA value, when the UE 116 is sending the SRS for positioning. After sending the SRS for positioning towards a PCI or a TRP, the PCI or TRP can determine the TA value that UE should use (to have timing alignment at the PCI's or TRP's reference time as mentioned herein). The UE 116 can then be sent the TA command (absolute timing advance or relative timing advance), for example, from the PCI or TRP that determined the TA or for the PCI or TRP that the UE 116 camping on as mentioned herein, and a PCI or TRP determined and/or configured by the network 130.

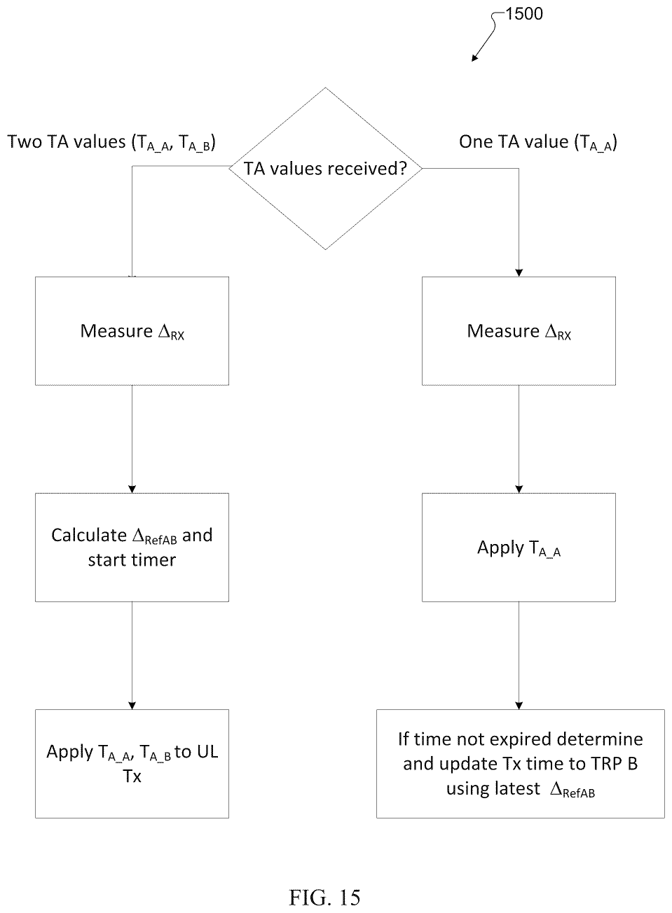

FIG. 15 illustrates a flow diagram 1500 for a UE receiving a TA value(s) for positioning according to embodiments of the present disclosure. For example, procedure 1500 for applying a determination of SRS can be performed by the UE 116 of FIG. 3. This example is for illustration only and other embodiments can be used without departing from the scope of the present disclosure.

With reference to FIG. 15:
When a UE is signaled TA command, T_{A-A} and T_{A-B} for TRP A and for TRP B respectively at the same time or at around the same time,
   In one example T_{A-A} and T_{A-B} are signaled at time tₐ and t_{b}, where T=abs(tₐ-t_{b}), abs is the absolute value. In one example, if T is less than a threshold or less than or equal to a threshold, the following procedure can apply, i.e., T_{A-A} and T_{A-B} are signaled at around the same time. T can be configured or updated by RRC signaling and/or MAC CE signaling and/or L1 control signaling.
   The UE 116 determines T_{TA-A} and T_{TA-B} for TRP A and a TA for TRP B respectively.
   The LIE 116 measures Δ_{RX}, which is the difference in receive time from TRPA and TRPB.
   The UE 116 can update the difference in reference time between TRPA and TRPB ΔREF_{AB} as mentioned herein. In one example, the UE 116 starts a timer for ΔREF_{AB}.
   The UE 116 updates the SRS for positioning transmission times to TRP A and TRP B based on the signaled TA commands.
When a UE is only signaled a TA command for a TRP (e.g., T_{AA}):
   The UE 116 determines T_{TA-A} corresponding to T_{A-A}.
   The UE 116 measures Δ_{RX}, which is the difference in receive time from TRPA and TRPB.
   The UE 116 updates the uplink transmission time to the first TRP (e.g., TRP A) based on the signaled TA command as mentioned herein.
   The UE 116 determines and updates T_{TA-B} for the second TRP (e.g., if the timer for ΔREF_{AB} has not expired) as mentioned herein using T_{TA-B}=T_{TA-A}+ΔN_{TA,offset}·T_{c}+2*Δ_{RX}+2*ΔREF_{AB}.
      The UE 116 can use T_{TA-B} to determine the transmission time of the SRS for positioning to TRPB relative a receive time at the UE 116 determined based on TRPA (i.e., T₂), e.g., T₂+Δ_{RX}−T_{TA-B}.
      The UE 116 can use T_{TA-B} to determine the transmission time of the SRS for positioning to TRPB relative a receive time at the UE 116 determined based on TRPB (i.e., T′₂), e.g., T′₂−T_{TA-B}.
      The UE 116 can use T_{TA-B} to determine the transmission time of the SRS for positioning to TRPB relative a transmit time at the UE 116 determined based on TRPA (i.e., T₃), e.g., T₃+T_{TA-B}+Δ_{RX}−T_{TA-B}.
      In a variant example, the UE 116 doesn't calculate T_{TA-B}, but uses ΔREF_{AB}(e.g., if its timer has not expired) along with T_{TA-A} or T_{A-A}, to determine the transmission of SRS for positioning to TRPB (e.g., relative to T₂ or T′₂ or T₃).
      In a variant example, the UE 116 receives the T_{A-B} for TRPB and determines the transmission time towards TRPA.
In a variant example, the UE 116 isn't signaled a TA for the first TRP (e.g., TRP A), but it measures Δ_{RX} and determines that the uplink transmission time to the TRPB changes using the methods mentioned herein (e.g., if the timer for ΔREF_{AB} has not expired).

In the following discussion, we evaluate two PCIs or TRPs, e.g., a first PCI or first TRP (e.g., TRPA), and a second PCI or second TRP (e.g., TRPB). However, this can be extended to more than two TRPs, for example, there can be more than one second TRP or second PCI. The receive and transmit times are according to Table 6, wherein T₂ is a reference time at the UE 116 based on the receive time of TRPA, T′₂ is a reference time at the UE 116 based on the receive time of TRPB, and T₃ is a reference time at the UE 116 based on the transmit time to TRPA.

$${Δ}_{RX} = {Tprop}_{B} - {Tprop}_{A} - Δ {REF}_{AB} \\ Δ {N}_{TA , offset} = {N}_{TA , offset - B} - {N}_{TA , offset - A}$$

TABLE 6

| | For TRPA | For TRPB |
|---|---|---|
| Transmit time | T₁ | T₁ − ΔREF_{AB} |
| from TRP to UE | | |
| Receive time at | T₂ = T₁ + Tprop_{A} | T′₂ = T₁ − ΔREF_{AB} + Tprop_{B} = |
| UE from TRP | | T₂ − ΔREF_{AB} + Tprop_{B} − Tprop_{A} = |
| | | T₂ + Δ_{RX} |
| Transmit time at | T₃ = T₂ − T_{TA-A} | T₂ + Δ_{RX} − T_{TA-B} = |
| UE to TRP | | T′₂ − T_{TA-B} = |
| | | T₃ + T_{TA-A} + Δ_{RX} − T_{TA-B} |
| T_{TA} | T_{TA-A} = N_{TA, offset-A} · T_{c} + 2 | T_{TA-B} = N_{TA, offset-B} · T_{c} + 2 |
| | * Tprop_{A} | * Tprop_{B} |
| | | T_{TA-B} = T_{TA-A} + ΔN_{TA, offset} · T_{c} + 2 |
| | | * Δ_{RX} + 2 * ΔREF_{AB} |

In one example, the UE 116 determines or is provided a TA for the first TRY (TRPA) (i.e., T_{A-A} from which the UE determines T_{TA-A}), and the UE 116 camps on the first TRY. This establishes a receive time at UE as in the examples mentioned herein. This receive time can be common to all TRYs. The UE 116 sends the SRS for positioning towards the second TRY. Based on the information in Table 6, the UE 116 can determine transmission time of SRS for positioning to the second TRY (TRPB) relative to the receive time at the UE 116 of the first TRY, T′₂, as follows:

$${T}_{2} + {Δ}_{RX} - {T}_{TA - B}$$

In another example, the UE 116 determines or is provided a TA for the first TRY (TRPA) (i.e., T_{A-A} from which the UE determines T_{TA-A}). The UE 116 sends the SRS for positioning towards the second TRY (TRPB) based on the receive time of the second TRY (TRPB), i.e., T′₂. The UE 116 uses a different receive time for each TRY as in the examples mentioned herein. Based on the information in Table 6, the UE 116 can determine transmission time of SRS for positioning to the second TRP (TRPB) relative to the receive time at the UE 116 of the second TRP, T′₂, as follows:

T′₂−T_{TA-B}

In one example, the UE 116 determines or is provided a TA for the first TRP (TRPA) (i.e., T_{A-A} from which the UE determines T_{TA-A}). This establishes a transmit time at UE as in the examples mentioned herein to the first TRP, e.g., T₃=T₂−T_{TA-A}. The UE 116 sends the SRS for positioning towards the second TRP. Based on the information in Table 6, the UE 116 can determine transmission time of SRS for positioning to the second TRP (TRPB) relative to the transmit time at the UE 116 of the first TRP, T₃, as follows:

$${T}_{3} + {T}_{TA - A} + {Δ}_{RX} - {T}_{TA - B}$$

Based on the equations of the examples mentioned herein, to determine SRS for positioning transmit time to the second TRP (TRPB), the UE 116 would need to determine:
First Δ_{RX}, which is the difference between the reception time from the first TRP (TRPA) and the second TRP (TRPB). This can be measured at the UE 116. This includes two components: 1) Differential propagation delay, 2) difference between reference time of TRPA and TRPB.
Second T_{TA-B}.

To determine T_{TA-B}, the following options can be further evaluated:
T_{T-B} is signaled to the UE 116 from which the UE 116 determines T_{TA-B}, for example as described in component 2. The signaling can be based on:
   TA is signaled in the random access response or in the MsgB response.
   TA is signaled in a MAC CE command (absolute timing advance or relative timing advance). This can be for the PCI or TRP on which the UE 116 has camped or the PCI TRP to which the SRS for positioning or PRACH preamble is transmitted towards.
T_{TA-B} is determined by the UE 116. For example, this can be based on T_{TA-A} of the first TRP. The UE 116 can determine T_{TA-B} T_{TA-A}+ΔN_{TA,offset}·T_{c}+2*Δ_{RX}+2*ΔREF_{AB}, wherein:
   T_{T-A} is signaled to the UE 116 from which the UE 116 can determine T_{TA-A}.
   ΔN_{TA,offset}=N_{TA,offset-B}−N_{TA,offset-A}, wherein N_{TA,offset-A} and N_{TA,offset-B} can be configured to the UE 116. In one example N_{TA,offset-B}=N_{TA,offset-A}. In another example, N_{TA,offset-B}≠N_{TA,offset-A}.
   ΔREF_{AB} is the difference between the reference time of the first TRP and the second TRP. In one example, ΔREF_{AB} can be configured or updated to UE by RRC signaling and/or MAC CE signaling and/or L1 control signaling. In another example, the UE 116 can determine ΔREF_{AB} as explained herein. In one example, a timer can be started when ΔREF_{AB} is signaled or determined, ΔREF_{AB} is valid until the timer expires.

In one example, the UE 116 receives T_{A-A} and T_{A-B} at the same time or around the same time that the UE 116 determines T_{TA-A} and T_{TA-B}. The UE 116 measures Δ_{RX} at that time. T_{TA-A} and T_{TA-B} are related by:

$${T}_{TA - B} = {T}_{TA - A} + Δ {N}_{TA , offset} \cdot {T}_{c} + 2 * {Δ}_{RX} + 2 * Δ {REF}_{AB}$$

This would allow the UE 116 to determine ΔREF_{AB}. Subsequently, as the UE 116 moves around and Δ_{Rx} changes and/or the UE 116 receives a new update for T_{A-A}, the UE 116 can determine an updated value of T_{TA-B}, that can be used to determine the transmission time of positioning SRS transmission to the second TRP (TPP B).

When the UE 116 is signaled T_{A-A} and T_{A}_B and measures Δ_{RX} and determines ΔREF_{AB} based on the equation mentioned herein, a timer can be started for ΔREF_{AB}, wherein ΔREF_{AB} can be valid as long as the timer has not expired. If the timer has not expired, the UE 116 can determine T_{TA-B} based on a received T_{A-A} and a measured Δ_{RX}. If the timer expires, ΔREF_{AB} might not be valid to determine T_{TA-B}.

In one example, a device (e.g., UE) can be a device to assist the network 130 to determine the difference in reference time between a first TRPA and a second TRPB. In one example, this device can be referred to as a positioning reference unit (PRU).

In one example, the device has a known location.

In one example, the device reports its location to the network 130, i.e., the first TRP and/or the second TRP, and/or a TRP the UE 116 is camping on, and/or a TRP configured by the network 130, and/or a LMF.

In one example, the device measures the difference between a receive time of a first downlink signal from TRPA and a receive time of a second downlink signal from TRPB (e.g., Δ_{RX}). In one example, the first downlink signal and/or the second downlink signal can be a SS/PBCH block. In one example, the first downlink signal and/or the second downlink signal can be a CSI-RS. In one example, the first downlink signal and/or the second downlink signal can be a SS/PBCH block or a CSI-RS. In one example, the first downlink signal and/or the second downlink signal can be a DL PRS. In one example, the first downlink signal and/or the second downlink signal can be a DL channel and/or signal.

In one example, the device reports Δ_{RX} to the network 130, i.e., the first TRP and/or the second TRP, and/or a TRP the UE 116 is camping on, and/or a TRP configured by the network 130, and/or a LMF.

In one example, the network 130 determines based on the location of the device and the location of TRPA and TRPB the propagation delay between the device and each of TRPA and TRPB, i.e., Tprop_{A} and Tprop_{B}.

In one example, the network 130 determines based on the location of the device and the location of TRPA and TRPB and Δ_{RX}, the difference in reference timing between TRPA and TRPB, i.e., ΔREF_{AB}. For example, using Δ_{RX}=Tprop_{B}−Tprop_{A}−ΔREF_{AB}.

In one example, the network 130, i.e., the first TRP and/or the second TRP, and/or a TRP the UE 116 is camping on, and/or a TRP configured by the network 130, and/or a LMF, reports to the device the location of TRPA and/or TRPB.

In one example, the device determines based on the location of the device and the location of TRPA and TRPB the propagation delay between the device and each of TRPA and TRPB, i.e., Tprop_{A} and Tprop_{B}.

In one example, the device determines based on the location of the device and the location of TRPA and TRPB and Δ_{RX}, the difference in reference timing between TRPA and TRPB, i.e., ΔREF_{AB}. For example, using Δ_{RX}=Tprop_{B}−Tprop_{A}−ΔREF_{AB}.

In one example, the device reports ΔREF_{AB} to the network 130, i.e., the first TRP and/or the second TRP, and/or a TRP the UE 116 is camping on, and/or a TRP configured by the network 130, and/or a LMF.

In one example, a report from the device to network can include one or more of the following: (1) the location of the device, (2) Δ_{RX} and/or (3) ΔREF_{AB}. The report can have characteristics based on the following examples.

In one example, the report to the network 130 can be using RRC signaling and/or MAC CE signaling and/or L1 control signaling. In one example, the report is periodic, e.g., with a periodicity P in units of time, symbols, slots, subframes or frames, and with an offset O in units of time, symbols, slots, subframes or frames, wherein P and O can be configured or updated by RRC signaling and/or MAC CE signaling and/or L1 control signaling. In one example, the report is semi-persistent, e.g., with a periodicity P in units of time, symbols, slots, subframes or frames, and with an offset O in units of time, symbols, slots, subframes or frames, wherein, P and O can be configured or updated by RRC signaling and/or MAC CE signaling and/or L1 control signaling in the message activating semi-persistent reporting or in a separate message. In one example, the semi-persistent report can be activated and/or deactivated by RRC signaling and/or MAC CE signaling and/or L1 control signaling. In one example, the report is aperiodic, the report can be triggered by the network 130 by RRC signaling and/or MAC CE signaling and/or L1 control signaling with an offset O in units of time, symbols, slots, subframes or frames from the trigger. O can be configured or updated by RRC signaling and/or MAC CE signaling and/or L1 control signaling in the trigger message or in a separate message. In one example, the report is device initiated when a condition occurs. For example, the condition can be when:
The location of the device changes, or the location of the device changes by more than a threshold.
Δ_{RX} changes or Δ_{RX} changes by more than a threshold
ΔREF_{AB} change or ΔREF_{AB} changes by more than a threshold wherein the threshold can be configured or updated by RRC signaling and/or MAC CE signaling and/or L1 control signaling.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications and/or SL positioning. A UE can be configured one or more bandwidth parts (BWPs) of a system BW for transmissions or receptions of signals or channels.

In downlink, the UE 111A receives DL positioning reference signal (PRS), where a positioning frequency layer includes one or more DL PRS resources sets. Each DL PRS resource set includes one or more DL PRS resources.

The reference signal sequence is defined by:

$$r ( m ) = \frac{1}{\sqrt{2}} ( 1 - 2 c ( 2 m ) + j ( 1 - 2 c ( 2 m + 1 ) ) )$$

The pseudo-random sequence c(n) is a length-31 Gold sequence defined as

$$c ( n ) = ( {x}_{1} ( n + {N}_{c} ) + {x}_{2} ( n + {N}_{c} ) ) mod 2 \\ where , \\ {N}_{c} = 1600 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2.$$

The first m-sequence is initialized with x₁(0)=1, and x₁(n)=0, for n=1 . . . 30.

The second m-sequence is initialized with cᵢₙᵢₜ, where cᵢₙᵢₜ

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( ( {n}_{ID , seq}^{PRS} mod 1024 ) ) ) mod {2}^{31}$$

where, N_{symb}^{slot} is the number of symbols per slot, n_{s,f}^{μ} is the slot number, l is the symbol number within a slot and n_{ID,seq}^{PRS} is a higher layer provided parameter (dl-PRS-SequenceID-r16), with n_{ID,seq}^{PRS}∈{0,1, . . . , 4095}.

The DL PRS sequence is mapped to resource elements a_{k,l}^{(p,μ)} within a slot, where k is the sub-carrier frequency, l is the symbol number within the slot, p is the antenna port, which for DL PRS is p=5000 and μ is the sub-carrier spacing configuration, by

a_{k,l}^{(p,μ)}=β_{PRS}r(m)

where,
β_{PRS} is a scaling factor, m=0, 1, . . . .

k=mK_{comb}^{PRS}+((k_{offset}^{PRS}+k′) mod K_{comb}^{PRS}), K_{comb}^{PRS} is the comb size, which is given by higher layer parameter dl-PRS-CombSizeN, with K_{comb}^{PRS}∈{2,4,6,12}, k_{offset}^{PRS} is the sub-carrier offset, which is given by higher layer parameter dl-PRS-ReOffset, with k_{offset}^{PRS}ϵ{0,1, . . . , K_{comb}^{PRS}−1}. k′ is a sub-carrier offset that is a function of the symbol number within a slot as given by Table 1.

l=lₛₜₐᵣₜ^{PRS}, lₛₜₐᵣₜ^{PRS}+1, . . . , lₛₜₐᵣₜ^{PRS}+L_{PRS}−1, lₛₜₐᵣₜ^{PRS} is the first DL PRS symbol in a slot, which is given by higher layer parameter dl-RS-ResourceSymbolOffset, L_{PRS} is the number of DL PRS symbols in a slot, with L_{PRS}∈{2,4,6,12}.

TABLE 7

| | Symbol number within PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

The allowed combination of {L_{PRS},K_{comb}^{PRS}} is one of {{2,2}, {4,2}, {6,2}, {12,2}, {4,4}, {12,4}, {6,6}, {12,6}, {12,12}}.

FIG. 10 illustrates an example DL PRS resources within a slot, with K_{comb}^{PRS}=2, k_{offset}^{PRS}=0, L_{PRS}=6, and lₛₜₐᵣₜ^{PRS}=4.

In uplink, a UE can transmit positioning sounding reference signal (SRS). A positioning SRS is configured by higher layer IE SRS-PosResource.

The positioning SRS sequence is a low peak-to-average power ratio (PAPR) sequence of length N_{ZC}=M_{sc,b}^{SRS} given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC}$$

where M_{ZC}=mN_{sc}^{RB}/2^{δ}, δ=log(K_{TC}), with K_{TC} being the transmission comb number is provided in higher layer IE transmissionComb, K_{TC}∈{2,4,8}. l′ is the positioning SRS symbol within a positioning SRS resource of a slot, l′∈{0,1, . . . , N_{symb}^{SRS}−1}, N_{symb}^{SRS} is the number of SRS symbols in a slot. For positioning SRS, there is one antenna port, the cyclic shift α is given by

$$α = 2 π \frac{{n}_{SRS}^{cs}}{{n}_{SRS}^{cs , max}} ,$$

with n_{SRS}^{cs} being provided by higher layer in IE transmissionComb, n_{SRS}^{cs,max} depends on K_{TC} as illustrated in Table 8.

TABLE 8

| K_{TC} | n_{SRS}^{cs, max} |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and v∈{0,1}, if 60>N_{ZC}. The base sequence, r̅_{u,v}(n), is generated as follows:
4. For N_{ZC}∈{6,12,18,24}, r̅_{u,v}(n)=e^{jϕ(n)ϕ/4}, with 0≤n<M_{ZC}−1. ϕ(n) is given by Tables 5.2.2.2-1 to 5.2.2.2-4 of TS 38.211 [REF1].
5.

$$For {N}_{ZC} = 30 , {\overline{r}}_{u , v} ( n ) = {e}^{- j \frac{π ( u + 1 ) ( n + 1 ) ( n + 2 )}{31}} ,$$

with 0≤n<M_{ZC}−1.
6. For N_{ZC}≥30, r̅_{u,v}(n)=x_{q}(n mod N_{ZC}),

$${x}_{q} ( n ) = {e}^{- j \frac{π qm ( m + 1 )}{{N}_{ZC}}} . {N}_{ZC}$$

is the largest prime number less than

$${M}_{ZC} . q = ⌊ \overline{q} + 1 / 2 ⌋ + v \cdot {( - 1 )}^{⌊ 2 \overline{q} ⌋} . \overline{q} = {N}_{ZC} \frac{u + 1}{31} .$$

The sequence group u is given by: u=(ƒ_{gh}(n_{s,f}^{μ},l′)+n_{ID}^{SRS}), where n_{ID}^{SRS} is provided by higher layer parameter sequenceID, with n_{ID}^{SRS}∈{0, 1, . . . , 65535}. Higher layer parameter groupOrSequenceHopping determines the values of u and v:
ifgroupOrSequenceHopping equals ‘neither’, neither group, nor sequence hopping shall be used and ƒ_{gh}(n_{s,f}^{μ},l′)=0, and v=0.
if groupOrSequenceHopping equals ‘groupHopping’, group hopping but not sequence hopping is used and v=0, and ƒ_{gh}(n_{s,f}^{μ},l′)=(Σₘ₌₀⁷(8(n_{s,f}^{μ}N_{symb}^{slot}+l₀+l′)+m)·2^{m}) mod 30, N_{symb}^{slot} is the number of symbols in a slots, l₀ is the first positioning SRS symbols in the slot, and c(n) a length-31 Gold sequence defined asc(n)=(x₁(n+N_{c})+x₂(n+N_{c})) mod 2, with N_{c}=1600, x₁(n+31)=(x₁(n+3)+x₁(n)) mod 2, x₁(n+31)=(x₂(n+3)+x₂(n+2)+x₂(n+1)+x₂(n)) mod 2, the first m-sequence is initialized with x₁(0)=1, and x₂(n)=0, for n=1 . . . 30. The second m-sequence is initialized with cᵢₙᵢₜ, where cᵢₙᵢₜ=n_{ID}^{SRS}.
if groupOrSequenceHopping equals ‘sequenceHopping’, sequence hopping but not group hopping is used and ƒ_{gh}(n_{s,f}^{μ},l′)=0 and

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

N_{symb}^{slot} is the number of symbols in a slots, l₀ is the first positioning SRS symbols in the slot, and c(n) a length-31 Gold sequence as previously defined.

The positioning SRS sequence, r^{(P)}(n,l′), is mapped to resource elements a_{k,l}^{(p)} within a slot, where k is the sub-carrier frequency, l is the symbol number within the slot and p is the antenna port, where for positioning SRS there is one antenna port, by

$${a}_{k , l}^{( p )} = {β}_{SRS} {r}^{( p )} ( {k}^{′} , {l}^{′} ) \\ l = {l}^{′} + {l}_{0}$$

where,
β_{SRS} is a scaling factor, k′=0, 1, . . . , M_{sc,b}^{SRS}−1, M_{sc,b}^{SRS}=m_{SRS,b} N_{sc}^{RB}/K_{TC}, m_{SRS,b} is provided by Table 6.4.14.3-1 of TS 38.211 [REF1], and l′=0,1, . . . , N_{symb}^{SRS}−1.

l=l′+l₀, with l₀ the first positioning SRS symbols in the slot, where l₀∈{0,1, . . . , 13}.

k=K_{TC}k′+k^{(p)}. K_{TC} is the transmission comb number as previously described, k₀^{(p)}=k̅₀^{(p)}+Σ_{b=0}^{B}^{_{SRS}}K_{TC}M_{sc,b}^{SRS}n_{b}, k̅₀^{(p)}=n_{shift}N_{sc}^{RB}+(k_{TC}^{(p)}+k_{offset}^{l′}) mod K_{TC}, k_{TC}^{(p)}=k̅_{TC} for positioning SRS, k̅_{TC} is the transmission comb offset included within higher layer IE transmissionComb, with k̅_{TC}∈{0,1, . . . , K_{TC}−1}, k_{offset}^{l′} is a symbol dependent sub-carrier offset given by Table 3, n_{shift} is given by higher layer parameter freqDomainShift and it adjusts the frequency allocation with respect to a reference point. If N_{BWP}^{start}≤n_{shift} the reference point for k₀^{(p)} is sub-carrier 0 in common resource block 0. Otherwise, the reference point is the lowest subcarrier of the BWP. n_{b} is a frequency positioning index. For positioning SRS, B_{SRS}=0, bₕₒₚ=0, and frequency hopping is disable. n_{b} is given by:

$${n}_{b} = ⌊ \frac{4 {n}_{RRC}}{{m}_{SRS , b}} ⌋ mod {N}_{b}$$

n_{RRC} is given by higher layer parameterfreqDomainPosition, and m_{SRS,b} and N_{b} are determined by Table 6.4.14.3-1 of TS 38.211 [REF1] with b=B_{SRS} and the configured value of C_{SRS}.

TABLE 9

| | k_{offset}⁰, k_{offset}¹, . . . , k_{offset}^{N}^{_{symb}}^{SRS}−1 | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, |
| | | | | | 0, 2, 1, 3 |
| 8 | — | — | 0, 4, 2, 6 | 0, 4, 2, 6, 1, 5, 3, 7 | 0, 4, 2, 6, 1, 5, 3, 7, |
| | | | | | 0, 4, 2, 6 |

NR supports positioning on the Uu interface. In the DL, positioning reference signal (PRS) can be transmitted by a gNB to a UE to enable the UE 111A to perform positioning measurements. In the UL a UE can transmit positioning sounding reference signal (SRS) to enable a gNB to perform positioning measurements. UE measurements or metrics for positioning include; DL PRS reference signal received power (DL PRS RSRP), DL PRS reference signal received path power (DL PRS RSRPP), DL reference signal time difference (DL RSTD), UE Rx-Tx time difference, DL reference signal carrier phase (DL RSCP), DL reference signal carrier phase difference (DL RSCPD), NR enhanced cell ID (E-CID), DL SSB radio resource management (RRM) measurement, and NR E-CID DL CSI-RS RRM measurement. UE measurements for positioning on the SL interface include; sidelink PRS reference signal received power (SL PRS-RSRP), sidelink PRS reference signal received path power (SL PRS-RSRPP), sidelink relative time of arrival (SL-RTOA), sidelink angle of arrival (SL AoA), sidelink Rx-Tx time difference, and sidelink reference signal time difference (SL RSTD). NG-RAN measurements for positioning include; UL relative time of arrival (UL-RTOA), UL angle of arrival (UL AoA), gNB Rx-Tx time difference, UL SRS reference signal received power (UL SRS-RSRP), UL SRS reference signal received path power (UL SRS-RSRPP) and UL reference signal carrier phase (UL RSCP). NR introduced several radio access technology (RAT) dependent positioning methods: time difference of arrival based methods such DL time difference of arrival (DL-TDOA), UL time difference of arrival (UL TDOA) and SL time difference of arrival (SL TDOA), angle based methods such as UL angle of arrival (UL AoA), DL angle of departure (DL AoD) and SL angle of arrival (SL AoA), multi-round trip time (RTT) based methods for Uu interface and SL interface and E-CID based methods.

Positioning schemes can be UE-based, i.e., the UE 111A determines the location or UE-assisted (e.g., location management function (LMF) based), i.e., UE provides measurements for a network entity (e.g., LMF) to determine the location, or NG-RAN node assisted (i.e., NG-RAN node such as gNB provides measurement to LMF). LTE positioning protocol (LPP) [TS 37.355] first introduce for LTE and then extended to NR is used for communication between the UE 111A and LMF. NR positioning protocol annex (NRPPa) [TS 38.455] is used for communication between the gNB 102 and the LMF. FIG. 11 illustrates the overall positioning architecture along with positioning measurements and methods.

With reference to FIG. 12, the LMF includes a controller/processor, a memory, and a backhaul or network interface. However, LMFs come in a wide variety of configurations.

The controller/processor can include one or more processors or other processing devices that control the overall operation of the LMF. For example, the controller/processor can support functions related to positioning and location services. Any of a wide variety of other functions can be supported in the LMF by the controller/processor. In some embodiments, the controller/processor includes at least one microprocessor or microcontroller.

The controller/processor is also capable of executing programs and other processes resident in the memory, such as a basic OS. In some embodiments, the controller/processor supports communications between entities, such as gNB and UE and supports protocols such as LPP and NRPPA. The controller/processor can move data into or out of the memory as required by an executing process.

The controller/processor is also coupled to the backhaul or network interface. The backhaul or network interface allows the LMF to communicate with other devices or systems over a backhaul connection or over a network. The interface can support communications over any suitable wired or wireless connection(s). For example, when the LMF is implemented as part of a cellular communication system or wired or wireless local area network (such as one supporting 5G, LTE, or LTE-A), the interface can allow the LMF to communicate with gNBs or eNBs or other network elements over a wired or wireless backhaul connection. The interface includes any suitable structure supporting communications over a wired or wireless connection, such as an Ethernet or RF transceiver.

The memory is coupled to the controller/processor. Part of the memory can include a RAM, and another part of the memory can include a Flash memory or other ROM. In certain embodiments, a plurality of instructions, such as a BIS algorithm is stored in memory. The plurality of instructions is configured to cause the controller/processor to perform the BIS process and to perform positioning or location services algorithms.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL Broadcast channel (PSBCH) conveying system information to assist in SL synchronization. SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE 111A transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE 111A:
HARQ-ACK reporting option (1): A UE can attempt to decode a transport block (TB) in a PSSCH reception if, for example, the UE 111A detects a SCI format scheduling the TB reception through a corresponding PSSCH. If the UE 111A fails to correctly decode the TB, the UE 111A multiplexes a negative acknowledgement (NACK) in a PSFCH transmission. In this option, the UE 111A does not transmit a PSFCH with a positive acknowledgment (ACK) when the UE 111A correctly decodes the TB.
HARQ-ACK reporting option (2): A UE can attempt to decode a TB if, for example, the UE 111A detects a SCI format that schedules a corresponding PSSCH. If the UE 111A correctly decodes the TB, the UE 111A multiplexes an ACK in a PSFCH transmission; otherwise, if the UE 111A does not correctly decode the TB, the UE 111A multiplexes a NACK in a PSFCH transmission.

In HARQ-ACK reporting option (1), when a UE that transmitted the PSSCH detects a NACK in a PSFCH reception, the UE 111A can transmit another PSSCH with the TB (retransmission of the TB). In HARQ-ACK reporting option (2) when a UE that transmitted the PSSCH does not detect an ACK in a PSFCH reception, such as when the UE 111A detects a NACK or does not detect a PSFCH reception, the UE 111A can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′}_{_{MAX}}^{SL}−1} and can be configured, for example, at least using a bitmap. Where, T′_{MAX} is the number of SL slots in a resource pool, e.g., in 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m·n_{subCHsize}+j, where j=0, 1, . . . , n_{subCHsize}, n_{subCHstart} and n_{subCHsize} are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE 111A such that, 0≤T₁≤T_{proc,1}^{SL}, where T_{proc,1}^{SL} is a PSSCH processing time, for example, as defined in REF 4. T₂ is determined by the UE 111A such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is a configured by higher layers and depends on the priority of the SL transmission.

The slots of a SL resource pool are determined as follows:
1. Let set of slots that may belong to a resource be denoted by {t₀^{SL}, t₁^{SL}, t₂^{SL}, . . . , t_{T}_{_{MAX-1}}^{SL}}, where 0≤tᵢ^{SL}<10240×2^{μ}, and 0≤i<Tₘₐₓ. μ is the sub-carrier spacing configuration. μ=0 for a 15 kHz sub-carrier spacing. μ=1 for a 30 kHz sub-carrier spacing. μ=2 for a 60 kHz sub-carrier spacing. μ=3 for a 120 kHz sub-carrier spacing. The slot index is relative to slot #0 of SFN #0 (system frame number 0) of the serving cell, or DFN #0 (direct frame number 0). The set of slots includes all slots except:
   a. N_{S-SSB} slots that are configured for SL SS/PBCH Block (S-SSB).
   b. N_{nonSL} slots where at least one SL symbol is not not-semi-statically configured as UL symbol by higher layer parameter tdd-UL-DL-ConfigurationCommon or sl-TDD-Configuration. In a SL slot, OFDM symbols Y-th, (Y+1)-th, . . . , (Y+X−1)-th are SL symbols, where Y is determined by the higher layer parameter sl-StartSymbol and X is determined by higher layer parameter sl-LengthSymbols.
   c. N_{reserved} reserved slots. Reserved slots are determined such that the slots in the set {t₀^{SL}, t₁^{SL}, t₂^{SL}, . . . , t_{T}_{_{MAX}}₋₁^{SL}} is a multiple of the bitmap length (L_{bitmap}), where the bitmap (b₀, b₁, . . . , b_{L}_{_{bitmap}}₋₁) is configured by higher layers. The reserved slots are determined as follows:
      i. Let {l₀, l₁, . . . , l₂_{^{μ}}_{×10240-N}_{_{S-SSB}}_{-N}_{_{nonSL}}₋₁} be the set of slots in range 0 . . . 2^{μ}×10240-1, excluding S-SSB slots and non-SL slots. The slots are arranged in ascending order of the slot index.
      ii. The number of reserved slots is given by: N_{reserved}=(2^{μ}× 10240−N_{S-SSB}−N_{nonSL}) mod L_{bitmap}.
      iii. The reserved slots lᵣ are given by:

$$r = ⌊ \frac{m \cdot ( {2}^{μ} \times 10240 - {N}_{S - SSB} - {N}_{nonSL} )}{{N}_{reserved}} ⌋ ,$$

where, m=0, 1, . . . , N_{reserved}−1
Tₘₐₓ is given by: Tₘₐₓ=2^{μ}×10240−N_{S-SSB}−N_{nonSL}−N_{reserved}.
2. The slots are arranged in ascending order of slot index.
3. The set of slots belonging to the SL resource pool, {t′₀^{SL}, t′₁^{SL}, t′₂^{SL}, . . . , t′_{T′}_{_{MAX}}₋₁^{SL}}, are determined as follows:
   a. Each resource pool has a corresponding bitmap (b₀, b₁, . . . , b_{L}_{_{bitmap}}₋₁) of length L_{bitmap}.
   b. A slot tₖ^{SL} belongs to the SL resource pool if

$${b}_{k mod {L}_{bitmap}} = 1$$

c. The remaining slots are indexed successively staring from 0, 1, . . . T′_{MAX}−1. Where, T′_{MAX} is the number of remaining slots in the set.

Slots can be numbered (indexed) as physical slots or logical slots, wherein physical slots include all slots numbered sequential, while logical slots include only slots that are allocated to sidelink resource pool as described herein numbered sequentially. The conversion from a physical duration, Pᵣₛᵥₚ, in milli-second to logical slots, Pᵣₛᵥₚ′, is given by

$${P}_{rsvp}^{′} = ⌈ \frac{T {′}_{max}}{10240 ms} \times {P}_{rsvp} ⌉$$

(see section 8.1.7 of 38.214 [4]).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE 111A such that 0≤T₁≤T_{proc,1}^{SL}, where T_{proc,1}^{SL} is a PSSCH processing time for example as defined in REF 4. T₂ is determined by the UE 111A such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure:
The first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE 111A measures a SL RSRP that exceeds a threshold. The threshold depends on the priority indicated in a SCI format and on the priority of the SL transmission. Therefore, sensing within a sensing window involves decoding the first stage SCI and measuring the corresponding SL RSRP, wherein the SL RSRP can be based on PSCCH demodulation reference signal (DMRS) or PSSCH DMRS. Sensing is performed over slots where the UE 111A doesn't transmit SL. The resources excluded are based on reserved transmissions or semi-persistent transmissions that can collide with the excluded resources or any of reserved or semi-persistent transmissions. The identified candidate resources after resource exclusion are provided to higher layers.
The second step (e.g., performed in the higher layers) is to select or re-select a resource from the identified candidate resources for PSSCH/PSCCH transmission.

During the first step of the resource (re-)selection procedure, a UE can monitor slots in a sensing window [n−T₀,n−T_{proc,0}), where the UE 111A monitors slots belonging to a corresponding sidelink resource pool that are not used for the UE 111A's own transmission. To determine a candidate single-slot resource set to report to higher layers, a UE excludes (e.g., resource exclusion) from the set of available single-slot resources for SL transmission, within a resource pool and within a resource selection window, the following:
1. Single slot resource R_{x,y}, such that for any slot t′ₘ^{SL} not monitored within the sensing window with a hypothetical received SCI Format 1-0, with a “Resource reservation period” set to any periodicity value allowed by a higher layer parameter reservationPeriodAllowed and indicating all sub-channels of the resource pool in this slot, satisfies condition 2.2. herein.
2. Single slot resource R_{x,y}, such that for any received SCI within the sensing window:
   1. The associated L1-RSRP measurement is above a (pre-)configured SL-RSRP threshold, where the SL-RSRP threshold depends on the priority indicated in the received SCI and that of the SL transmission for which resources are being selected.
   2. (Condition 2.2) The received SCI in slot t′ₘ^{SL}, or if “Resource reservation field” is present in the received SCI the same SCI is assumed to be received in slot

$${t}_{m + q \times {P}_{rsvp \_ Rx}^{′}}^{{′}^{SL}} ,$$

indicates a set of resource blocks that overlaps

$${R}_{x , y + j \times {P}_{rsvp \_ Tx}^{′}} .$$

where,
   q=1, 2, . . . , Q, where,
   If P_{rsvp_RX}≤T_{scal} and

$${n}^{′} - m < {P}_{rsvp \_ Rx}^{′} \to Q = ⌈ \frac{{T}_{scal}}{{P}_{rsvp \_ Rx}} ⌉ . {T}_{scal}$$

is T₂ in units of milli-seconds.
Else Q=1
If n belongs to (t′₀^{SL}, t′₁^{SL}, . . . , t′_{T′}_{ₘₐₓ₋₁}^{SL}), n′=n, else n′ is the first slot after slot n belonging to set (t′₀^{SL}, t′₁^{SL}, . . . , t′_{T′}_{ₘₐₓ₋₁}^{SL}).
j=0, 1, . . . , Cᵣₑₛₑₗ−1
P_{rsvp_RX} is the indicated resource reservation period in the received SCI in physical slots, and P_{rsvp_Rx}′ is that value converted to logical slots.
P_{rsvp_Tx}′ is the resource reservation period of the SL transmissions for which resources are being reserved in logical slots.
3. If the candidate resources are less than a (pre-)configured percentage, such as 20% of the total available resources within the resource selection window, the (pre-)configured SL-RSRP thresholds are increased by a predetermined amount, such as 3 dB and the above steps are repeated.

NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE 111A performs a re-evaluation check at least in slot m−T₃. The re-evaluation check includes:
Performing the first step of the SL resource selection procedure [38.214 section 8.1.4], which involves identifying a candidate (e.g., available) sidelink resource set in a resource selection window as previously described.
If the pre-selected resource is available in the candidate sidelink resource set, the resource is used/signaled for sidelink transmission.
Else, the pre-selected resource is not available in the candidate sidelink resource set, a new sidelink resource is re-selected from the candidate sidelink resource set.

Pre-emption check occurs when a UE checks the availability of pre-selected SL resources that have been previously signaled and reserved in an SCI Format and, if needed, re-selects new SL resources. For a pre-selected and reserved resource to be signaled in slot m, the UE 111A performs a pre-emption check at least in slot m−T₃. When pre-emption check is enabled by higher layers, pre-emption check includes:
Performing the first step of the SL resource selection procedure [38.214 section 8.1.4], which involves identifying candidate (e.g., available) sidelink resource set in a resource selection window as previously described.
If the pre-selected and reserved resource is available in the candidate sidelink resource set, the resource is used/signaled for sidelink transmission.
Else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.
   If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority.
   Else, the resource is used/signaled for sidelink transmission.

The positioning solutions proposed for release 16 target the following commercial requirements for commercial applications:

TABLE 10

| Requirement characteristic | Requirement target |
|---|---|
| Horizontal Positioning | Indoor: 3 m for 80% of the UEs |
| Error | Outdoor: 10 m for 80% of the UEs |
| Vertical Positioning Error | Indoor: 3 m for 80% of the UEs |
| | Outdoor: 3 m for 80% of the UEs |
| End to end latency | Less than 1 second |

To meet these requirements, radio access technology (RAT)-dependent, RAT independent, and a combination of RAT-dependent and RAT independent positioning schemes have been evaluated. For the RAT-dependent positioning schemes, timing based positioning schemes as well as angle-based positioning schemes have been evaluated. For timing based positioning schemes, NR supports DL Time Difference of Arrival (DL-TDOA), using positioning reference signals (PRS) for time of arrival measurements. NR also supports UL Time Difference of Arrival (UL-TDOA), using sounding reference signals (SRS) for time of arrival measurements. In Rel-18, NR introduced SL positioning, and supports SL time difference of arrival (SL-TDOA) using SL PRS.

NR also supports round-trip time (RTT) with one or more neighboring gNBs or transmission/reception points (TRPs), as well as RTT between UEs. For angle based positioning schemes, NR exploits the beam-based air interface, supporting downlink angle of departure (DL-AoD), uplink angle of arrival (UL-AoA), as well as sidelink angle of arrival (SL-AoA). Furthermore, NR supports enhanced cell-ID (E-CID) based positioning schemes. RAT independent positioning schemes can be based on global navigation satellite systems (GNSS), WLAN (e.g., WiFi), Bluetooth, Terrestrial Beacon System (TBS), as well as sensors within the UE 116 such as accelerometers, gyroscopes, magnetometers, etc. Some of the UE 111A sensors are also known as Inertial Measurement Unit (IMU).

As NR expands into new verticals, there is a need to provide improved and enhanced location capabilities to meet various regulatory and commercial positioning requirements. 3GPP SA1 evaluates the service requirements for high accuracy positioning in TS 22.261 [7] and identified seven service levels for positioning, with varying levels of accuracy (horizontal accuracy and vertical accuracy), positioning availability, latency requirement, as well as positioning type (absolute or relative).

One of the positioning service levels is relative positioning (see table 7.3.2.2-1 of TS 22.261 [7]), with a horizontal and vertical accuracy of 0.2 m, availability of 99%, latency of 1 sec, and targeting indoor and outdoor environments with speed up to 30 km/hr and distance between UEs or a UE and a 5G positioning node of 10 m.

Rel-17 further enhanced the accuracy, latency, reliability, and efficiency of positioning schemes for commercial and HoT applications. Targeting to achieve sub-meter accuracy with a target latency less than 100 ms for commercial applications, and accuracy better than 20 cm with a target latency in the order of 10 ms for IIoT applications.

In Rel-17, RAN undertook a study item for in-coverage, partial coverage, and out-of-coverage NR positioning use cases [RP-201518]. The study focused on identifying positioning use cases and requirements for Vehicle to anything (V2X) and public safety as well as identifying potential deployment and operation scenarios. The outcome of the study item is included in TR 38.845. V2X positioning requirements depend on the service the UE operates and are applicable to absolute and relative positioning. Use cases include indoor, outdoor and tunnel areas, within network coverage or out of network coverage, as well as with GNSS-based positioning available, or not available, or not accurate enough; and with UE speeds up to 250 km/h. There are three sets of requirements for V2X use cases: the first with horizontal accuracy in the 10 to 50 m range, the second with horizontal accuracy in the 1 to 3 m range, and the third with horizontal accuracy in the 0.1 to 0.5 m range. The 5G system can also support determining the velocity of a UE with a speed accuracy better that 0.5 m/s and a 3-Dimension direction accuracy better than 5 degrees. Public safety positioning is to support indoor and outdoor use cases, with in network coverage or out of network coverage; as well as with GNSS-based positioning available, or not available, or not accurate enough. Public safety positioning use cases target a 1-meter horizontal accuracy and a vertical accuracy of 2 m (absolute) or 0.3 m (relative).

In terms of deployment and operation scenarios for in-coverage, partial-coverage and out-of-coverage NR positioning use case, TR 38.845 has identified the following:
For network coverage: In-network coverage, partial network coverage as well as out-of-network coverage. In addition to scenarios with no GNSS and no network coverage.
Radio link: Uu interface (UL/DL interface) based solutions, PC5 interface (SL interface) based solutions and their combinations (hybrid solutions), as well as RAT-independent solutions such as GNSS and sensors.
Positioning calculation entity: Network-based positioning when the positioning estimation is performed by the network 130 and UE-based positioning when the positioning estimation is performed by the UE 111A.
UE Type: For V2X UEs, this can be a UE installed in a vehicle, a roadside unit (RSU), or a vulnerable road user (VRU). Some UEs can have distributed antennas, e.g., multiple antenna patterns that can be leveraged for positioning. UEs can have different power supply limitations, for example VRUs or handheld UEs have limited energy supply compared to other UEs.
Spectrum: This can include licensed spectrum and unlicensed spectrum for the Uu interface and the PC5 interface, as well as intelligent transportation system (ITS)-dedicated spectrum for the PC5 interface.

In this disclosure, we look at aspects related to multiple SL transmissions and receptions. For example, when the UE 116 is equipped with multiple antennas or multiple antenna panels, a UE can transmit SL PRS on the multiple antennas or multiple antenna panels to have orthogonality or pseudo-orthogonality between the antennas or the antenna panels we evaluate multiplexing in the time domain or frequency domain or code domain. For example, when UE 111A is equipped with multiple antennas or multiple antenna panels, a UE can receive SL PRS on the multiple antennas or multiple antenna panels. A UE can provide a measurement report for each antenna or each antenna panel. The reporting for multiple antennas or multiple antenna panels can be combined in one reporting instance for all antennas or for all antenna panels, or can be in separate reporting instances (e.g., a reporting instance can include positioning measurements for one antenna or antenna panel, a positioning measurements for a subset of antennas or antenna panels.

SL is one of the promising features of NR, targeting verticals such the automotive industry, public safety, industrial internet of things (IIoT) and other commercial application. 3GPP Rel-16 is the first NR release to include sidelink through work item “5G V2X with NR sidelink” with emphasis on V2X and public safety where the requirements are met. In Rel-17, the support of SL has been expanded to other types of UEs such a vulnerable road users (VRUs), pedestrian UEs (PUEs) and other types of handheld devices, by supporting mechanisms for power saving for SL resource allocation as well as mechanisms that enhance reliability and reduce latency of SL transmissions. Another feature that NR supports is positioning, using the NR radio interface for performing positioning measurements to determine or assist in determining the location of a UE. NR positioning was first introduced using the Uu interface in Rel-16, through work item “NR Positioning Support”. Rel-17 further enhanced accuracy and reduced the latency of NR-based positioning through work item “NR Positioning Enhancements” [RP-210903]. In Rel-17, a study was conducted in the RAN on “scenarios and requirements of in-coverage, partial coverage, and out-of-coverage positioning use cases” with accuracy requirements in the 10's of cm range, using the PC5 interface as well as the Uu interface for absolute and relative positioning. In Rel-18 a new Study Item [RP-213588] followed by a Work Item [RP-223549] have been approved to study and evaluate performance and feasibility of potential solutions for SL positioning.

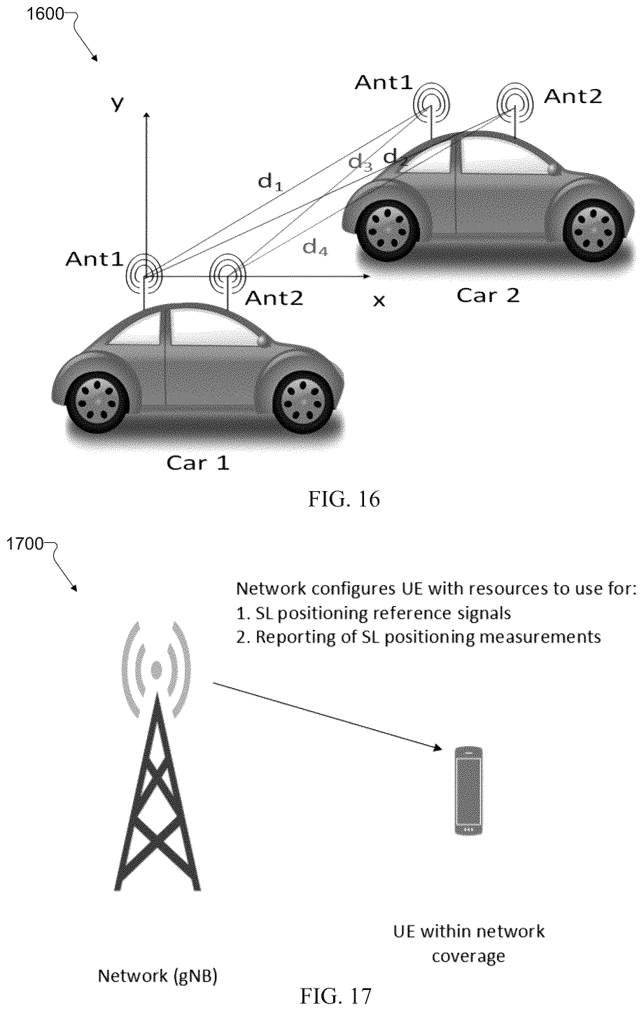

FIG. 16 illustrates a diagram 1600 for relative positioning according to embodiments of the present disclosure. For example, diagram 1600 for relative positioning can be utilized by the UEs 111, 111A, 111B, and 111C of FIG. 1. This example is for illustration only and other embodiments can be used without departing from the scope of the present disclosure.

In some scenarios, a UE can have multiple antennas or multiple antenna panels. For example, a UE can have two antennas that are separated by a distance D. In one example, the UE 111A can be a car or another device. In TR 37.885 two options are defined for vehicular UE's antenna. Option 2 includes two antenna panels, with one being placed at the front bumper/roof top and one being placed at the rear bumper/roof top. It is also possible that UE can have more than 2 antennas or more than 2 antenna panels. By leveraging these antennas or antenna panels, it possible determine the relative position of two vehicles as illustrated in FIG. 16. By performing positioning measurements between each pair of antennas in the two cars, car 1 can determine the relative position of car 2 or vice versa, using the examples mentioned herein.

Positioning measurements can include:
Round-trip measurements, for example by performing Rx-Tx time difference measurement at antennas/antenna panels of UE2 for antenna/antenna panels of UE1, and by performing Rx-Tx time difference measurement at antennas/antenna panels of UE1 for antenna/antenna panels of UE2.
Relative time of arrival at the antennas/antenna panels of target UE (e.g., UE2 or UE1) for the antennas/antenna panels of the source UE (e.g., UE1 or UE2). The relative time of arrival of a SL PRS from a source UE at the antennas/antenna panels of a target UE is relative to a time determined by the target UE.
Reference signal time difference at the antennas/antenna panels of target UE (e.g., UE2 or UE1) for the antennas/antenna panels of the source UE (e.g., UE1 or UE2). This can be for example, time difference between different pairs for source UE antennas/antenna panels and target UE antennas/antenna panels.

To enable pairwise positioning measurements between antennas or antenna panels of two UEs:
First, different SL PRS can be sent from the antennas or antenna panels of a first UE. The different SL PRS from the antennas or antenna panels of the first UE can be multiplexed in time domain or in frequency domain or in code domain. In this disclosure we look into the multiplexing of SL PRS from the antennas or antenna panels of a UE.
Second, SL positioning measurements are performed at the antennas or antenna panels of a second UE for the SL PRS signals transmitted from the antennas or antenna panels of the first UE. In this disclosure we look into the measurement reports from the antennas or antenna panels of a UE to enable pairwise (between antennas or antenna panels of two UEs) SL positioning measurements.

The present disclosure relates to a 5G/NR communication system.

This disclosure evaluates measurements and procedures for pairwise SL positioning measurements between antennas or antenna panels of a first UE and a second UE, including
Multiplexing of SL PRS signals transmitted from the antennas or antenna panels of the first UE.
SL positioning measurements and reporting at the antennas or antenna panels of the second UE.

In the present disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In the present disclosure, MAC CE signaling includes: (1) MAC CE signaling over the Uu interface, and/or (2) MAC CE signaling over the PC5 or SL interface.

In the present disclosure, L1 control signaling includes: (1) L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In the following examples, time can be expressed in one of following:
Logical slots within a resource pool.
   A logical slot index for a slot within a resource pool is denoted as t′ᵢ^{SL}.
   A time period expressed in logical slots within a resource pool is denoted as T′.
Logical slots that can be in a resource pool. These are the SL slots before the application of the resource pool bitmap, as described in section 8 of TS 38.214 [REF4].
   A logical slot index for a slot that can be in a resource pool is denoted as tᵢ^{SL}.
   A time period expressed in logical slots that can be in a resource pool is denoted as T′. While this is the same notation as used for logical slots within a resource pool, the value is different and should be apparent from the context which value to use.
Physical slots or physical time.
   A Physical slot number (or index) is denoted as n or n′. n is the physical slot number of any physical slot, while n′ is the physical slot number of a slot in the resource pool.
   A time period is expressed as physical time (e.g., in milliseconds (ms)) or in units of physical slots.

When used in the same equation, time units may be the same, i.e.,
If logical slots within a resource pool are used in an equation, inequality or expression, the time period in the same equation, inequality or expression should be expressed in units of logical slots within a resource pool.
If logical slots that can be in a resource pool are used in an equation, inequality or expression, the time period in the same equation, inequality or expression should be expressed in units of logical slots that can be in a resource pool.
If physical slots are used in an equation, inequality or expression, the time period in the same equation, inequality or expression should be expressed in units of physical slots or physical time scaled by the slot duration.

Time units can be converted from one unit to another.
For example, for each logical slot index for a slot within a resource pool there is a corresponding physical slot number. The converse is not true, i.e., not every physical slot corresponds to a logical slot within a resource pool. When converting from physical slot number to logical slot index:
   If the physical slot is in the resource pool, the corresponding logical slot index within the resource pool is determined.
   If the physical slot is not in the resource pool, the index of an adjacent logical slot within the resource pool is determined, wherein one of:
      The adjacent logical slot is the next logical slot after the physical slot.
      The adjacent logical slot is the pervious logical slot before the physical slot.
To convert from physical time (in ms) to time in units of logical slots within a resource pool, the following equation can be used, wherein T is in units of ms and T′ is in units of logical slots within a resource pool:

$${T}^{′} = ⌈ \frac{{T}_{max}^{′}}{10240 ms} \times T ⌉$$

wherein, T′ₘₐₓ is the number of logical slots within the resource pool in 1024 frames or 10240 ms.

The slot index or the time period provided by higher layers or specified in the specifications can be given in one unit, e.g., in physical slots or in ms, and is converted to a logical slot index or units of logical slots within a resource pool before being used in the corresponding equations, or vice versa.

In this disclosure, an antenna can also refer to an antenna port or an antenna panel or antenna reference position (ARP). In some examples the antennas are co-located in the same position. In some examples, antennas are not co-located, e.g., the antennas (or antenna panels or antenna ports) are at different physical locations. In some examples of this disclosure SL PRS is transmitted or received/measured on multiple antennas or multiple panels. Some of the examples can also be applicable when SL PRS are transmitted from multiple UEs. Some of the examples can also be applicable when SL PRS is received/measured by multiple UEs. Some of the examples can also be applicable when SL PRS transmitted by multiple UEs are received/measured by a UE.

In this disclosure, a SL positioning reference signal (SL PRS) refers generically to a physical reference signal transmitted on the SL interface to assist in determining a position of a SL UE or SL UE antenna or SL UE panel based on measurements performed on the SL positioning reference signal. In one example, a SL positioning reference signal can have a physical signal structure and/or resource allocation similar to the physical signal structure and/or resource allocation of a DL positioning reference signal (PRS) used in DL of the Uu interface in NR, except that it is transmitted/received on the SL interface (PC5 interface). In another example, a SL positioning reference signal can have a physical signal structure and/or resource allocation similar to the physical signal structure and/or resource allocation of a UL positioning sounding reference signal (SRS) used in UL of the Uu interface in NR, except that it is transmitted/received on the SL interface (PC5 interface). In another example, a SL positioning reference signal can have a physical signal structure and/or resource allocation combining aspects of the physical signal structure and/or resource allocation of (1) DL positioning reference signal (PRS) used in DL of the Uu interface in NR and (2) UL positioning sounding reference signal (SRS) used in UL of the Uu interface in NR, except that it is transmitted/received on the SL interface (PC5 interface). In another example, a SL positioning reference signal can have a new physical signal structure and/or resource allocation for use on the SL interface (PC5 interface).

As described in U.S. patent application Ser. No. 18/183,037, filed on Mar. 13, 2023, which is incorporated by reference in its entirety, a reference signal used for positioning (SL PRS) can be pre-configured and/or configured and/or allocated a network and/or by a SL UE.

As described in U.S. patent application Ser. No. 18/303,350, filed on Apr. 19, 2023, which is incorporated by reference in its entirety, a reference signal used for positioning (SL PRS) can be transmitted from multiple antennas or multiple panels of a first UE and received and measured for positioning purposes on multiple antennas or multiple panels of a second UE.

FIG. 17 illustrates a diagram 1700 of an example coverage network for a UE according to embodiments of the present disclosure. For example, diagram 1700 of an example coverage network for a UE can be utilized by any of the UEs 111-116 in network 100 of FIG. 1. This example is for illustration only and other embodiments can be used without departing from the scope of the present disclosure.

In one embodiment, the network 130 can configure SL resources for SL positioning reference signal and/or SL resources for reporting SL measurements. The network 130 can further configure SL UEs to transmit and/or receive SL positioning reference signals. The network 130 can further configure SL UEs to perform SL positioning measurements.

With reference to FIG. 17, a UE is in coverage of a network as shown. The network 130 can configure the UE 111A with resources to use for:
1. SL positioning reference signals on the SL interface (PC5 interface); and/or
2. Reporting of SL positioning measurements on the SL interface (PC5 interface).

In another embodiment, a SL UE is (pre-)configured SL resources for SL positioning reference signal and/or SL resources for reporting SL measurements. The UE 111A can be further configured (e.g., by higher layers (RRC or MAC CE) and/or lower lowers (L1 control)) to transmit and/or receive SL positioning reference signals. The UE 111A can be further configured to perform SL positioning measurements.

The UE 111A can be configured with resources to use for:
1. SL positioning reference signals on the SL interface (PC5 interface); and/or
2. Reporting of SL positioning measurements on the SL interface (PC5 interface).

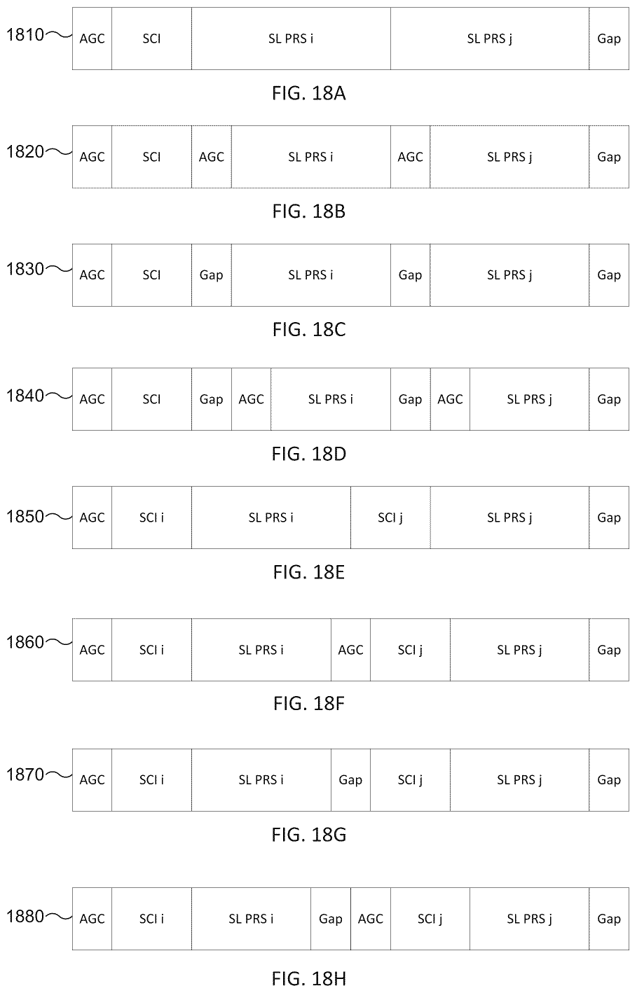

FIGS. 18A, 18B, 18C, 18D, 18E, 18F, 18G, and 18H illustrate diagrams 1810, 1820, 1830, 1840, 1850, 1860, 1870, and 1880, respectively, of example SL PRSs according to embodiments of the present disclosure. For example, diagrams 1810, 1820, 1830, 1840, 1850, 1860, 1870, and 1880, respectively, of example SL PRSs can be utilized by any of UEs 111, 111A, 111B, and 111C of FIG. 1. This example is for illustration only and other embodiments can be used without departing from the scope of the present disclosure.

In FIG. 18A, there is a common SL control information (SCI) for SL PRS at the start of the slot, e.g., for SL PRS i and SL PRS j. In one example SCI is transmitted from one antenna or antenna panel or UE (e.g., i or j or other than i and j). In one example SCI is transmitted from both antennas or antennas panels or UEs (e.g., i or j). In one example, the total power per symbol is the same for SCI, SL PRS i and SL PRS j. In one example, the power for SCI and/or SL PRS i and/or SL PRS j can be different. 1810 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18B is a variant example, with an AGC (e.g., duplicate) symbol(s) between SCI and the first SL PRS and between the first SL PRS and the second SL PRS. In a variant example, one of these AGC (e.g., duplicate) symbols is not there. In one example, the power for SCI and SL PRS i and SL PRS j is the same. In one example, the power for SCI and/or SL PRS i and/or SL PRS j can be different. 1820 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18C is a variant example, with gap symbol(s) between SCI and the first SL PRS and between the first SL PRS and the second SL PRS. In a variant example, one of these gap symbols is not there. In one example, the power for SCI and SL PRS i and SL PRS j is the same. In one example, the power for SCI and/or SL PRS i and/or SL PRS j can be different. 1830 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18D is a variant example, with AGC (e.g., duplicate) symbol(s) and gap symbol(s) between SCI and the first SL PRS and between the first SL PRS and the second SL PRS. In a variant example, one or more of these AGC (e.g., duplicate) symbol(s) and/or gap symbols is not there. In one example, the power for SCI and SL PRS i and SL PRS j is the same. In one example, the power for SCI and/or SL PRS i and/or SL PRS j can be different. 1840 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18E is a variant example, with SL control information (SCI) for each SL PRS, for example, SCI i for SL PRS i, and SCI j for SL PRS j. In one example, the power for SCI i+SL PRS i and SCI j+SL PRS j is the same. In one example, the power for SCI i+SL PRS i and SCI j+SL PRS j can be different. 1850 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18F is a variant example, with an AGC (e.g., duplicate) symbol(s) between the first SCI+SL PRS and the second SCI+SL PRS. In one example, the power for SCI i+SL PRS i and SCI j+SL PRS j is the same. In one example, the power for SCI i+SL PRS i and SCI j+SL PRS j can be different. 1860 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18G is a variant example, with a gap symbol(s) between the first SCI+SL PRS and the second SCI+SL PRS. In one example, the power for SCI i+SL PRS i and SCI j+SL PRS j is the same. In one example, the power for SCI i+SL PRS i and SCI j+SL PRS j can be different. 1870 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 18H is a variant example, with an AGC (e.g., duplicate) symbol(s) and a gap symbol(s) between the first SCI+SL PRS and the second SCI+SL PRS. In one example, the power for SCI i+SL PRS i and SCI j+SL PRS j is the same. In one example, the power for SCI i+SL PRS i and SCI j+SL PRS j can be different. 1880 shows AGC (e.g., duplicate) symbol(s) at the start of the slot and Gap symbol(s) at the end of the slot. In variant examples, there is no AGC (e.g., duplicate) symbol(s) and/or Gap symbol(s).

SL Positioning reference signals are reference signals transmitted on the SL interface by a first UE. In one example, SL PRS is transmitted on different resources corresponding to antennas or antenna panels of a UE. The SL positioning reference signals are received by one or more second UE(s) (e.g., the SL PRS can be unicast or groupcast or broadcast from a first UE to one or more second UEs), wherein the second UE(s) performs SL positioning measurements on the SL positioning reference signals. In one example SL PRS measurements are performed at the antennas or antenna panels of a UE, wherein the positioning measurements are performed pairwise between antennas or antenna panels of UE transmitting the SL PRS and the antennas or antenna panels of the UE 111A receiving the SL PRS. SL Positioning measurements are measurements that aid in finding the position of a SL UE, e.g., the absolute position of the first SL UE (or antenna or antenna panel of the first SL UE) and/or the absolute position of the second SL UE (or antenna or antenna panel of the second SL UE), and/or the relative of position of the first SL UE (or antenna or antenna panel of the first SL UE) to the second SL UE (or antenna or antenna panel of the second SL UE) and/or the relative position of the second SL UE (or antenna or antenna panel of the second SL UE) to the first SL UE (or antenna or antenna panel of the first SL UE). Absolute position is defined in a frame of reference, e.g., the Global frame of reference (e.g., using latitude and longitude and/or elevation). SL positioning measurements can include, in one example these measurements can be performed at the antennas or antenna panels of the second UE:
SL reference signal time difference (RSTD). For example, the time difference between a positioning reference signal received by a SL UE and a reference time. For example, the reference time can be that of a received SL PRS on another antenna panel of the second UE, or that of received SL PRS from other antenna panel of the first UE or SL SPR from a third UE.
SL reference signal relative time of arrival. For example, the time of the received SL PRS from the first UE relative to a reference time at the second UE.
SL reference signal received power (RSRP) of a SL positioning reference signal.
SL reference signal received power (RSRPP) of a SL positioning reference signal
SL reference signal carrier phase measurement of a SL positioning reference signal
SL reference signal carrier phase difference measurement, where the carrier phase difference is between a carrier phase measurement associated with first pair of antennas/antenna panels associated with first and second UEs, and a carrier phase measurement associate with a second pair of antennas/antenna panels associated with first (or third) and second UEs.
SL Angle of Arrival (AoA) of a SL positioning reference signal.
SL Rx-Tx time difference. For example, this can be the difference between the receive time of a first SL positioning reference signal and the transmit time of a second SL positioning reference signal.

A first UE is configured with a positioning reference signal on the SL interface (e.g., SL positioning reference signal referred to as SL PRS in this disclosure).

The configuration of the SL PRS can include:
Time domain resources, e.g., number of symbols and starting position within a slot of DL PRS.
Time domain behavior, whether transmission is aperiodic, semi-persistent or periodic transmission, including periodicity for semi-persistent and periodic transmissions.
Frequency domain resources, e.g., starting position in frequency domain (e.g., FD shift), and length in frequency domain (e.g., number of PRBs or C-SRS).
Transmission comb related information. Number of transmission combs and transmission comb offset.
Code domain information, e.g., sequence ID, and group or sequence hopping type (e.g., neither groupHopping nor sequenceHopping).

In some examples, as described in this disclosure, the parameters mentioned herein can be common across multiple antennas or antenna panels or can be antenna-specific or antenna port-specific or antenna panel-specific.

In one example, the SL PRS from the antennas or antenna panels of a UE are time division multiplexed, e.g., different time resources are used for different antennas or different antennas panels.

In one example, different slots are used for used different antennas or antenna ports. For example, if the number antennas or antenna panels is N with index i=0, 1, N−1, and if s is a slot number or index, slot s is used for antenna i or antenna panel i, if ƒ(s)=i, where ƒ( ) is a function. For example, ƒ( ) can be a modulo N, e.g., slot s is used for antenna i or antenna panel i, if (s % N)=i. In one example, N=2, i.e., even slots are used for one antenna or antenna panel and odd slots are used another antenna or antenna panel. In one example, SL PRS is transmitted with periodicity P. For example, SL PRS is transmitted in slots where (s % P)=O, where O is an offset, for example, O=0, or 1 or . . . or (P−1). In one example, the SL PRS in a first period is used for a first antenna or a first antenna panel, the SL PRS in a second period is used for a second antenna or a second antenna panel, and so on then the SL PRS transmission pattern repeats. For example, slot s is used for antenna i or antenna panel i, if (s % N*P)=K+i*P. In one example, slot s, is a physical slot. In one example, slot s is a logical slot that can be in a resource pool. In one example, slot s is a logical slot that is in a resource pool.

In one example, SL PRS for one antenna or one antenna panels is transmitted in a slot.

In one example, SL PRS for multiple antennas or one antenna panel are transmitted in a slot. There are multiple SL PRS occasions per slot. FIG. 18 shows an example of two SL PRS occasions in a slot, the first SL PRS corresponds to antenna i or antenna panel i. The second SL PRS corresponds to antenna j or antenna panel j. FIG. 18 shows various examples of multiplexing SL PRS in a slot for antenna i or antenna panel i and antenna j or antenna panel j. It can also be the case that SL PRS i and SL PRS j correspond to different users, e.g., UE i and UE j.

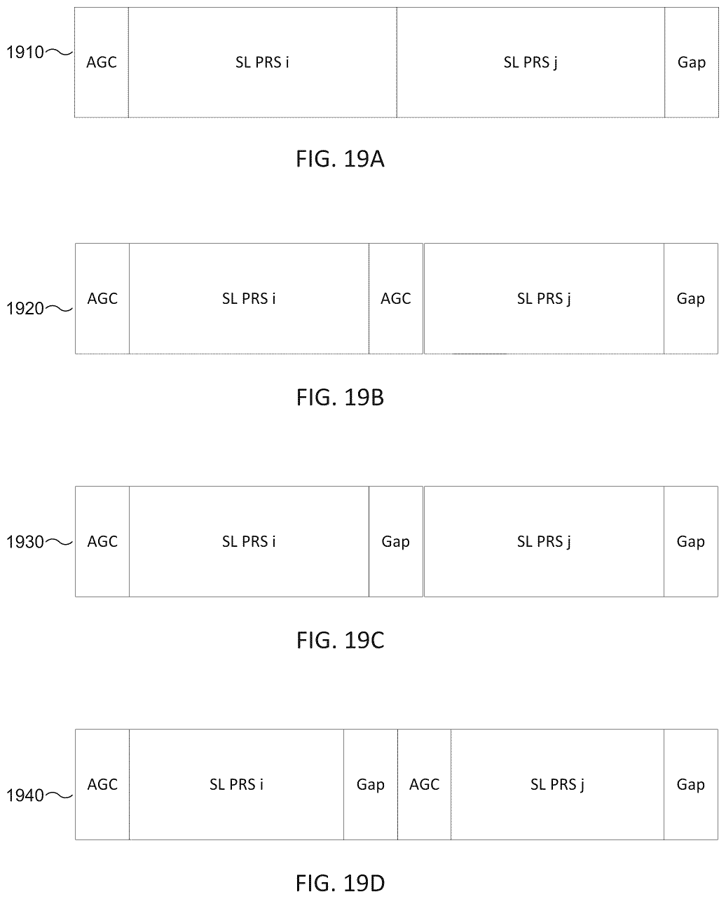

FIGS. 19A, 19B, 19C, and 19D illustrate diagrams 1910, 1920, 1930, and 1940, respectively, of example SL PRSs according to embodiments of the present disclosure. For example, diagrams 1910, 1920, 1930, and 1940, respectively, of example SL PRSs can be utilized by any of UEs 111, 111A, 111B, and 111C of FIG. 1. This example is for illustration only and other embodiments can be used without departing from the scope of the present disclosure.

In FIG. 19A, there is no AGC (e.g., duplicate) symbol(s) nor gap symbol(s) between SL PRS i and SL PRS j. In one example, the power for SL PRS i and SL PRS j is the same. In one example, the power for SL PRS i and SL PRS j can be different. 1910 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 19B is a variant example, there is an AGC (e.g., duplicate) symbol(s) between SL PRS i and SL PRS j. In one example, the power for SL PRS i and SL PRS j is the same. In one example, the power for SL PRS i and SL PRS j can be different. 1920 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 19C is a variant example, there is a gap between SL PRS i and SL PRS j. In one example, the power for SL PRS i and SL PRS j is the same. In one example, the power for SL PRS i and SL PRS j can be different. 1930 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 19D is a variant example, there is an AGC (e.g., duplicate symbols) and a gap symbol(s) between SL PRS i and SL PRS j. In one example, the power for SL PRS i and SL PRS j is the same. In one example, the power for SL PRS i and SL PRS j can be different. 1940 shows AGC (e.g., duplicate) symbol(s) at the start of the slot and Gap symbol(s) at the end of the slot. In variant examples, there is no AGC (e.g., duplicate) symbol(s) and/or Gap symbol(s).

FIG. 19 is a variant example, with no SL control information (SCI) associated with SL PRS transmitted in the same slot. In one example, the SCI can be transmitted in a different slot.

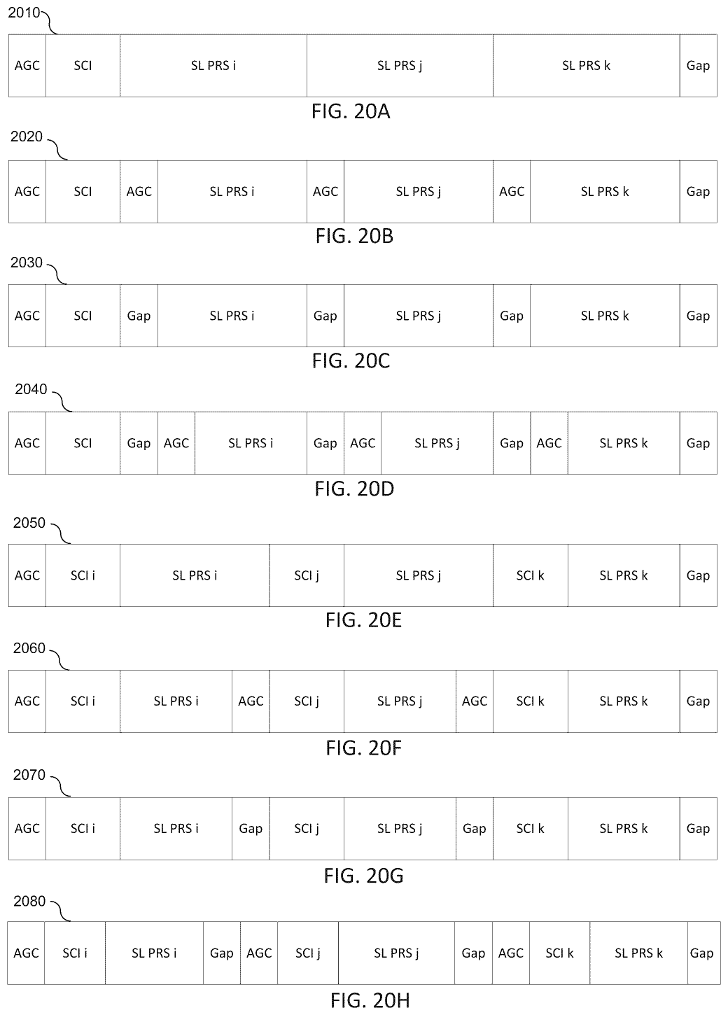

FIGS. 20A, 20B, 20C, 20D, 20E, 20F, 20G, and 20H illustrate diagrams 2010, 2020, 2030, 2040, 2050, 2060, 2070, and 2080, respectively, of example SL PRSs according to embodiments of the present disclosure. For example, diagrams 2010, 2020, 2030, 2040, 2050, 2060, 2070, and 2080, respectively, of example SL PRSs can be utilized by any of UEs 111, 111A, 111B, and 111C of FIG. 1. This example is for illustration only and other embodiments can be used without departing from the scope of the present disclosure.

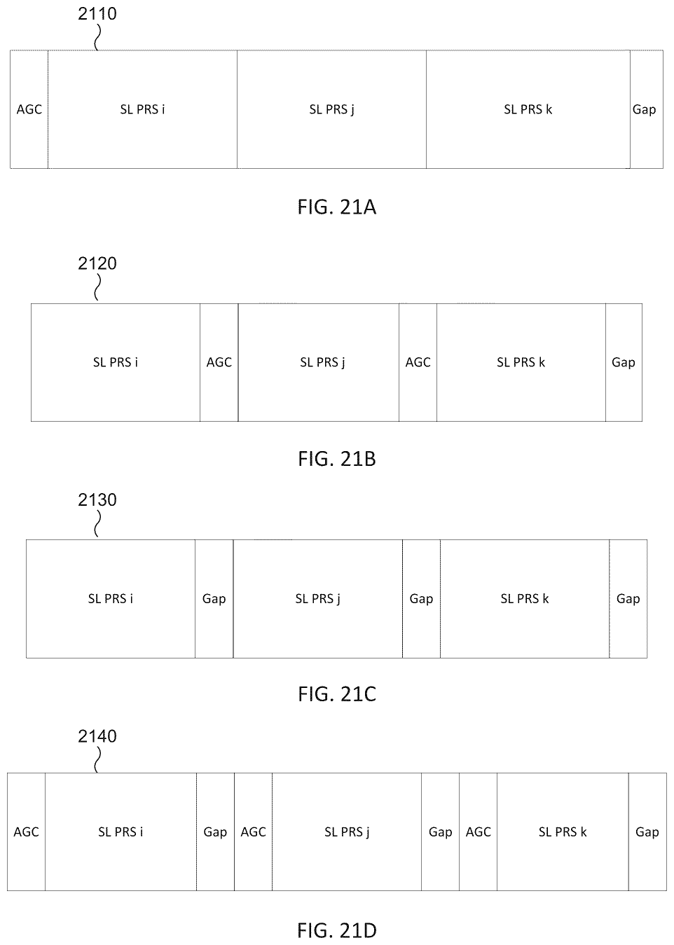

FIGS. 21A, 21B, 21C, and 21D illustrate diagrams 2110, 2120, 2130, and 2140, respectively, of example SL PRSs according to embodiments of the present disclosure. For example, diagrams 2110, 2120, 2130, and 2140, respectively, of example SL PRSs can be utilized by any of UEs 111, 111A, 111B, and 111C of FIG. 1. This example is for illustration only and other embodiments can be used without departing from the scope of the present disclosure.

FIGS. 18A, 18B, 18C, 18D, 18E, 18F, 18G, 19A, 19B, 19C, and 19D show an example with two SL PRS occasions per slot. It should be apparent that the number of SL PRS occasions per slot can be more than two, e.g., three, four, etc. As an example, FIGS. 20A, 20B, 20C, 20D, 20E, 20F, 20G, 20H, 21A, 21B, 21C, and 21D show three SL PRS occasions per slot, SL PRS i, SL PRS j and SL PRS k.

In one example, there are K SL PRS transmissions per slot and N antennas or antenna panels.

In one example, K=N, in a slot with SL PRS transmission, there is a SL PRS transmission for each antenna or antenna panel.

In one example, K<N, the SL PRS for different antennas or antenna panels cycle through the SL PRS occasions per slot and the SL slots used for transmission of SL PRS. For example, if K=2 and N=4. In a first slot, SL PRS for antennas or antenna panels 0 and 1 is transmitted. In a next slot for SL PRS, SL PRS for antennas or antenna panels 2 and 3 is transmitted. Then in the next slot for SL PRS, SL PRS for antennas or antenna panels 0 and 1 is transmitted and so on.

In one example, K>N, in a slot with SL PRS transmission, there is a SL PRS transmission for each antenna or antenna panel.

In one example, the SL PRS from the antennas or antenna panels of a UE are frequency division multiplexed, e.g., different frequency resources are used for different antennas or different antennas panels.

In one example, different comb offsets are used for different antennas or antenna panels. For example, a first comb offset index (e.g., 0) is used for a first antenna or a first antenna panel, and a second comb offset index (e.g., 1 or comb size divided by 2) is used for a second antenna or a second antenna panel, and so on.

In one example, different PRBs (or sub-channels) are used for different antennas or antenna panels. For example, a first set of PRBs (or sub-channels) is used for a first antenna or a first antenna panel, and a second set of PRBs (or sub-channels) is used for a second antenna or a second antenna panel, and so on.

In one example, different comb offsets and different PRBs (or sub-channels) are used for different antennas or antenna panels. For example, a first comb offset index (e.g., 0) in a first set of PRBs (or sub-channels) is used for a first antenna or a first antenna panel, and a second comb offset index (e.g., 1 or comb size divided by 2) in a first set of PRBs (or sub-channels) is used for a second antenna or a second antenna panel, a first comb offset index (e.g., 0) in a second set of PRBs (or sub-channels) is used for a third antenna or a third antenna panel, and a second comb offset index (e.g., 1 or comb size divided by 2) in a second set of PRBs (or sub-channels) is used for a fourth antenna or a fourth antenna panel, and so on. In another example, a first comb offset index (e.g., 0) in a first set of PRBs (or sub-channels) is used for a first antenna or a first antenna panel, and a first comb offset index (e.g., 0) in a second set of PRBs (or sub-channels) is used for a second antenna or a second antenna panel, a second comb offset index (e.g., 1 or comb size divided by 2) in a first set of (or sub-channels) PRBs is used for a third antenna or a third antenna panel, and a second comb offset index (e.g., 1 or comb size divided by 2) in a second set of PRBs (or sub-channels) is used for a fourth antenna or a fourth antenna panel, and so on.

In one example, the SL PRS from the antennas or antenna panels of a UE are time division multiplexed and frequency division multiplexed, e.g., different time and frequency resources are used for different antennas or different antennas panels.

In one example, different comb offsets and different time resources are used for different antennas or antenna panels. In one example the different time resources can be different SL PRS symbols within a slot (e.g., different SL PRS occasions within a slot) and/or different slots as mentioned herein. For example, a first comb offset index (e.g., 0) in a first slot or first SL PRS occasion in a slot is used for a first antenna or a first antenna panel, and a second comb offset index (e.g., 1 or comb size divided by 2) in a first slot or first SL PRS occasion in a slot is used for a second antenna or a second antenna panel, a first comb offset index (e.g., 0) in a second slot or second SL PRS occasion in a slot is used for a third antenna or a third antenna panel, and a second comb offset index (e.g., 1 or comb size divided by 2) in a second slot or second SL PRS occasion in a slot is used for a fourth antenna or a fourth antenna panel, and so on. In another example, a first comb offset index (e.g., 0) in a first slot or first SL PRS occasion in a slot is used for a first antenna or a first antenna panel, and a first comb offset index (e.g., 0) in a second slot or second SL PRS occasion in a slot is used for a second antenna or a second antenna panel, a second comb offset index (e.g., 1 or comb size divided by 2) in a first slot or first SL PRS occasion in a slot is used for a third antenna or a third antenna panel, and a second comb offset index (e.g., 1 or comb size divided by 2) in a second slot or second SL PRS occasion in a slot is used for a fourth antenna or a fourth antenna panel, and so on.

In one example, different PRBs (or sub-channels) and different time resources are used for different antennas or antenna panels. In one example the different time resources can be different SL PRS symbols within a slot (e.g., different SL PRS occasions within a slot) and/or different slots as mentioned herein. For example, a first set of PRBs (or sub-channels) in a first slot or first SL PRS occasion in a slot is used for a first antenna or a first antenna panel, and a second set of PRBs (or sub-channels) in a first slot or first SL PRS occasion in a slot is used for a second antenna or a second antenna panel, a first set of PRBs (or sub-channels) in a second slot or second SL PRS occasion in a slot is used for a third antenna or a third antenna panel, and a second set of PRBs (or sub-channels) in a second slot or second SL PRS occasion in a slot is used for a fourth antenna or a fourth antenna panel, and so on. In another example, a first set of PRBs (or sub-channels) in a first slot or first SL PRS occasion in a slot is used for a first antenna or a first antenna panel, and a first set of PRBs (or sub-channels) in a second slot or second SL PRS occasion in a slot is used for a second antenna or a second antenna panel, a second set of PRBs (or sub-channels) in a first slot or first SL PRS occasion in a slot is used for a third antenna or a third antenna panel, and a second set of PRBs (or sub-channels) in a second slot or second SL PRS occasion in a slot is used for a fourth antenna or a fourth antenna panel, and so on.

In one example, different comb offsets and different PRBs (or sub-channels) and different time resources are used for different antennas or antenna panels. In one example the different time resources can be different SL PRS symbols within a slot (e.g., different SL PRS occasions within a slot) and/or different slots as mentioned herein. The antenna or antenna panel index determines the time resources (e.g., slots and/or symbols within a slot) and frequency resources, e.g., PRBs (or sub-channels) and RE offset to be used for SL PRS.

In one example, the SL PRS from the antennas or antenna panels of a UE uses different sequences, e.g., different SL PRS sequence ID (e.g., n_{ID,seq}^{SL-PRS}) is used for each antenna or antenna panel.

In one example, the SL PRS from the antennas or antenna panels of a UE uses different sequences, e.g., different SL PRS sequence ID (e.g., n_{ID,seq}^{SL-PRS}) is used for each antenna or antenna panel, and the same time resources (e.g., slots and/or symbols within a slot) and frequency resources (e.g., comb offsets and/or PRBs (or sub-channels)) are used for SL PRS from the antennas or antenna panels of a UE.

In one example, the SL PRS from the antennas or antenna panels of a UE uses different sequences, e.g., different SL PRS sequence ID (e.g., n_{ID,seq}^{SL-PRS}) is used for each antenna or antenna panel, and different time resources (e.g., slots and/or symbols within a slot) and/or different frequency resources (e.g., comb offsets and/or PRBs (or sub-channels)) are used for SL PRS from the antennas or antenna panels of a UE as described in the examples mentioned herein.

In one example, the following parameters can be configured, signaled, indicated, or determined to/by a UE. In one example, the UE can be the UE 111A transmitting the SL PRS. In one example, the UE can be the UE 111A receiving the SL PRS.

In one example, the number of SL PRS transmissions in a slot can be configured, signaled, indicated, or determined to/by a UE.

In one example, the number of SL PRS transmissions in a slot is determined to be equal to the number of antennas or antenna panels the UE 111A transmitting the SL PRS has.

In one example, the number of SL PRS transmissions in a slot is pre-configured and/or configured by RRC signaling. RRC signaling can Uu RRC signaling and/or PC5 RRC signaling.

In one example, the number of SL PRS transmissions in a slot is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU).

In one example, different time resources (e.g., different symbols in a slot) are used for the different SL PRS transmissions.

In one example, different frequency resources (e.g., different comb offsets and/or different PRBs (or sub-channels)) are used for the different SL PRS transmissions.

In one example, different code resources (e.g., different sequences) are used for the different SL PRS transmissions.

In one example, different time resources (e.g., different symbols in a slot) and/or different frequency resources (e.g., different comb offsets and/or different PRBs (or sub-channels)) and/or different code resources (e.g., different sequences) are used for the different SL PRS transmissions.

In one example, the number of SL PRS transmissions in a slot or across multiple slots can be configured, signaled, indicated, or determined to/by a UE.

In one example, the number of SL PRS transmissions in a slot or across multiple slots is determined to be equal to the number of antennas or antenna panels the UE 111A transmitting the SL PRS has.

In one example, the number of SL PRS transmissions in a slot or across multiple slots is pre-configured and/or configured by RRC signaling. RRC signaling can Uu RRC signaling and/or PC5 RRC signaling.

In one example, the number of SL PRS transmissions in a slot or across multiple slots is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU).

In one example, different time resources (e.g., different symbols in a slot and/or different slots) are used for the different SL PRS transmissions.

In one example, different frequency resources (e.g., different comb offsets and/or different PRBs (or sub-channels)) are used for the different SL PRS transmissions.

In one example, different code resources (e.g., different sequences) are used for the different SL PRS transmissions.

In one example, different time resources (e.g., different symbols in a slot and/or different slots) and/or different frequency resources (e.g., different comb offsets and/or different PRBs (or sub-channels)) and/or different code resources (e.g., different sequences) are used for the different SL PRS transmissions.

In one example, a starting symbol for SL PRS transmissions can be configured, signaled, indicated, or determined to/by a UE.

In one example, a common starting symbol of SL PRS transmission is configured, or signaled or indicated to the UE 111A. In one example, all SL PRS transmissions have a same starting symbol. In one example, the common symbol could be starting symbol for the first SL PRS occasion. The starting symbol for the next SL PRS occasions can be determined based on the common starting symbol and the length of the SL PRS (e.g., in symbols), and whether there are AGC (e.g., duplicate symbols) and/or gap symbols between SL PRS occasions. For example,
Starting symbol for second SL PRS occasion in a slot=Common starting symbol+length of SL PRS if there is no AGC (e.g., duplicate) symbol or gap symbol.
Starting symbol for second SL PRS occasion in a slot=Common starting symbol+length of SL PRS+1 if there is one AGC (e.g., duplicate) symbol or one gap symbol.
Starting symbol for second SL PRS occasion in a slot=Common starting symbol+length of SL PRS+2 if there is one AGC (e.g., duplicate) symbol and one gap symbol

The starting symbol for the third SL PRS occasion can be given by:
Starting symbol for third SL PRS occasion in a slot=Starting symbol for second SL PRS occasion in a slot+length of SL PRS if there is no AGC (e.g., duplicate) symbol or gap symbol.
Starting symbol for third SL PRS occasion in a slot=Starting symbol for second SL PRS occasion in a slot+length of SL PRS+1 if there is one AGC (e.g., duplicate) symbol or one gap symbol.
Starting symbol for third SL PRS occasion in a slot=Starting symbol for second SL PRS occasion in a slot+length of SL PRS+2 if there is one AGC (e.g., duplicate) symbol and one gap symbol.

In general, we can have the starting symbol in a slot given by ƒ(i,P), where,
ƒ(i,P) is a function of i and P.
i is the index of the SL PRS transmission (e.g., index of antenna or antenna panel or UE)
P is the common starting symbol.
ƒ(i,P) can depend on whether there are AGC (e.g., duplicate) symbols and/or gap symbols between SL PRS transmissions.

In one example, the common starting symbol of SL PRS transmission is pre-configured and/or configured by RRC signaling. RRC signaling can Uu RRC signaling and/or PC5 RRC signaling.

In one example, the common starting symbol of SL PRS transmission is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission, it can be from the UE 111A transmitting SL PRS from a UE receiving SL PRS and/or from a third UE not transmitting or receiving SL PRS (e.g., group leader or platoon leader or Roadside Unit (RSU).

In one example, a starting symbol of each SL PRS transmission (e.g., associated with an antenna or an antenna panel) is configured, or signaled or indicated to the UE 111A.

In one example, a starting symbol of each SL PRS transmission (e.g., associated with an antenna or an antenna panel) is pre-configured and/or configured by RRC signaling. RRC signaling can Uu RRC signaling and/or PC5 RRC signaling.

In one example, a starting symbol of each SL PRS transmission (e.g., associated with an antenna or an antenna panel) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission, it can be from the UE 111A transmitting SL PRS, from a UE receiving SL PRS and/or from a third UE not transmitting or receiving SL PRS (e.g., group leader or platoon leader or Roadside Unit (RSU).

In one example, a length in time domain (e.g., in number of symbols) of the SL PRS transmissions can be configured, signaled, indicated, or determined to/by a UE.

In one example, SL PRS transmissions (e.g., associated with an antenna or an antenna panel) have a same length in time domain (e.g., in number of symbols).

In one example, SL PRS transmissions (e.g., associated with an antenna or an antenna panel) can have a different length in time domain (e.g., in number of symbols).

In one example, the length in time domain (e.g., in number of symbols) of the SL PRS transmissions (e.g., associated with an antenna or an antenna panel or UE) is pre-configured and/or configured by RRC signaling. RRC signaling can Uu RRC signaling and/or PC5 RRC signaling. In one example, a common length (e.g., in symbols) is configured for all SL PRS transmissions, in another example, a different length can be configured for a SL PRS transmission (e.g., associated with an antenna or an antenna panel or UE).

In one example, the length in time domain (e.g., in number of symbols) of the SL PRS transmissions (e.g., associated with an antenna or an antenna panel or UE) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU). In one example, a common length (e.g., in symbols) is signaled or indicated for all SL PRS transmissions. In another example, a different length can be signaled or indicated for a SL PRS transmission (e.g., associated with an antenna or an antenna panel or UE).

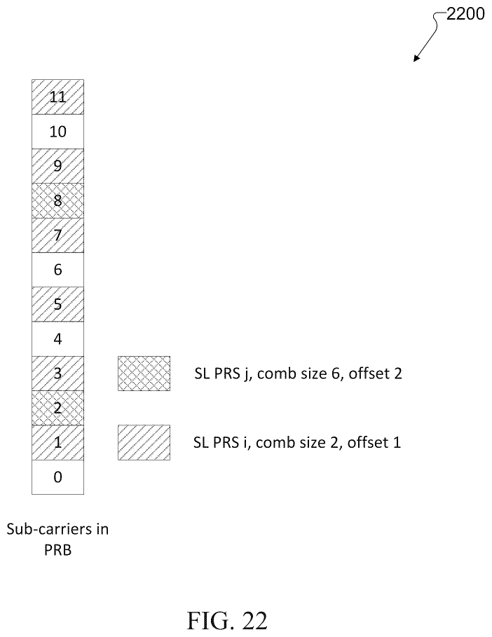

FIG. 22 illustrates a diagram 2200 of an example nested comb structure for SL PRS according to embodiments of the present disclosure. For example, diagram 2200 of an example nested comb structure for SL PRS can be utilized by any of UEs 111, 111A, 111B, and 111C of FIG. 1. This example is for illustration only and other embodiments can be used without departing from the scope of the present disclosure.

In one example, a comb size of the SL PRS transmissions can be configured, signaled, indicated, or determined to/by a UE.

In one example, SL PRS transmissions (e.g., associated with an antenna or an antenna panel) have a same comb size.

In one example, SL PRS transmissions (e.g., associated with an antenna or an antenna panel) can have a different comb size.

For example, a nested structure of comb offsets with different comb size for different SL PRS transmissions can be evaluated. The SL PRS transmissions can be associated with different antennas or antenna panels or with different users. To described nested comb structure for SL PRS, two SL PRS transmissions are evaluated. A first SL PRS i transmission has a comb size of Sᵢ and a comb offset of Oᵢ. A second SL PRS j transmission has a comb size of Sⱼ and a comb offset of Oⱼ. Let Sⱼ=M·Sᵢ, where M is an integer greater than 1. For the two SL transmissions to be on different REs, Oⱼ is selected from a set {0, 1, . . . Sⱼ−1}, excluding {0·Sᵢ+Oᵢ,1·Sᵢ+Oᵢ, . . . (M−1)−Sᵢ+Oᵢ}. For example, SL PRS i has comb size of 2 and a comb offset of 1. SL PRS j has a comb size of 6, the allowed comb offset for SL PRS j to not interfere with SL PRS i are {0, 2, 4}. FIG. 22 shows an example of nested comb structure, with SL PRS i having a comb size of 2 and a comb offset of 1, and SL PRS j has comb size of 6 and a comb offset of 2.

In one example, the comb size is determined implicitly, for example the comb size can equal the number of antennas or the number of antenna panels, or the number of SL PRS transmissions in a slot or the number of SL PRS transmissions in a slot or across multiple slots as mentioned herein.

In one example, the comb size of the SL PRS transmissions (e.g., associated with an antenna or an antenna panel or UE) is pre-configured and/or configured by RRC signaling. RRC signaling can Uu RRC signaling and/or PC5 RRC signaling. In one example, a common comb size is configured for all SL PRS transmissions. In another example, a different comb size can be configured for a SL PRS transmission (e.g., associated with an antenna or an antenna panel or UE).

In one example, the comb size of the SL PRS transmissions (e.g., associated with an antenna or an antenna panel or UE) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU). In one example, a common comb size is signaled or indicated for all SL PRS transmissions, in another example, a different comb size can be signaled or indicated for a SL PRS transmission (e.g., associated with an antenna or an antenna panel or UE).

In one example, a comb offset of the SL PRS transmissions can be configured, signaled, indicated, or determined to/by a UE.

In one example, the comb offset can be determined based on an index i of an antenna or antenna panel. For example, comb offset i is used for antenna with index i or panel with index i.

In one example, the comb offset can be determined based on an index i of an antenna or antenna panel and a common configured parameter P. For example, comb offset ƒ(i,P) is used for antenna with index i or panel with index i, where ƒ( ) is a function of i and P. In one example, the function can be ƒ(i,P)=(i+P) % comb_size, where % is the modulo operator, M % N is the remainder of dividing M by N.

In one example, the comb offset can be configured or indicated or signaled for each SL PRS transmission (e.g., associated with an antenna or an antenna panel or UE).

In one example, the comb offset of the SL PRS transmissions (e.g., associated with an antenna or an antenna panel or UE) is pre-configured and/or configured by RRC signaling. RRC signaling can Uu RRC signaling and/or PC5 RRC signaling. In one example, a common comb offset parameter is configured for all SL PRS transmissions from which the comb offset for each SL transmission is determined, in another example, a different comb offset can be configured for a SL PRS transmission (e.g., associated with an antenna or an antenna panel or UE).

In one example, the comb offset of the SL PRS transmissions (e.g., associated with an antenna or an antenna panel or UE) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU). In one example, a common comb offset parameter is signaled or indicated for all SL PRS transmissions from which the comb offset for each SL transmission is determined, in another example, a different comb offset can be signaled or indicated for a SL PRS transmission (e.g., associated with an antenna or an antenna panel or UE).

In one example, a starting PRB (or sub-channel) for SL PRS transmissions can be configured, signaled, indicated, or determined to/by a UE.

In one example, a common starting PRB (or sub-channel) of SL PRS transmission is configured, or signaled or indicated to the UE 111A. In one example, all SL PRS transmissions have a same starting PRB (or sub-channel). In one example, the common PRB (or sub-channel) could be starting PRB (or sub-channel) for the first SL PRS occasion in frequency domain. The starting PRB (or sub-channel) for the next SL PRS occasions in frequency domain can be determined based on the common starting PRB (or sub-channel) and the length of the SL PRS (e.g., in PRBs (or sub-channels)). For example, starting PRB (or sub-channel) for second SL PRS occasion in frequency domain=Common starting PRB (or sub-channel)+length of SL PRS (e.g., in PRBs (or sub-channels))+length of guard PRBs (or sub-channels) if present. The starting PRB (or sub-channel) for the third SL PRS occasion can be given by: Starting PRB (or sub-channel) for third SL PRS occasion in frequency domain=Starting PRB (or sub-channel) for second SL PRS occasion+length of SL PRS (e.g., in PRBs (or sub-channels))+length of guard PRBs (or sub-channels) if present. In general, we can have the starting PRB (or sub-channel) given by ƒ(i,P), where:
ƒ(i,P) is a function of i and P.
i is the index of the SL PRS transmission (e.g., index of antenna or antenna panel or UE)
P is the common starting PRB (or sub-channel).
ƒ(i,P) can depend on whether there are guard PRBs (or sub-channels) between the SL PRS transmissions in frequency domain.

In one example, the common starting PRB (or sub-channel) of SL PRS transmission is pre-configured and/or configured by RRC signaling. RRC signaling can Uu RRC signaling and/or PC5 RRC signaling.

In one example, the common starting PRB (or sub-channel) of SL PRS transmission is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU).

In one example, a starting PRB (or sub-channel) of each SL PRS transmission (e.g., associated with an antenna or an antenna panel) is configured, or signaled or indicated to the UE 111A.

In one example, a starting PRB (or sub-channel) of each SL PRS transmission (e.g., associated with an antenna or an antenna panel) is pre-configured and/or configured by RRC signaling. RRC signaling can Uu RRC signaling and/or PC5 RRC signaling.

In one example, a starting (or sub-channel) PRB of each SL PRS transmission (e.g., associated with an antenna or an antenna panel) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU).

In one example, a length in frequency domain (e.g., in number of PRBs (or sub-channels)) of the SL PRS transmissions can be configured, signaled, indicated, or determined to/by a UE.

In one example, SL PRS transmissions (e.g., associated with an antenna or an antenna panel) have a same length in frequency domain (e.g., in number of PRBs (or sub-channels)).

In one example, SL PRS transmissions (e.g., associated with an antenna or an antenna panel) can have a different length in frequency domain (e.g., in number of PRBs (or sub-channels)).

In one example, the length in frequency domain (e.g., in number of PRBs (or sub-channels)) of the SL PRS transmissions (e.g., associated with an antenna or an antenna panel or UE) is pre-configured and/or configured by RRC signaling. RRC signaling can Uu RRC signaling and/or PC5 RRC signaling. In one example, a common length (e.g., in PRBs (or sub-channels)) is configured for all SL PRS transmissions. In another example, a different length can be configured for a SL PRS transmission (e.g., associated with an antenna or an antenna panel or UE).

In one example, the length in frequency domain (e.g., in number of PRBs (or sub-channels)) of the SL PRS transmissions (e.g., associated with an antenna or an antenna panel or UE) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission. It can be from the UE 111A transmitting SL PRS, from a UE receiving SL PRS and/or from a third UE not transmitting or receiving SL PRS (e.g., group leader or platoon leader or Roadside Unit (RSU). In one example, a common length (e.g., in PRBs) is signaled or indicated for all SL PRS transmissions, in another example, a different length can be signaled or indicated for a SL PRS transmission (e.g., associated with an antenna or an antenna panel or UE).

In one example, a SL PRS sequence ID (e.g., n_{ID,seq}^{SL-PRS}) of the SL PRS transmissions can be configured, signaled, indicated, or determined to/by a UE.

In one example, SL PRS transmissions (e.g., associated with an antenna or an antenna panel) have a same SL PRS sequence ID (e.g., n_{ID,seq}^{SL-PRS}). In one example, all SL PRS transmissions have a same SL PRS sequence ID (e.g., n_{ID,seq}^{SL-PRS})

The SL PRS sequence ID (e.g., n_{ID,seq}^{SL-PRS}) can be given by ƒ(i,P), where,
ƒ(i,P) is a function of i and P.
i is the index of the SL PRS transmission (e.g., index of antenna or antenna panel or UE)
P is the configured or signaled or indicated SL PRS sequence ID (e.g., n_{ID,seq}^{SL-PRS}).

In one example, the configured or signaled or indicated SL PRS sequence ID (e.g., n_{ID,seq}^{SL-PRS}) can be the SL PRS sequence ID for a first SL PRS transmission. The SL PRS sequence ID for the next SL PRS can be determined based on the configured or signaled or indicated SL PRS sequence ID and an offset. For example, starting PRB for second SL PRS=configured or signaled or indicated SL PRS sequence ID+offset. The starting PRB for the third SL PRS can be given by: SL PRS sequence ID for third SL PRS=SL PRS sequence ID for second SL PRS+offset. In on example, the offset can be configured by RRC signaling and/or MAC CE signaling and/or L1 control signaling.

In one example, the SL PRS sequence ID (e.g., n_{ID,seq}^{SL-PRS}) of SL PRS transmission is pre-configured and/or configured by RRC signaling. RRC signaling can Uu RRC signaling and/or PC5 RRC signaling.

In one example, the SL PRS sequence ID (e.g., n_{ID,seq}^{SL-PRS}) of SL PRS transmission is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot.

In one example, SCI signal is not associated with SL PRS transmission, it can be from the UE 111A transmitting SL PRS, from a UE receiving SL PRS and/or from a third UE not transmitting or receiving SL PRS (e.g., group leader or platoon leader or Roadside Unit (RSU).

In one example, a SL PRS sequence ID (e.g., n_{ID,seq}^{SL-PRS}) of each SL PRS transmission (e.g., associated with an antenna or an antenna panel) is configured, or signaled or indicated to the UE 111A.

In one example, a SL PRS sequence ID (e.g., n_{ID,seq}^{SL-PRS}) of each SL PRS transmission (e.g., associated with an antenna or an antenna panel) is pre-configured and/or configured by RRC signaling. RRC signaling can Uu RRC signaling and/or PC5 RRC signaling.

In one example, a SL PRS sequence ID (e.g., n_{ID,seq}^{SL-PRS}) of each SL PRS transmission (e.g., associated with an antenna or an antenna panel) is signaled or indicated by MAC CE signaling and/or L1 control. MAC CE signaling can Uu MAC CE signaling and/or PC5 MAC CE signaling. L1 control signaling can be DCI signaling over the Uu interface, and/or SCI signaling across the PC5 interface. In one example, SCI signaling can be associated with SL PRS transmission in the same slot as SL PRS or in a different slot. In one example, SCI signal is not associated with SL PRS transmission, it can be from the UE 111A transmitting SL PRS, from a UE receiving SL PRS and/or from a third UE not transmitting or receiving SL PRS (e.g., group leader or platoon leader or Roadside Unit (RSU).

In one example, the SL PRS transmissions from different antenna or antenna panels are part of SL PRS resource set, e.g., each antenna or antenna panel can be associated with a different SL PRS in same SL PRS resource set.

In one example, the SL PRS transmissions from different antenna or antenna panels are in different SL PRS resource set, e.g., each antenna or antenna panel can be associated with a different SL PRS resource set.

In one example, a first UE receiving or performing SL PRS measurements has multiple antenna or antenna panels. The antennas or antenna panels of the UE 111A are denoted as R₀, R₁, . . . R_{N-1}, where N is the number of antennas or antenna panels the UE 111A receiving or performing SL PRS measurements has. The SL PRS is transmitted from a second UE, wherein the second UE has M transmit antennas or antenna panels. The antenna panels of the transmitting UE are denoted as: To, T₁, . . . T_{M-1}. In one example, the first UE can be UE transmitting the SL PRS and the second UE can be the UE 111A receiving or performing SL PRS measurements.

In one example, SL PRS measurements related to round-trip timing are performed. The first UE measures the Rx-Tx time difference for each antenna pair or for each antenna panel pair. For example, the first UE can measure and report, Rx-Tx time difference for antenna pair or antenna panel pair (i,j), wherein i=0, 1, . . . N−1 is the antenna or antenna panel of the first UE and j=0, 1, . . . M−1 is the antenna or antenna panel of the second UE. In total, there can be N×M Rx-Tx measurements at the first UE. In one example, the N×M Rx-Tx measurements are reported to the network 130 (e.g., to the LMF or gNB). In one example, the N×M Rx-Tx measurements are reported to a UE, wherein the UE can be the UE 111A transmitting SL PRS, and/or a third UE not transmitting or receiving SL PRS (e.g., group leader or platoon leader or Roadside Unit (RSU).

Similarly, the second UE can receive SL PRS from the first UE and the second UE can perform SL PRS reception and measurement at each of the antennas or the antenna panels of the second UE, wherein the SL PRS can be transmitted from each of the antennas or the antenna panels of the first UE. For example, the second UE can measure and report, Rx-Tx time difference for antenna pair or antenna panel pair (j,i), wherein i=0, 1, . . . N−1 is the antenna or antenna panel of the first UE and j=0, 1, . . . M−1 is the antenna or antenna panel of the second UE. In total, there can be N×M Rx-Tx measurements at the second UE. In one example, the N×M Rx-Tx measurements are reported to the network 130 (e.g., to the LMF or gNB). In one example, the N×M Rx-Tx measurements are reported to a UE, wherein the UE can be the UE 111A transmitting SL PRS, and/or a third UE not transmitting or receiving SL PRS (e.g., group leader or platoon leader or Roadside Unit (RSU).

By combining the Rx-Tx measurements for the first UE and the second UE for each antenna/antenna panel pair, the round-trip time and correspondingly the distance between each pair of antennas or panels can be determined. Knowing the distance or relative position between the antennas or antenna panels of each UE, the position (e.g., relative position) of the UEs can be determined.

The reported measurement can be tagged with the antenna or antenna panel of the first UE, i.e., i, and the antenna or antenna panel of the second UE for which the Rx-Tx time difference is being calculated, i.e., j.

In one example, SL PRS measurements related to reference signal time difference are performed. In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, the first UE at antenna panel Rᵢ, i can be from 0 to N−1, measures and calculates the time difference between: (1) time of arrival of a SL PRS transmitted from antenna or antenna panel j1 from the second UE and (2) time of arrival of a SL PRS transmitted from antenna or antenna panel j2 from the second UE, wherein j1≠j2 and j1 can be from 0 to M−1 and j2 can be from 0 to M−1. The reported measurement can be tagged with the antenna or antenna panel of the first UE, i.e., i, and the antennas or antenna panels of the second UE for which the time difference is being calculated, i.e., j1 and j2.

In one example, SL PRS measurements related to reference signal time difference are performed. In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, for a SL PRS transmitted from antenna or antenna panel j of the second UE, wherein j can be between 0 and M−1, the first UE measures and calculates the time difference between (1) time of arrival of the SL PRS received at antenna or antenna panel i1 of the first UE and (2) time of arrival of the SL PRS received at antenna or antenna panel i2 of the first UE, wherein i1≠i2 and i1 can be from 0 to N−1 and i2 can be from 0 to N−1. The reported measurement can be tagged with the antennas or antenna panels of the first UE, i.e., i1 and i2, and the antenna or antenna panel of the second UE for which the time difference is being calculated, i.e., j.

In one example, SL PRS measurements related to time of arrival are performed. In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. The time of arrival measurement can be relative to a time determined by the first UE. In one example, the determined time is common for all N antennas or antenna panels of first UE. In one example, each antenna or antenna panel of first UE has its determined time. In one example, the first UE at antenna panel Rᵢ, i can be from 0 to N−1, measures the time of arrival of a SL PRS from an antenna or antenna panel T from the second UE, wherein j can be from 0 to M−1. The reported measurement can be tagged with the antenna or antenna panel of the first UE, i.e., i, and the antenna or antenna panel of the second UE for which the time of arrival is being calculated, i.e., j.

In one example, SL PRS measurements related to angle of arrival are performed. In one example, the angle of arrival is in a global coordinate system. In one example, the angle of arrival is in a local coordinate system of a UE (e.g., first UE). In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, the first UE at antenna panel Rᵢ, i can be from 0 to N−1, measures the angle of arrival of a SL PRS from an antenna or antenna panel Tⱼ from the second UE, wherein j can be from 0 to M−1. The reported measurement can be tagged with the antenna or antenna panel of the first UE, i.e., i, and the antenna or antenna panel of the second UE for which the time of arrival is being calculated, i.e., j.

In one example, SL PRS measurements related to angle of arrival (e.g., angle of arrival difference) are performed. In one example, the angle of arrival is in a global coordinate system. In one example, the angle of arrival is in a local coordinate system of a UE (e.g., first UE). In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, the first UE at antenna panel Rᵢ, i can be from 0 to N−1, measures and calculates the angle of arrival difference between: (1) angle of arrival of a SL PRS transmitted from antenna or antenna panel j1 from the second UE and (2) angle of arrival of a SL PRS transmitted from antenna or antenna panel j2 from the second UE, wherein j1≠j2 and j1 can be from 0 to M−1 and j2 can be from 0 to M−1. The reported measurement can be tagged with the antenna or antenna panel of the first UE, i.e., i, and the antennas or antenna panels of the second UE for which the angle of arrival difference is being calculated, i.e., j1 and j2.

In one example, SL PRS measurements related to angle of arrival (e.g., angle of arrival difference) are performed. In one example, the angle of arrival is in a global coordinate system. In one example, the angle of arrival is in a local coordinate system of a UE (e.g., first UE). In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, for a SL PRS transmitted from antenna or antenna panel j of the second UE, wherein j can be between 0 and M−1, the first UE measures and calculates the angle of arrival difference between (1) angle of arrival of the SL PRS received at antenna or antenna panel i1 of the first UE and (2) angle of arrival of the SL PRS received at antenna or antenna panel i2 of the first UE, wherein i1≠i2 and i1 can be from 0 to N−1 and i2 can be from 0 to N−1. The reported measurement can be tagged with the antennas or antenna panels of the first UE, i.e., i1 and i2, and the antenna or antenna panel of the second UE for which the angle of arrival difference is being calculated, i.e., j.

In one example, SL PRS measurements related to SL carrier phase are performed. In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, the first UE at antenna panel Rᵢ, i can be from 0 to N−1, measures the SL carrier phase of a SL PRS from an antenna or antenna panel Tⱼ from the second UE, wherein j can be from 0 to M−1. The reported measurement can be tagged with the antenna or antenna panel of the first UE, i.e., i, and the antenna or antenna panel of the second UE for which the SL carrier phase is being calculated, i.e., j.

In one example, SL PRS measurements related to SL carrier phase (e.g., SL carrier phase difference) are performed. In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, the first UE at antenna panel Rᵢ, i can be from 0 to N−1, measures and calculates the SL carrier phase difference between: (1) carrier phase of a SL PRS transmitted from antenna or antenna panel j1 from the second UE and (2) carrier phase of a SL PRS transmitted from antenna or antenna panel j2 from the second UE, wherein j1≠j2 and j1 can be from 0 to M−1 and j2 can be from 0 to M−1. The reported measurement can be tagged with the antenna or antenna panel of the first UE, i.e., i, and the antennas or antenna panels of the second UE for which the SL carrier phase difference is being calculated, i.e., j1 and j2.

In one example, SL PRS measurements related to SL carrier phase (e.g., SL carrier phase difference) are performed. In one example, the first UE measures the SL PRS transmitted from the second UE. The first UE has N antennas or antenna panels denoted as R₀, R₁, . . . R_{N-1}, the second UE has M antennas or antenna panels denoted as T₀, T₁, . . . T_{M-1}. In one example, for a SL PRS transmitted from antenna or antenna panel j of the second UE, wherein j can be between 0 and M−1, the first UE measures and calculates the SL carrier phase difference between: (1) carrier phase of the SL PRS received at antenna or antenna panel i1 of the first UE and (2) carrier phase of the SL PRS received at antenna or antenna panel i2 of the first UE, wherein i1≠i2 and i1 can be from 0 to N−1 and i2 can be from 0 to N−1. The reported measurement can be tagged with the antennas or antenna panels of the first UE, i.e., i1 and i2, and the antenna or antenna panel of the second UE for which the SL carrier phase difference is being calculated, i.e., j.

In one example, a UE performing SL PRS receptions and measurement reports SL PRS measurements for each antenna panel as mentioned herein.

In one example, a UE performing SL PRS receptions and measurement reports SL PRS measurements for each antenna panel as mentioned herein. In one example, a single reporting instance includes measurement reports from each antenna or antenna panel. In one example, each report is tagged with the antenna index or antenna panel index of the receiving UE. In one example, each report is tagged with an index pair or tuple wherein a first index or indexes corresponds to the antenna index(es) or antenna panel index(es) of the receiving UE and a second index or indexes corresponds to the antenna index(es) or the antenna panel index(es) of the UE 111A transmitting the SL PRS.

In one example, a UE performing SL PRS receptions and measurement reports SL PRS measurements for each antenna panel as mentioned herein, in one example, a single reporting instance includes measurement reports from one antenna or antenna panel. In one example, each report is tagged with the antenna index or antenna panel index of the receiving UE. In one example, each report is tagged with an index pair or tuple wherein a first index or indexes corresponds to the antenna index(es) or antenna panel index(es) of the receiving UE and a second index or indexes corresponds to the antenna index(es) or the antenna panel index(es) of the UE 111A transmitting the SL PRS.

In one example, a UE performing SL PRS receptions and measurement reports SL PRS measurements for each antenna panel as mentioned herein. In one example, a single reporting instance includes measurement reports for a subset of antennas or antenna panels. In one example, each report is tagged with the antenna index or antenna panel index of the receiving UE. In one example, each report is tagged with an index pair or tuple wherein a first index or indexes corresponds to the antenna index(es) or antenna panel index(es) of the receiving UE and a second index or indexes corresponds to the antenna index(es) or the antenna panel index(es) of the UE 111A transmitting the SL PRS.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive, from a second UE, via N antenna panels, M sidelink positioning reference signals (SL PRSs), wherein at least one of N and M is greater than 1; and
a processor operably coupled to the transceiver, the processor configured to:
perform:
a first positioning measurement based on a first SL PRS from the M SL PRS and a second positioning measurement based on a second SL PRS from the M SL PRS, or
a third positioning measurement based on a third SL PRS from the M SL PRS that is received by a first antenna panel from the N antenna panels and a fourth positioning measurement based on the third SL PRS that is received by a second antenna panel from the N antenna panels, and
determine a first positioning measurement report based on (i) the first positioning measurement and the second positioning measurement or (ii) the third positioning measurement and the fourth positioning measurement,
wherein the first positioning measurement report includes (i) an identifier of a SL PRS used and (ii) an identifier of an antenna panel used to receive the SL PRS.

2. The UE of claim 1 wherein the first positioning measurement is based on at least one of:
a time of arrival of the first SL PRS,
a carrier phase measurement of the first SL PRS, and
an angle of arrival of the first SL PRS.

3. The UE of claim 1 wherein,
the processor is further configured to calculate:
a first difference between the first positioning measurement and the second positioning measurement, or
a second difference between the third positioning measurement and the fourth positioning measurement, and
the first positioning measurement report includes the first difference or the second difference.

4. The UE of claim 1, wherein the transceiver is further configured to receive sidelink control information (SCI) including a value of M and a configuration for the M SL PRS.

5. The UE of claim 1, wherein the transceiver is further configured to transmit K SL PRS via K antenna panels, where K is >1.

6. The UE of claim 5, wherein a first SL PRS from the K SL PRS uses a first group of symbols in a slot and a second SL PRS from the K SL PRS uses a second group of symbols in the slot.

7. The UE of claim 5, wherein a first SL PRS from the K SL PRS uses a first group of physical resource blocks (PRBs) and a second SL PRS from the K SL PRS uses a second group of PRBs.

8. The UE of claim 5, wherein a first SL PRS from the K SL PRS uses a first comb offset and a second SL PRS from the K SL PRS uses a second comb offset.

9. The UE of claim 5, wherein:
the transceiver is further configured to transmit sidelink control information (SCI), and
the SCI indicates a value of K and a configuration for the K SL PRS.

10. The UE of claim 5, wherein the processor is further configured to:
measure an earliest detected path based on a fourth SL PRS from the M SL PRS received by a third antenna panel from the N antenna panels,
determine a transmit timing of a SL PRS from the K SL PRS resources transmitted from a fourth antenna panel from the K antenna panels,
calculate a SL receive-transmit (Rx-Tx) time difference for the third antenna panel and the fourth antenna panel based on the earliest detected path and the transmit timing, and
determine a second positioning measurement report based on the SL Rx-Tx time difference, wherein the second positioning measurement report includes an identifier of the third antenna panel and an identifier of the fourth antenna panel.

11. A method of operating a user equipment (UE), the method comprising:
receiving, from a second UE, via N antenna panels, M sidelink positioning reference signals (SL PRSs), wherein at least one of N or M is greater than 1;
performing:
a first positioning measurement based on a first SL PRS from the M SL PRS and a second positioning measurement based on a second SL PRS from the M SL PRS, or
a third positioning measurement based on a third SL PRS from the M SL PRS that is received by a first antenna panel from the N antenna panels and a fourth positioning measurement based on the third SL PRS that is received by a second antenna panel from the N antenna panels;
determining a first positioning measurement report based on (i) the first positioning measurement and the second positioning measurement or (ii) the third positioning measurement and the fourth positioning measurement,
wherein the first positioning measurement report includes (i) an identifier of a SL PRS used and (ii) an identifier of an antenna panel used to receive the SL PRS.

12. The method of claim 11 wherein the first positioning measurement is based on at least one of:
a time of arrival of the first SL PRS,
a carrier phase measurement of the first SL PRS, and
an angle of arrival of the first SL PRS.

13. The method of claim 11 further comprising:
calculating:
a first difference between the first positioning measurement and the second positioning measurement, or
a second difference between the third positioning measurement and the fourth positioning measurement,
wherein the first positioning measurement report includes the first difference or the second difference.

14. The method of claim 11, further comprising:
receiving sidelink control information (SCI), including a value of M and a configuration for the M SL PRS.

15. The method of claim 11, further comprising:
transmitting K SL PRS via K antenna panels, where K is >1.

16. The method of claim 15, wherein a first SL PRS from the K SL PRS uses a first group of symbols in a slot and a second SL PRS from the K SL PRS uses a second group of symbols in the slot.

17. The method of claim 15, wherein a first SL PRS from the K SL PRS uses a first group of physical resource blocks (PRBs) and a second SL PRS from the K SL PRS uses a second group of PRBs.

18. The method of claim 15, wherein a first SL PRS from the K SL PRS uses a first comb offset and a second SL PRS from the K SL PRS uses a second comb offset.

19. The method of claim 15, further comprising:
transmitting sidelink control information (SCI),
wherein the SCI indicates a value of K and a configuration for the K SL PRS.

20. The method of claim 15, further comprising:
measuring an earliest detected path based on a fourth SL PRS from the M SL PRS received by a third antenna panel from the N antenna panels;
determining a transmit timing of a SL PRS from the K SL PRS resources transmitted from a fourth antenna panel from the K antenna panels;
calculating a SL receive-transmit (Rx-Tx) time difference for the third antenna panel and the fourth antenna panel based on the earliest detected path and the transmit timing; and
determining a second positioning measurement report based on the SL Rx-Tx time difference, wherein the second positioning measurement report includes an identifier of the third antenna panel and an identifier of the fourth antenna panel.
